(19) United States
(12) Patent Application Publication
(10) Pub. No.: US 2026/0141619 A1
(43) Pub. Date: May 21, 2026

(54) SCENE RECONSTRUCTION USING REFERENCE TIMESTAMPS AND VOLUMETRIC REPRESENTATIONS

(71) Applicant: NVIDIA Corporation, Santa Clara, CA (US)

(72) Inventors: Jiawei REN, Singapore (SG); Hanxue LIANG, Cambridge (GB); Sanja FIDLER, Toronto (CA); Ashkan MIRZAEI, Toronto (CA); Huan LING, Toronto (CA); Zan GOJCIC, Zurich (CH); Jiahui HUANG, Santa Clara, CA (US); Antonio TORRALBA BARRIUSO, Somerville, MA (US)

(73) Assignee: NVIDIA Corporation, Santa Clara, CA (US)

(21) Appl. No.: 19/385,608

(22) Filed: Nov. 11, 2025

Related U.S. Application Data
(60) Provisional application No. 63/721,014, filed on Nov. 15, 2024.

(51) Int. Cl. G06T 15/20; G06T 7/11; G06T 15/06

(52) U.S. Cl. CPC G06T 15/20; G06T 7/11; G06T 15/06; G06T 2207/10016

(57) ABSTRACT

In some examples, systems, and methods are disclosed relating to scene reconstruction using reference timestamps and volumetric representations. Some systems can obtain a plurality of context frames of video data, the plurality of context frames corresponding to a plurality of camera poses at a plurality of timestamps. Some systems can determine a reference timestamp is one of the plurality of timestamps or between two of the plurality of timestamps of the plurality of context frames. Some systems can apply the plurality of context frames, the plurality of camera poses, and the reference timestamp as a plurality of inputs to a vision model to cause the vision model to generate a volumetric representation of a scene at the reference timestamp. Some systems can provide the volumetric representation of the scene at the reference timestamp for rendering at a plurality of perspectives.

### CROSS-REFERENCE TO RELATED APPLICATIONS

The present application claims the benefit of U.S. Provisional Patent Application No. 63/721,014, filed Nov. 15, 2024, the disclosure of which is incorporated herein by reference in its entirety.

### BACKGROUND

Implementing dynamic scene reconstruction from a monocular video in systems that process volumetric outputs (e.g., 3D representations, time-parameterized reconstructions, or frame-by-frame transformations) presents challenges. Some traditional methods rely on static scene reconstructions or multi-view constraints, leading to inefficiencies when processing real-world motion from particular viewpoints. For example, some approaches embed scene updates in application logic or use multi-camera configurations that introduce deployment overhead and inconsistent results across different capture conditions. Additionally, manual scene-configuration can reduce some overhead but introduce repeated parameter tuning, particularly as objects move in unpredictable ways, which increases complexity and latency. Current methods are inadequate for managing dynamic scenes in a scalable and consistent manner using monocular data.

### SUMMARY

Implementations of the present disclosure relate to systems and methods for improving scene reconstruction using a reference timestamp-based framework in systems that process video frames, camera poses, and/or outputs corresponding to moving objects. Systems and methods are disclosed that can output volumetric representations of a scene from a monocular video. For example, systems and methods in accordance with the present disclosure can obtain a set of context frames, camera poses, and at least one reference timestamp to generate a three-dimensional (3D) representation capturing both static and dynamic elements. This representation can reduce redundant per-frame optimization, improve 3D data consistency, and improve the fidelity of motion capture. For example, the disclosed implementations process scenes using a viewpoint (e.g., single viewpoint), reducing the requirement for multi-camera setups while supporting motion depiction. The systems and methods can be applied in various contexts, including single-camera AR/VR pipelines, video-based simulation frameworks, and real-time (or near real-time) interactive displays.

Some implementations relate to a system. The system including one or more processors to execute operations including operations to obtain a plurality of context frames of video data, the plurality of context frames corresponding to a plurality of camera poses at a plurality of timestamps. The operations executed by the one or more processors also including operations to determine a reference timestamp is one of the plurality of timestamps or between two of the plurality of timestamps of the plurality of context frames. The operations executed by the one or more processors further including operations to apply the plurality of context frames, the plurality of camera poses, and the reference timestamp as a plurality of inputs to a vision model to cause the vision model to generate a volumetric representation of a scene at the reference timestamp. The operations executed by the one or more processors further including operations to provide the volumetric representation of the scene at the reference timestamp for rendering at a plurality of perspectives.

In some implementations, the one or more processors are to execute operations including operations to generate, using the vision model, the volumetric representation based at least on an unprojection of a plurality of image patches, a plurality of pose embeddings based on the plurality of camera poses, a plurality of time embeddings based on the plurality of timestamps and the reference timestamp. In some implementations, the one or more processors are to execute operations including operations to segment at least one context frame of the plurality of context frames into a plurality of patches. In some implementations, the one or more processors are to execute operations including operations to generate at least one token of a plurality of tokens for at least one of the plurality of patches, the at least one token including at least one image feature, at least one pose feature, and at least one time feature. In some implementations, the operations to apply the plurality of context frames, the plurality of camera poses, and the reference timestamp as inputs includes operations to apply the plurality of tokens as the plurality of inputs to the vision model to cause the vision model to generate the volumetric representation and the vision model to map at least one output token of the vision model to at least one parameter of a three-dimensional (3D) Gaussian, the at least one parameter including at least one of color, scale, rotation, opacity, or a distance along a ray.

In some implementations, the one or more processors are to execute operations including operations to generate, using at least one artificial intelligence (AI) model, an interpolated frame at the reference timestamp different from the plurality of timestamps of the plurality of context frames and update the plurality of context frames to include the interpolated frame corresponding with the reference timestamp. In some implementations, the operations to apply the plurality of context frames, the plurality of camera poses, and the reference timestamp to the vision model to cause the vision model to generate the volumetric representation further includes operations to perform an unprojection of a plurality of pixel locations from at least one context frame of the plurality of context frames into 3D space based on the plurality of camera poses, operations to assign at least one distance parameter to the plurality of pixel locations to position a plurality of 3D Gaussians along a plurality of rays, and operations to update at least one 3D parameter of the plurality of 3D Gaussians to represent a portion of the scene.

In some implementations, the plurality of 3D Gaussians are positioned based at least on a plurality of spatial changes corresponding to at least one motion trajectory of at least one object between the plurality of context frames. In some implementations, the plurality of 3D Gaussians are configured for rendering from the plurality of perspectives and to represent the at least one motion trajectory of the at least one object within the scene at the reference timestamp. In some implementations, the one or more processors are to execute operations including operations to render at least one two-dimensional (2D) image from the volumetric representation of the scene at the reference timestamp, operations to determine at least one performance metric based on at least one loss function and a ground-truth image, and operations to update at least one model parameter of the vision model based on the at least one performance metric.

In some implementations, the one or more processors are to execute operations including operations to identify a plurality of reference timestamps based at least on iterating through the plurality of timestamps of the video data corresponding to a monocular video. In some implementations, the one or more processors are to apply the plurality of context frames, the plurality of camera poses, and at least one of the plurality of reference timestamps as the plurality of inputs to the vision model to cause the vision model to generate a plurality of volumetric representations of the scene at a plurality of different reference timestamps. In some implementations, the one or more processors are to store or provide the plurality of volumetric representations as a sequence of volumetric frames corresponding to a reconstructed scene.

Some implementations relate to one or more processors including processing circuitry to obtain a plurality of context frames corresponding to a plurality of camera poses at a plurality of timestamps. In one or more embodiments, the processing circuitry determines whether a reference timestamp is one of the plurality of timestamps or between two of the plurality of timestamps of the plurality of context frames. In one or more embodiments, the processing circuitry generates, using a vision model, a volumetric representation of a scene at the reference timestamp based on the plurality of context frames, the plurality of camera poses, and the reference timestamp. In one or more embodiments, the processing circuitry provides the volumetric representation of the scene at the reference timestamp.

In some implementations, the processing circuitry to generates, using the vision model, the volumetric representation based at least on an unprojection of a plurality of image patches, a plurality of pose embeddings based on the plurality of camera poses, and a plurality of time embeddings based on the plurality of timestamps and the reference timestamp. In some implementations, the processing circuitry segments at least one context frame of the plurality of context frames into a plurality of patches. In some implementations, the processing circuitry generates at least one token of a plurality of tokens for at least one of the plurality of patches, the at least one token including at least one image feature, at least one pose feature, and at least one time feature.

In some implementations, applying the plurality of context frames, the plurality of camera poses, and the reference timestamp as inputs includes applying the plurality of tokens as the plurality of inputs to the vision model to cause the vision model to generate the volumetric representation. In some implementations, the vision model to map at least one output token of the vision model to at least one parameter of a three-dimensional (3D) Gaussian, the at least one parameter including at least one of color, scale, rotation, opacity, or a distance along a ray.

In some implementations, the processing circuitry generates, using at least one artificial intelligence (AI) model, an interpolated frame at the reference timestamp different from the plurality of timestamps of the plurality of context frames and update the plurality of context frames to include the interpolated frame corresponding with the reference timestamp. In some implementations, applying the plurality of context frames, the plurality of camera poses, and the reference timestamp to the vision model to cause the vision model to generate the volumetric representation further includes performing an unprojection of a plurality of pixel locations from at least one context frame of the plurality of context frames into 3D space based on the plurality of camera poses, assigning at least one distance parameter to the plurality of pixel locations to position a plurality of 3D Gaussians along a plurality of rays, and updating at least one 3D parameter of the plurality of 3D Gaussians to represent a portion of the scene.

In some implementations, the plurality of 3D Gaussians are positioned based at least on a plurality of spatial changes corresponding to at least one motion trajectory of at least one object between the plurality of context frames. In some implementations, the plurality of 3D Gaussians are configured for rendering from a plurality of perspectives and to represent the at least one motion trajectory of the at least one object within the scene at the reference timestamp.

In some implementations, the processing circuitry renders at least one two-dimensional (2D) image from the volumetric representation of the scene at the reference timestamp, determines at least one performance metric based on at least one loss function and a ground-truth image, and updates at least one model parameter of the vision model based on the at least one performance metric. In some implementations, the processing circuitry identifies a plurality of reference timestamps based at least on iterating through the plurality of timestamps of video data corresponding to a monocular video, applies the plurality of context frames, the plurality of camera poses, and at least one of the plurality of reference timestamps as the plurality of inputs to the vision model to cause the vision model to generate a plurality of volumetric representations of the scene at a plurality of different reference timestamps, and stores or provides the plurality of volumetric representations as a sequence of volumetric frames corresponding to a reconstructed scene.

Some implementations relate to a method. The method includes obtaining, using one or more processors, a plurality of context frames of video data, the plurality of context frames corresponding to a plurality of camera poses at a plurality of timestamps. The method includes determining, using the one or more processors, a reference timestamp is one of the plurality of timestamps or between two of the plurality of timestamps of the plurality of context frames. The method includes applying, using the one or more processors, the plurality of context frames, the plurality of camera poses, and the reference timestamp as a plurality of inputs to a vision model to cause the vision model to generate a volumetric representation of a scene at the reference timestamp. The method includes providing, using the one or more processors, the volumetric representation of the scene at the reference timestamp for rendering at a plurality of perspectives.

The processors, systems, and/or methods described herein can be implemented by or included in at least one of a system for implementing scene reconstruction, a system for applying contextual features to one or more models, a system for performing motion analysis, a system for performing volumetric rendering, a control system for an autonomous or semi-autonomous machine, a perception system for an autonomous or semi-autonomous machine, a system for performing one or more simulation operations, a system for performing one or more digital twin operations, a system for performing light transport simulation, a system for performing collaborative content creation for 3D assets, a system for performing one or more deep learning operations, a system implemented using an edge device, a system implemented using a robot, a system for performing one or more generative AI operations, a system for performing operations using one or more large language model (LLMs), one or more language reasoning models (LRMs), one or more vision language models (VLMs), one or more multi-modal language models (MMLMs), or one or more vision-language-action (VLA) models—or any combination thereof, a system for using or deploying one or more inference microservices, a system for performing one or more conversational AI operations, a system for generating synthetic data, a system for presenting extended reality (XR) (e.g., at least one of virtual reality (VR), augmented reality (AR), or mixed reality) content, a system incorporating one or more virtual machines (VMs), a system implemented at least partially in a data center, or a system implemented at least partially using cloud computing resources.

### BRIEF DESCRIPTION OF THE DRAWINGS

The present systems and methods for scene reconstruction using reference timestamps and volumetric representations are described in detail below with reference to the attached drawing figures, wherein:

FIG. 1 is a block diagram of an example of a system, in accordance with some implementations of the present disclosure;

FIG. 2 is a flow diagram of an example of a method for scene reconstruction using reference timestamps and volumetric representations in a vision pipeline, in accordance with some implementations of the present disclosure;

FIG. 3A is a block diagram of a vision pipeline, in accordance with some implementations of the present disclosure;

FIG. 3B is a block diagram of a time enhancer pipeline, in accordance with some implementations of the present disclosure;

FIGS. 4A-4D are example illustrations of inputs and outputs of the vision pipeline, in accordance with some implementations of the present disclosure;

FIGS. 5A-5B are example metrics of the vision pipeline, in accordance with some implementations of the present disclosure;

FIG. 6A is an example of sensor locations having corresponding fields of view or sensory fields for example autonomous or semi-autonomous machines, in accordance with some implementations of the present disclosure;

FIG. 6B is an illustration of an example of component and sensor locations on an autonomous or semi-autonomous vehicle, in accordance with some implementations of the present disclosure;

FIG. 6C is a block diagram of an example system architecture for an autonomous or semi-autonomous vehicle, robot, and/or other machine type, in accordance with some implementations of the present disclosure;

FIG. 6D is a block diagram of an example architecture of a computing system-such as a system-on-a-chip (SoC)—in accordance with some implementations of the present disclosure;

FIG. 6E is a system diagram for communication between cloud-based server(s) and an example autonomous or semi-autonomous vehicle, robot, and/or other machine type, in accordance with some implementations of the present disclosure;

FIG. 7 is a system diagram illustrating a three-computer ecosystem, including a computing system for generating or creating artificial intelligence (AI)—such as AI training and validation data, a computing system for training artificial intelligence, and a computing system deploying the AI at the edge, in accordance with some implementations of the present disclosure;

FIG. 8 is a block diagram of an example computing system for generative artificial intelligence (AI), in accordance with some implementations of the present disclosure; and

FIG. 9 is a block diagram of an example computing device, in accordance with some implementations of the present disclosure.

### DETAILED DESCRIPTION

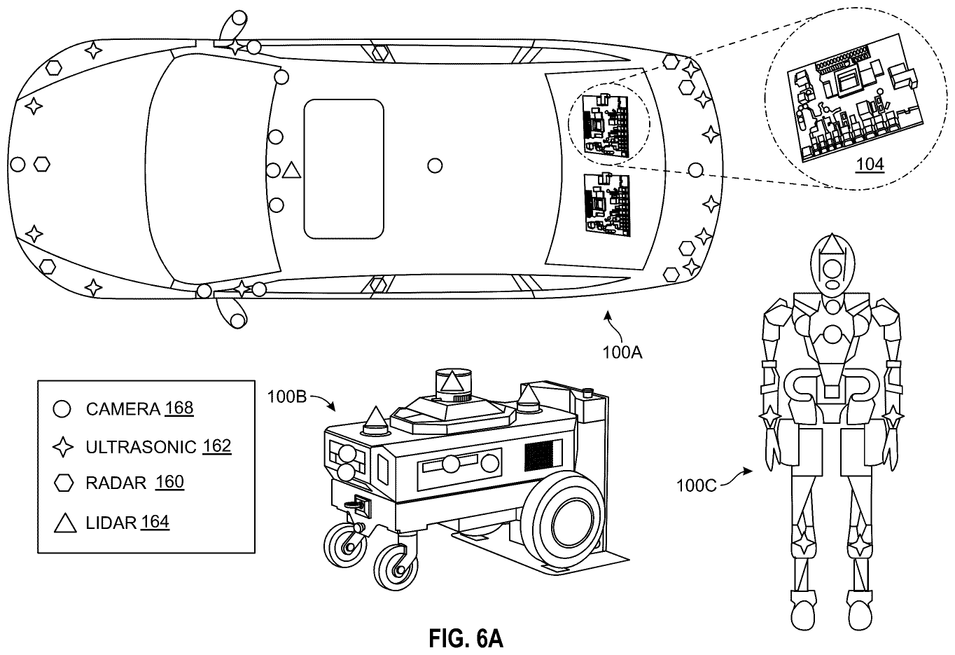

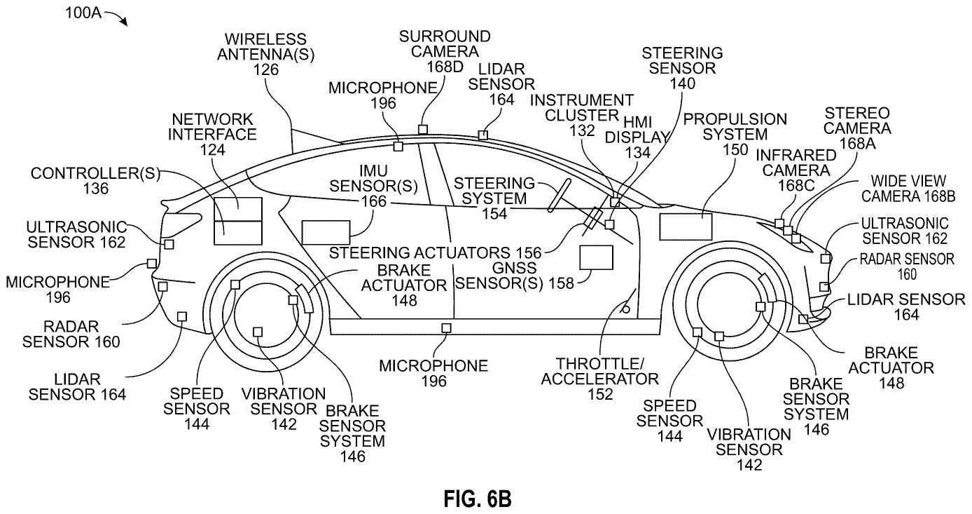

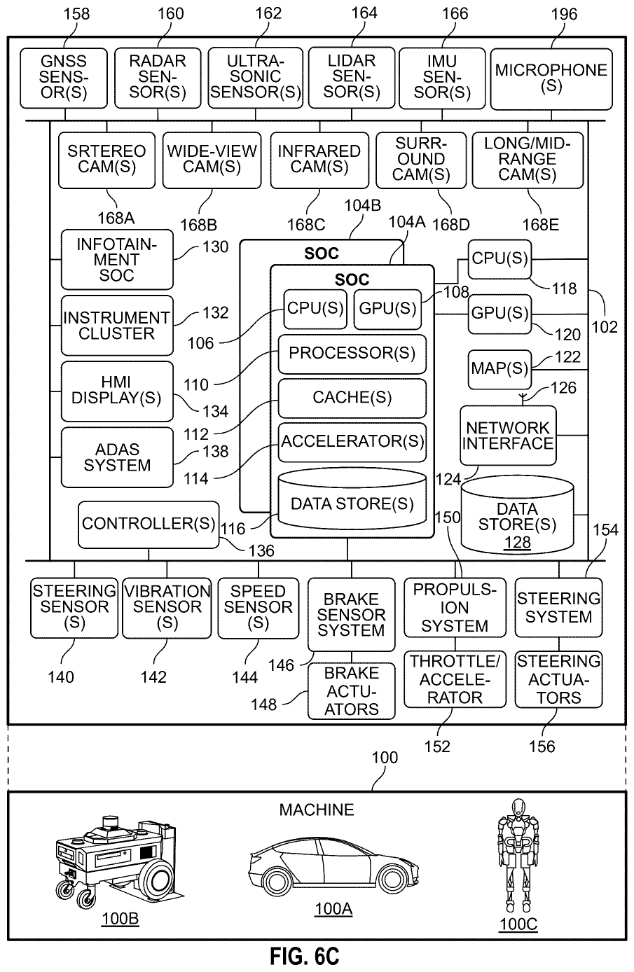

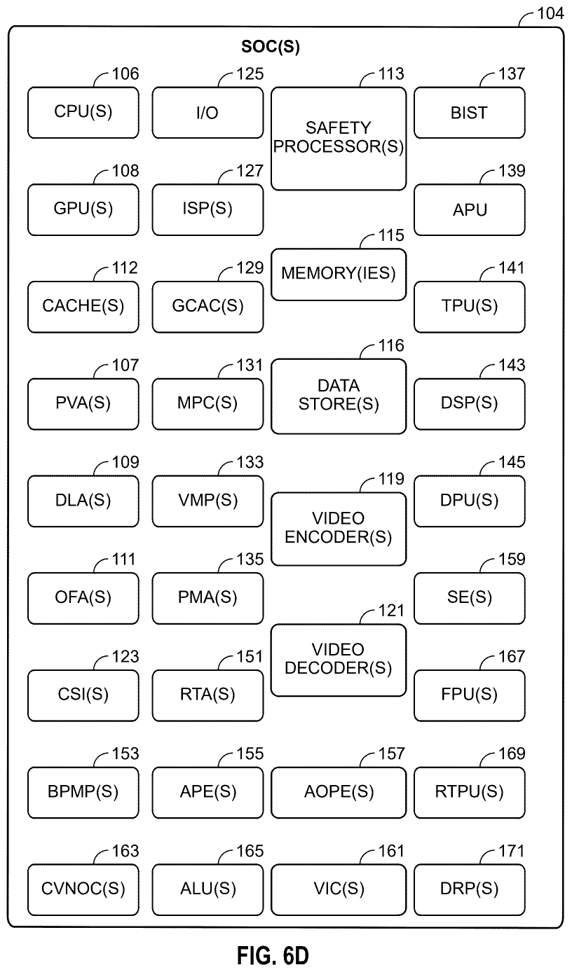

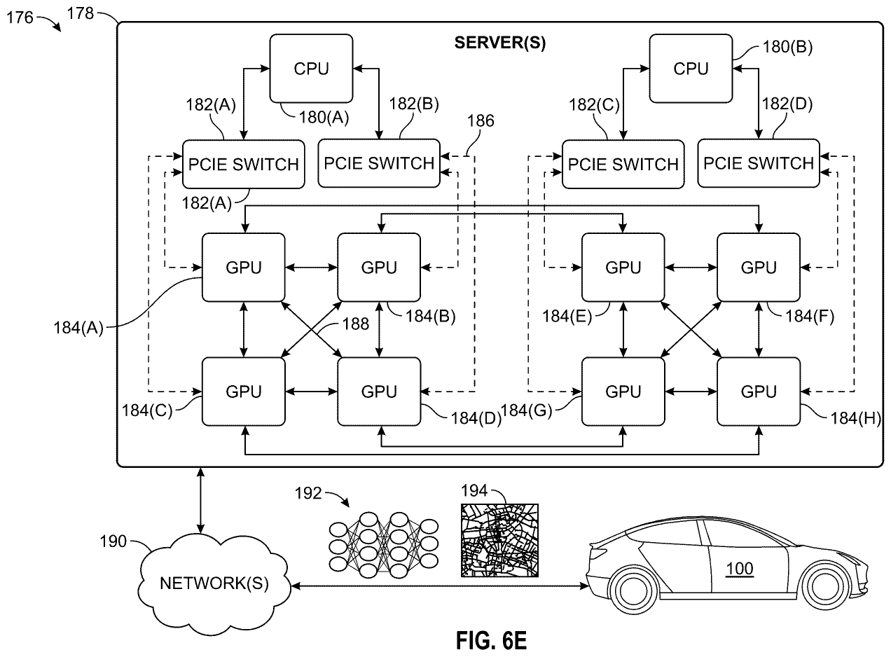

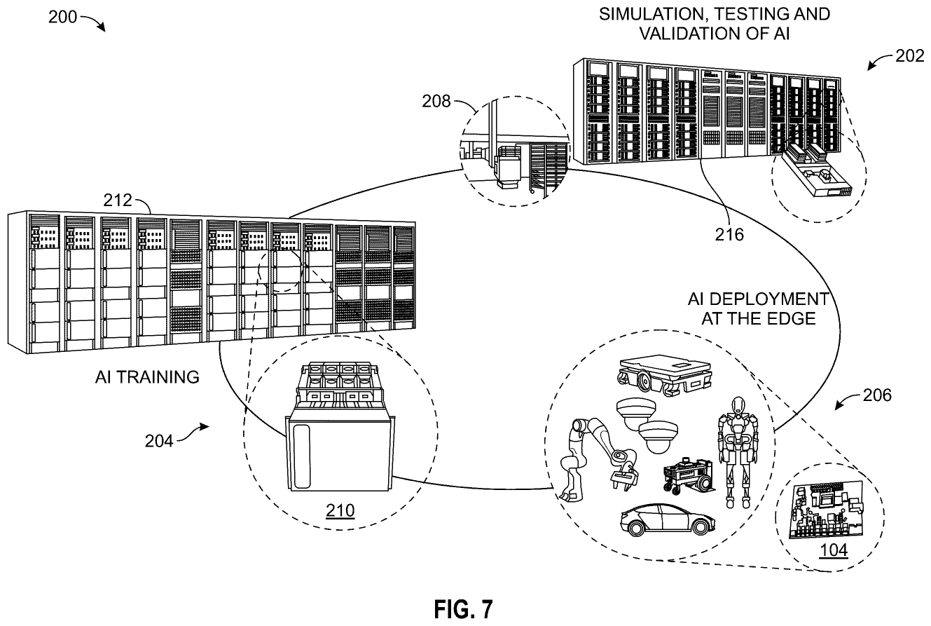

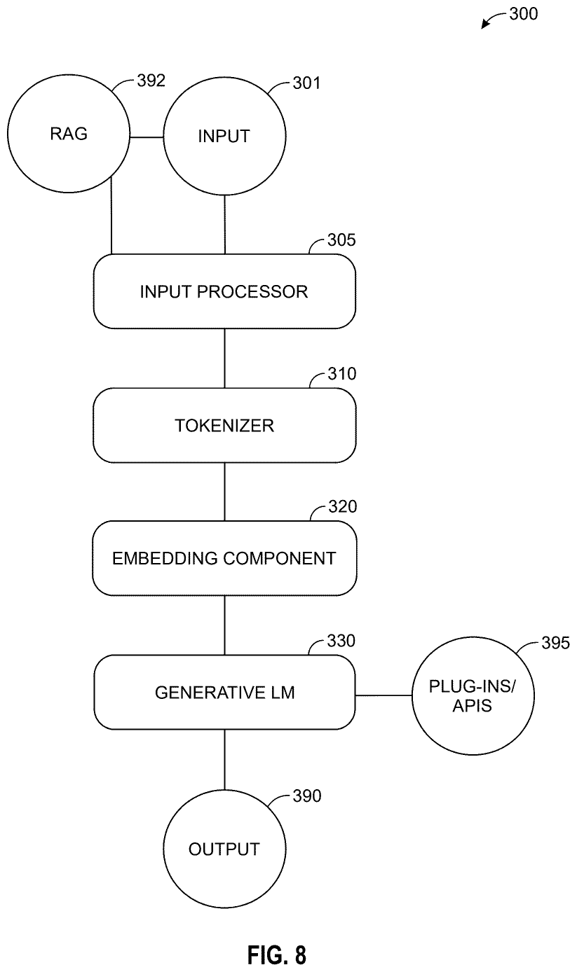

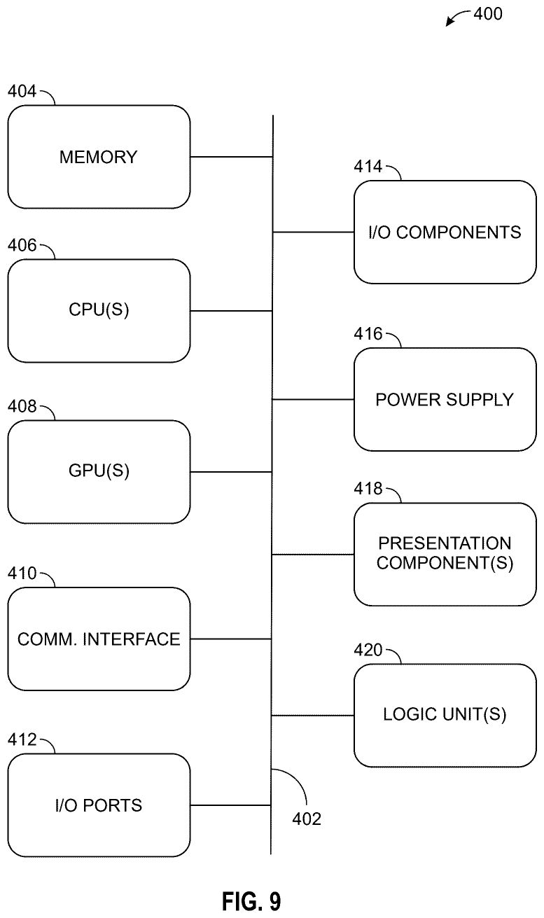

Systems and methods are disclosed related to scene reconstruction using reference timestamps and volumetric representations. Although the present disclosure can be described with respect to an example autonomous or semi-autonomous vehicle, robot, and/or other machine type 600 (alternatively referred to herein as “vehicle 600,” “ego-vehicle 600,” “machine 600,” “ego-machine 600,” “robot 600,” and/or “ego-robot 600,” an example of which is described with respect to FIGS. 6A-6E), this is not intended to be limiting. For example, the systems and methods described herein can be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure can be described with respect to scene reconstruction (e.g., volumetric scene generation, motion-aware rendering, frame interpolation, view synthesis, temporal consistency modeling), this is not intended to be limiting, and the systems and methods described herein can be used in extended reality (XR), augmented reality (AR), virtual reality (VR), mixed reality (MR), robotics, security and surveillance (e.g., smart cities), autonomous or semi-autonomous machine applications, industrial manufacturing, simulation, and/or any other technology spaces where scene reconstruction can be used. In some implementations, the systems, methods, and/or processes described herein can be executed using similar components, features, and/or functionality to those of example machine 600 of FIGS. 6A-6E, example computing ecosystem 700 of FIG. 7, example generative language model system 800 of FIG. 8, and/or example computing device 900 of FIG. 9.

This disclosure relates to systems and methods for scene reconstruction using a reference timestamp-based strategy. Modern visualization environments (e.g., XR systems, real-time simulation services, and/or high-fidelity content creation platforms) often include multiple components, such as monocular video capture modules, camera pose estimation services, and/or specialized compute nodes (e.g., GPUs or neural accelerators), to process tasks such as, frame segmentation and/or volumetric rendering. Traditional methods for reconstructing scenes typically use static background elements or rely on multi-view data captured from several cameras. For example, an application can be used to reconstruct the motion of a fast-moving subject using a single viewpoint, but the lack of properly encoded temporal or pose data often results in blurred or incomplete reconstructions. Some methods address partial dynamic reconstruction by embedding motion information into object-centric models or by applying per-frame optimizations. However, these methods do not consistently process long sequences of motion or complex interactions between multiple moving objects. Additionally, distributing motion-related parameters via local configurations at various capture nodes can result in inconsistent updates, with some nodes using outdated data and others requiring manual calibration.

Systems and methods in accordance with the present disclosure perform scene reconstruction by processing the spatial and temporal data of the scene at a reference timestamp. For example, implementations can receive a set of context frames, at least one (e.g., each) tagged with a camera pose and timestamp. A reference timestamp can be selected from among these timestamps, or between them, for generating a frozen volumetric representation of the scene. The approach can apply a vision model (e.g., a transformer-based network, a convolutional neural network trained for volumetric scene modeling, and/or any artificial intelligence (AI) model implemented to process context frames, camera poses, and reference timestamps to extract and map features to volumetric representations) to segment frames into patches, extracting features (e.g., image, pose, and/or time features), and/or mapping the features to 3D Gaussian parameters representing color, scale, orientation, opacity, and/or distance.

In some implementations, the disclosed systems and methods apply unprojection techniques to map two-dimensional (2D) pixel data into 3D space based on the camera poses, positioning 3D Gaussian splats at various depths. When dynamic objects are identified, the motion trajectories can be inferred from changes between context frames. That is, the motion trajectories can be used to arrange or update 3D Gaussians to output a volumetric representation that captures both static and moving objects and/or entities. Additionally, by freezing and/or otherwise fixing the scene parameters in relation to the reference timestamp of the scene, the volumetric representation can be rendered from different viewpoints, facilitating interactive manipulation, such as rotating, panning, and/or zooming around the frozen scene.

Systems and methods in accordance with the present disclosure can store multiple generated volumetric representations as a sequence of frames, creating a reconstruction of a video. In some implementations, the disclosed systems and methods can employ image-space training of the vision model, avoiding the use of computationally expensive three-dimensional ground-truth data. For example, a weighted sum of mean squared error and perceptual similarity losses can be computed between a rendered 2D image of the volumetric representation and the corresponding ground-truth image for backpropagation. Thus, the training (e.g., updating) can ensure that the model can be trained to reconstruct dynamic scenes from monocular video data, even when the training dataset (e.g., corpus) contains 2D color frames and associated camera parameters. Accordingly, the systems and methods can provide technical improvements to scene reconstruction. By selecting a reference timestamp, using context frames, and/or applying a vision model that processes spatial inputs and/or temporal inputs, and/or arranging 3D Gaussians to capture object motion, implementations address the technical inefficiencies of traditional methods and support high-fidelity volumetric outputs suitable for diverse applications in XR, simulation, content creation, real-time (or near real-time) motion analysis, high-fidelity video reconstruction, and/or automated cinematic effects.

In some implementations, the systems and methods can obtain a plurality of context frames of video data (e.g., monocular video). For example, the plurality of context frames can be with respect to a plurality of camera poses at a plurality of timestamps. Additionally, the system can determine a reference timestamp corresponding to at least one of the plurality of timestamps or between the plurality of timestamps of the plurality of context frames. For example, the reference timestamp can be selected from a timestamp that exists in the video or a fractional timestamp that can be computed between two recorded frames. In some implementations, the system can apply the plurality of context frames, the plurality of camera poses, and the reference timestamp as a plurality of inputs to a vision model to cause the vision model to generate a volumetric representation (e.g., 3D Gaussian splats) of a scene (e.g., dynamic or static) at the reference timestamp. Additionally, the system can provide the volumetric representation of the scene at the reference timestamp for rendering at a plurality of perspectives. For example, the parameters of the representation (e.g., color, opacity, scale, and rotation) can be used to render the visual details (e.g., allowing interactive manipulation of the scene (e.g., rotating, panning, zooming)) while maintaining visual fidelity and without updating the 3D Gaussian splats (e.g., just rendered from a new angle).

In some implementations, the systems and methods described herein can be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) can be used to determine scene reconstruction accuracy, interpolation consistency, and rendering performance, etc., and this information can be used to perform operations associated with the virtual machine within the simulation environment. These simulated operations can be used to test performance of the underlying algorithms, systems, and/or processes prior to deploying them in the real-world. In some instances, the simulation can be used to generate synthetic training data—e.g., reconstructed scenes, interpolated frames, and depth information from within the simulation. The synthetic training data (in addition to or alternatively from real-world data) can then be used or processed improve reconstruction models, refine temporal processing, and enhance scene consistency.

In any example, such as where a simulation environment is used for testing, validation, training, etc., the simulation environment and/or associated training data can be rendered or otherwise generated using one or more light transport simulation algorithms-such as one or more ray-tracing and/or path-tracing algorithms. Where light transport simulation is used, the simulation system can employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some implementations, the simulation environment and/or one or more objects, features, or components thereof can be generated or managed within a three-dimensional (3D) content collaboration platform (e.g., NVIDIA's OMNIVERSE) that can be optimized or suitable for industrial digitalization, generative physical artificial intelligence, and/or other use cases, applications, and/or services. For example, the content collaboration platform or system can include a system for using or developing universal scene descriptor (USD) (e.g., OpenUSD) data for managing objects, features, scenes, etc. within a simulated environment, digital environment, etc. The platform can include real physics simulation (e.g., using NVIDIA's PhysX software developer kit (SDK)), in order to simulate real physics and physical interactions with simulations hosted by the platform. The platform can integrate OpenUSD along with ray tracing/path tracing/light transport simulation (e.g., NVIDIA's RTX rendering technologies) into software tools and simulation workflows for building, training, deploying, and/or testing AI systems-such as systems for testing, validating, training (e.g., machine learning models, neural networks, etc.), and/or other tasks related to automobiles, robots, other machine types, and/or other systems and applications. In some examples, the simulation environment can include a digital twin of a real environment, such as a digital twin of a specific stretch of roadway, a warehouse, a data center, an airport, a geographic area, a marine area, and/or any other real environment where autonomous or semi-autonomous vehicles or machines can operate.

In some implementations, teleoperation or remote control of a vehicle, robot, and/or other machine can be performed using a remote control or teleoperation system. For example, the systems and methods described herein can be used to process and display reconstructed environments for remote operation that can be included in a visualization or mapping of an environment to aid a remote operator in controlling—or providing waypoints or other indications of control or navigation—an autonomous or semi-autonomous machine through an environment. As such, the remote operator can use the visual, audible, textual, and/or other clues or indicators generated using the systems and methods described herein to aid in navigating the vehicle, robot, machine, etc. through a real-world environment using the teleoperation system.

In some implementations, the system and methods described herein can be deployed in a robotics application. For example, a robot or robotic system can include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which can include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system can use these processors to execute one or more machine learning models (e.g., language models, language reasoning models (LRMs), vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system can use sensor fusion techniques to combine data from multiple sensors (e.g., cameras, infrared, LiDAR, RADAR, accelerometers) to create a comprehensive model of the robot's surroundings. This data can be processed locally on the robot or sent to remote servers for more computationally intensive tasks, such as 3D mapping or SLAM (Simultaneous Localization and Mapping). In one or more implementations, data from individual robots (e.g., sensor data, task status, or environmental conditions) can be uploaded to the cloud, where centralized AI models can analyze and distribute optimized commands to an entire fleet. In some implementations, the machine learning model(s) (e.g., language models, VLMs, LRMs, VLAS, LLMs, MMLMs, transformer models, diffusion models, NeRF models, DNNs, etc.) described herein can be used to allow the robot to perceive and reason about the environment and/or communicate with one or more other robots and/or persons in an environment. In some implementations, the robot can communicate (e.g., using one or more network interface cards (NICs) and/or data processing units (DPUs)) with one or more locally hosted servers/computing devices and/or with one or more remotely located servers/computing devices (e.g., in one or more data centers).

In some implementations, the system and methods described herein can be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) can include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which can include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system can use these processors to execute one or more machine learning models (e.g., language models) to allow features such as voice control, personalized media recommendations, dynamic navigation, and real-time communication with other services through network connectivity. The in-vehicle infotainment system can also use natural language processing (NLP) models to allow voice-based interaction. The one or more machine learning models can be stored locally or accessed through one or more APIs that connect to cloud services, enabling the system to process requests in real time or near real-time.

In some examples, the machine learning model(s) (e.g., deep neural networks, language models, LLMs, LRMs, VLMs, multi-modal language models, vision-language-action (VLA) models, perception models, tracking models, fusion models, transformer models, diffusion models, encoder-only models, decoder-only models, encoder-decoder models, neural rendering field (NeRF) models, etc.) described herein can be packaged as a microservice-such an inference microservice (e.g., NVIDIA NIMs)—which can include a container (e.g., an operating system (OS)—level virtualization package) that can include an application programming interface (API) layer, a server layer, a runtime layer, and/or a model “engine.” For example, the inference microservice can include the container itself and the model(s) (e.g., weights and biases). In some instances, such as where the machine learning model(s) is small enough (e.g., has a small enough number of parameters), the model(s) can be included within the container itself. In other examples—such as where the model(s) is large—the model(s) can be hosted/stored in the cloud (e.g., in a data center) and/or can be hosted on-premises and/or at the edge (e.g., on a local server or computing device, but outside of the container). In such implementations, the model(s) can be accessible via one or more APIs—such as REST APIs. As such, and in some implementations, the machine learning model(s) described herein can be deployed as an inference microservice to accelerate deployment of a model(s) on any cloud, data center, or edge computing system, while ensuring the data is secure. For example, the inference microservice can include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which can include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein can be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice can include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some implementations, the inference microservice can include software to perform in-place replacement and/or updating to the machine learning model(s). When replacing or updating, the software that performs the replacement/updating can maintain user configurations of the inference runtime software and enterprise management software.

Although examples can be described herein with respect to using machine learning models, such as neural networks, this is not intended to be limiting. For example, and without limitation, any of the various machine learning models and/or neural networks described herein can include any type of machine learning model, such as a machine learning model(s) using linear regression, logistic regression, decision trees, support vector machines (SVM), naive Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, language reasoning models (LRMs), large language models (LLMs), vision language models (VLMs), multi-modal language models (MMLMs), large action models (LAMs), vision-language-action (VLA) models, etc.), and/or other types of machine learning models.

The systems and methods described herein can be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein can be used for a variety of purposes, by way of example and without limitation, for machine control, machine locomotion, machine driving, synthetic data generation, model training, perception, extended reality (e.g., augmented reality, virtual reality, mixed reality, etc.), robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed implementations can be included in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models-such as large language models (LLMs), language reasoning models (LRMs,), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

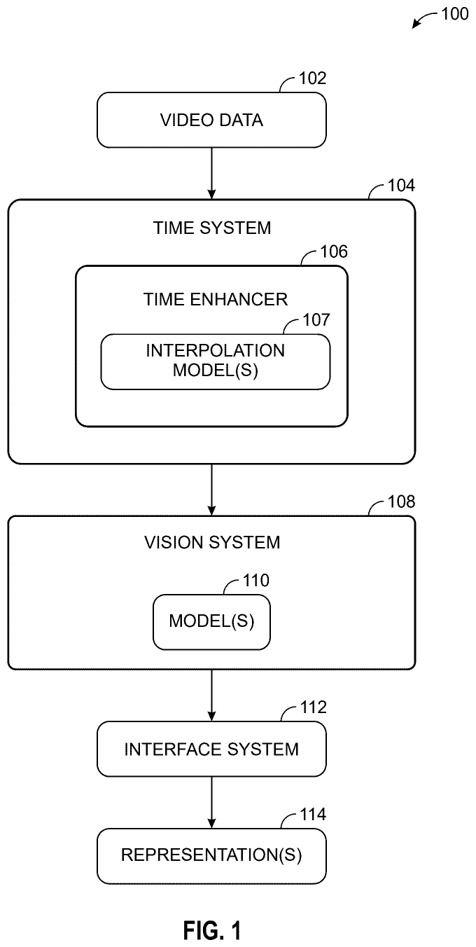

With reference to FIG. 1, FIG. 1 is an example block diagram of a system 100, in accordance with some implementations of the present disclosure. It should be understood that this and other implementations described herein are set forth only as examples. Other implementations, components, features, and elements (e.g., machines, interfaces, functions, orders, groupings of functions, etc.) can be used in addition to or instead of those shown, and some elements can be omitted altogether. Further, many of the implementations, components, features, elements, etc. described herein are functional entities that can be implemented as discrete or distributed components or in conjunction with other components, and in any suitable combination and location (e.g., on a local device, vehicle, or machine at the edge, on-premises-such as locally hosted servers, remotely located-such as in one or more computing or server devices in one or more data centers in the cloud, and/or at other locations). Various functions described herein as being performed by entities can be carried out by hardware, firmware, and/or software. For instance, various functions can be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some implementations, the systems, methods, and processes described herein can be executed using similar components, features, and/or functionality to those of example machine 600 of FIGS. 6A-6E, example computing ecosystem 700 of FIG. 7, example generative language model system 800 of FIG. 8, and/or example computing device 900 of FIG. 9.

The system 100 can implement at least a portion of a vision pipeline, such as a scene reconstruction pipeline, a motion estimation pipeline, or a volumetric rendering pipeline. The system 100 can be used to generate volumetric representations and/or process monocular video data by any of various systems described herein, including but not limited to XR systems, simulation systems, content creation systems, real-time motion analysis systems, video reconstruction systems, cinematic effects systems, and/or autonomous navigation systems.

Generally, the vision pipeline can include operations performed by the system 100. For example, the vision pipeline can include any one or more of a timing stage, a modeling stage, and/or an interfacing stage. Each stage of the vision pipeline includes one or more components of the system 100 that perform the functions described herein. In some implementations, one or more of the stages can be performed during the training of AI models. Additionally, one or more of the stages can be performed during the inference phase using the AI models.

Implementing the vision pipeline can include the system 100 obtaining a plurality of context frames of video data. The plurality of context frames can correspond to a plurality of camera poses at a plurality of timestamps. In some implementations, implementing the vision pipeline can include the system 100 determining a reference timestamp is one of (i) the plurality of timestamps or (ii) between two of the plurality of timestamps of the plurality of context frames. Additionally, implementing the vision pipeline can include the system 100 applying the plurality of context frames, the plurality of camera poses, and the reference timestamp as a plurality of inputs to a vision model to cause the vision model to generate a volumetric representation 114 of a scene at the reference timestamp. In some implementations, implementing the vision pipeline can include the system 100 providing the volumetric representation 114 of the scene at the reference timestamp for rendering at a plurality of perspectives. Thus, the vision pipeline can improve scene reconstruction efficiency, motion-aware rendering, and/or dynamic object representation by providing a feed-forward reconstruction model.

In some implementations, the timing stage can be the stage in the vision pipeline in which the system 100 can identify and process temporal relationships between context frames. The system 100 can include at least one time system 104. The time system 104 can obtain a plurality of context frames of video data 102 (e.g., monocular video captured from a single viewpoint that can represent a dynamic scene at different timestamps). That is, the time system 104 can obtain a set of visual data of a video captured at multiple times from multiple viewpoints.

That is, the time system 104 can obtain a monocular video (e.g., image sequence) represented by

$$I = {\{ {I}_{i} ∈ {ℝ}^{H \times W \times 3} \}}_{i = 1}^{N}$$

with N frames of width W and height H with known camera poses

$$P = {\{ {P}_{i} ∈ 𝕊𝔼 ( 3 ) \}}_{i = 1}^{N}$$

(e.g., intrinsics) and corresponding timestamps

$$T = {\{ {t}_{i} ∈ ℝ \}}_{i = 1}^{N} .$$

The time system 104 can extract timestamps and associate them with corresponding camera poses to determine temporal continuity across frames. The plurality of context frames can correspond to a plurality of camera poses (e.g., positions and orientations of a camera relative to the scene) at a plurality of timestamps (e.g., time values indicating when each frame was captured). For example, during the timing stage, the time system 104 can determine and/or otherwise identify at least one reference timestamp based on the plurality of timestamps or compute an intermediate timestamp for interpolation. In some implementations, the time system 104 can obtain and/or otherwise retrieve the video data 102 by accessing stored video data, extracting associated timestamps, and/or aligning context frames with corresponding camera poses.

In some implementations, the video data 102 can be sequential frame data associated with timestamped camera poses. That is, the plurality of context frames of the video data 102 can represent different moments in a scene that can be reconstructed as a volumetric representation 114 (shown as representation(s) 114 in FIG. 1). For example, the time system 104 can obtain the plurality of context frames by identifying sequential frame data corresponding to timestamped camera poses and selecting frames that represent different moments in the scene for volumetric reconstruction. In this example, a first context frame can be of a first camera pose capturing a horse and human competing in an equestrian event at a time T₁, a second context frame can be of a second camera pose capturing the horse and human competing in the equestrian event at a time T_{N-1}, and a third context frame can be of a third camera pose capturing the horse and human competing in the equestrian event at a time T_{N}.

In some implementations, the timing stage can be the stage in the vision pipeline in which the system 100 can identify a plurality of reference timestamps (e.g., observed or interpolated) based at least on iterating through the plurality of timestamps of the video data 102 corresponding to a monocular video. The time system 104 can determine a reference timestamp (also referred to herein as a “bullet time” representing a frozen moment in the scene for volumetric reconstruction) is one of the plurality of timestamps or between two of the plurality of timestamps of the plurality of context frames. That is, the time system 104 can determine a reference time matching one of the multiple times or a time between two of the multiple times. The reference timestamp can be selected from a timestamp that exists in the video data 102 or a fractional timestamp computed between two recorded frames. For example, a timestamp that exists in the video data 102 can be an actual recorded frame timestamp associated with a captured image and corresponding camera pose. In another example, a fractional timestamp computed between two recorded frames in the video data 102 can be an interpolated time value generated to reconstruct an intermediate scene representation that is not explicitly captured in the original frames.

In some implementations, the fractional timestamp (e.g., interpolated time value) and corresponding interpolated context frame can be determined by selecting adjacent timestamps from the plurality of context frames, interpolating the target pose based on the nearby camera poses, and generating an intermediate frame using an artificial intelligence (AI) model trained for temporal frame synthesis. The system 100 can include at least one time enhancer 106 of the time system 104 (e.g., component of, integrated within, configured as, implemented in, or operating as part of). The time enhancer 106 generates an interpolated frame at the reference timestamp different from the plurality of timestamps of the plurality of context frames. That is, the time enhancer 106 can synthesize interpolated frames with timestamps t ∉ T. The output of the time enhancer 106 can be used with other context views as input to the model(s) 110 to enhance reconstruction at arbitrary intermediate timestamps.

In some implementations, the time enhancer 106 can use at least one artificial intelligence (AI) model to predict an intermediate frame before inputting the context frames into the vision model (e.g., the model(s) 110 of the vision system 108). For example, the time enhancer 106 can apply a decoder-only interpolation (DOI) model and/or any other AI model trained on temporal embeddings and spatial embeddings to generate a frame at the interpolated timestamp (e.g., without rendering a 3D Gaussian representation). The interpolated frame can be determined by extracting feature embeddings from the nearest context frames, applying a self-attention mechanism to refine temporal consistency, and/or projecting the refined embeddings to an RGB image. Additionally, the time enhancer 106 can update the plurality of context frames to include the interpolated frame corresponding with the reference timestamp. That is, updating the context frames can include inserting the interpolated frame into the sequence of context frames and updating the corresponding timestamp list to reflect the reference timestamp. For example, the time enhancer 106 can adjust the sampling distribution of context frames to maintain an even temporal spread.

Generally, while the model(s) 110 (also referred to herein as “BulletTimer model”) can reconstruct the 3DGS representation for at least one (e.g., each) observed timestamps, implementing the model(s) 110 to reconstruct at a novel intermediate timestamp (e.g., performing interpolation at t_{b} ∉ T) can result in spatial misalignment and/or inconsistencies in motion representation due to the absence of visual data at the interpolated time. That is, the exact bullet-time frame cannot be included in the context frames as it does not exist. The model(s) 110 can exhibit reduced performance in predicting smooth transitions between adjacent video frames when the motion is complex and/or fast. This can be caused by the inductive bias of the pixel-aligned 3D Gaussian prediction. To improve performance, the time enhancer 106 (e.g., a 3D-free Novel Time Enhancer (NTE) module and/or system) can be implemented to output images at given timestamps (e.g., which can be used as input to the model(s) 110 of the vision system 108).

In some implementations, the time enhancer 106 can be implemented using a vision transformer (ViT) architecture. That is, the time enhancer 106 can implement interpolation model(s) 107 (e.g., decoder-only interpolation (DOI) model, attention-based temporal synthesis model, and/or any neural network model configured for frame interpolation) configured to generate a frame at a target timestamp by processing temporal and spatial features from context frames. For example, time features of the input context tokens (e.g., features representing temporal relationships between context frames) can be encoded into corresponding context timestamps, where

$${f}_{i}^{time}$$

can be equal to

$${f}_{i}^{ctx} .$$

The interpolation moder(s) 107 can be configured to concatenate additional target tokens representing the target timestamp and target camera pose, apply an attention mechanism to process these tokens, and generate an image at the target timestamp without rendering a 3D Gaussian representation. In some implementations, the interpolation model(s) 107 of the time enhancer 106 can apply an attention mask to restrict interactions between context tokens and target tokens, preventing information leakage during interpolation. The context tokens can be embeddings that encode spatial, temporal, and pose information, and can be processed by the transformer layers to refine the interpolation. The output embeddings corresponding to the target timestamp can be unpatchified and projected to RGB values at the original image resolution using a linear layer.

In some implementations, the time enhancer 106 can implement the interpolation model(s) 107 to process context embeddings derived from input frames, camera poses, and/or timestamps to generate an image at a target timestamp. During inference, the interpolation model(s) 107 can receive context tokens representing spatial, temporal, and pose embeddings extracted from context frames. For example, at least one (e.g., each) token can be derived by dividing an image into patches, where each patch can be linearly embedded into a feature space. In this example, the temporal embeddings can encode context timestamps, and the pose embeddings can encode camera parameters. The embeddings can be summed with image feature embeddings to create the input tokens. Additional target tokens encoding the target timestamp and interpolated pose can be concatenated to the input sequence. In some implementations, the interpolation model(s) 107 can apply an attention mask to ensure that context tokens (e.g., only) contribute to self-attention calculations in transformer layers, while the target tokens aggregate information from context embeddings (e.g., without leaking information from the target frame during training). After processing through multiple transformer layers, the output embeddings corresponding to the target tokens can be extracted, unpatchified, and/or projected through a final linear layer to generate an RGB image at the target timestamp.

In some implementations, the interpolation model(s) 107 of the time enhancer 106 can include a plurality of layers such as self-attention layers (e.g., trained to compute contextual dependencies between context embeddings and target embeddings), feedforward layers (e.g., trained to refine token representations after self-attention computations), normalization layers (e.g., trained to stabilize training and prevent gradient vanishing or explosion), and linear projection layers (e.g., trained to map token embeddings to RGB values for frame synthesis)

During training, the time enhancer 106 can improve the interpolation model(s) 107 using a weighted combination of mean squared error (MSE) loss and/or perceptual similarity loss (LPIPS), computed between the synthesized target frame and the corresponding ground-truth frame at the target timestamp. The time enhancer 106 can train (e.g., update) the interpolation model(s) 107 on a dataset containing static scenes and/or dynamic scenes, where context frames can be randomly selected, and target timestamps can be sampled directly from observed frames and/or interpolated between existing timestamps. The time enhancer 106 can train the interpolation model(s) 107 using QK-normalization to stabilize self-attention computations and KV-Cache optimization to accelerate inference by caching key-value pairs from context embeddings across transformer layers (e.g., embedding layers), reducing redundant computation. For example, QK-normalization can include scaling query-key dot products based on statistical normalization to maintain stable attention scores and prevent over-amplification of token importance. In another example, KV-Cache optimization can include storing previously computed key-value pairs for context embeddings across transformer layers to avoid re-computation during autoregressive inference, reducing latency and improving memory efficiency.

Additionally, the time enhancer 106 can concatenate extra target tokens (e.g., tokens representing the target timestamp and interpolated camera pose) to the input tokens, which can encode the target timestamp, and the target pose for which the time enhancer 106 can generate the RGB image. In some implementations, a QK-normalization (e.g., a normalization technique applied to query-key dot products to stabilize attention scores and prevent gradient instability during training) can be implemented to stabilize training. The training can be performed using a weighted combination of mean squared error (MSE) loss and/or perceptual similarity loss (LPIPS) to improve frame synthesis accuracy while maintaining perceptual quality. Additionally, an attention mask can be applied to mask at least one (e.g., each, all) attention to the target tokens, such that KV-Cache (e.g., a caching mechanism that stores key-value pairs for previously computed context embeddings, preventing redundant computation and improving inference efficiency) can be used for improved inference. The time enhancer 106 can obtain the target token(s) (e.g., from the output of the final self-attention layer of the transformer model).

In some implementations, from the output of the transformer layers, the time enhancer 106 retains the target tokens, which can be unpatchified and projected to RGB values at the original image resolution using a single linear layer. The interpolation model(s) 107 can be trained with the same or similar objective as the model(s) 110 but the output image can be directly decoded from the network (e.g., instead of being from a 3DGS representation). That is, the time enhancer 106 can generate additional visual data (e.g., context frame(s)) representing a new view of the scene at the reference time and update the set of visual data to include the additional visual data. That additional visual data is different from the set of visual data. The interpolation model(s) 107 can generate interpolated RGB frames from token embeddings without relying on volumetric scene reconstruction. In some implementations, to reconstruct a bullet-time 3DGS at t_{b} ∉ T, the system 100 can use the interpolation model(s) 107 to synthesize I_{b} at the timestamp t_{b}, where the target pose P_{b} can be linearly interpolated from the nearby context poses in P (e.g., where P is a set of camera poses corresponding to the plurality of context frames, each associated with a timestamp and spatial transformation parameters) and the context frames can be selected and/or otherwise determined as the nearest frames to t_{b}. To accelerate the inference of the interpolation model(s) 107, the time enhancer 106 can implement KV-Cache techniques. Additionally, the use of the interpolation model(s) 107 can add negligible overhead to the overall runtime.

In some implementations, the modeling stage can be the stage in the vision pipeline in which the system 100 processes spatial and temporal scene information to construct a volumetric representation 114 based on context frames, camera poses, and/or timestamps. The vision system 108 can generate a plurality of volumetric representations of the scene at a plurality of different reference timestamps. That is, at least one (e.g., each) representation can correspond to a reference timestamp and reflect the state of the scene at that moment in time. The sequence can capture both static and dynamic elements. The system 100 can include at least one vision system 108. The vision system 108 can apply the plurality of context frames, the plurality of camera poses, and the reference timestamp as a plurality of inputs to a vision model (e.g., model(s) 110, such as transformer-based bullet-time reconstruction model, also referred to herein as “BulletTimer”) to cause the vision model to generate a volumetric representation 114 of a scene (e.g., dynamic and/or static scenes) at the reference timestamp. That is, the vision system 108 can generate, using at least one artificial intelligence (AI) model, a three-dimensional (3D) representation of a scene at the reference time based on the set of visual data. The volumetric representation 114 can be a 3DGS scene frozen at a specified bullet timestamp. That is, given a monocular video (e.g., image sequence) represented by

$$I = {\{ {I}_{i} ∈ {ℝ}^{H \times W \times 3} \}}_{i = 1}^{N}$$

with known camera poses

$$P = {\{ {P}_{i} ∈ 𝕊𝔼 ( 3 ) \}}_{i = 1}^{N}$$

and the corresponding timestamps

$$T = {\{ {t}_{i} ∈ ℝ \}}_{i = 1}^{N} ,$$

the vision system 108 can implement a feed-forward model (e.g., the model(s) 110) configured to output (e.g., for rendering) high-quality novel views at arbitrary timestamps t ∈ [t₁, t_{N}]]. The vision system 108 can identify a plurality of reference timestamps based at least on iterating through the plurality of timestamps of the video data corresponding to a monocular video. For example, during modeling stage the vision system 108 can segment input frames into patches, extract spatial and temporal features, and process these features through transformer layers to compute a volumetric representation 114 at the selected reference timestamp.

In some implementations, the input tokens can contain features (e.g., image features, pose features, and time features) and at least one (e.g., each) token can correspond to a patch and/or element of the context frames. The tokens containing the features can be processed through the embedding layers of the model(s) 110 to transform the raw features into structured representations. Generally, the vision system 108 can segment at least one context frame of the plurality of context frames into a plurality of patches (e.g., input frame having a resolution of H×W, at least one (e.g., each) patch having dimensions P×P such that the frame can be segmented into (H/P)×(W/P) patches). The vision system 108 can generate at least one token of a plurality of tokens for at least one of the plurality of patches. For example, the token can include at least one image feature (f^{rgb} at least one pose feature (f^{pose}), and at least one time feature (fₜᵢₘₑ).

The vision system 108 can apply a subset of frames l_{c} ⊂l (e.g., context frames) and corresponding poses P_{c}⊂P and timestamps T_{c} ⊂T as input to the model(s) 110 to cause the model(s) to output a representation (e.g., 3D Gaussian Splat (3DGS)) of a scene frozen at a specified bullet timestamp t_{b} ∈ [min_{Tc}, max_{Tc}] (e.g., where min_{Tc} is the earliest timestamp within the selected context frames and max_{Tc} is the latest timestamp within the selected context frames). That is, the features (e.g., f^{rgb}, f^{pose}, fₜᵢₘₑ) can be represented as input tokens in the self-attention layers of the model(s) 110 for feature encoding and spatial-temporal correlation learning. Iterating over at least one (e.g., each, all) t_{b} ∈ T (e.g., where T is the set of all timestamps in the input video sequence) results in a video reconstruction represented by a sequence of 3DGS. That is, the model(s) 110 can be trained and/or implemented to generate temporally consistent volumetric representations by learning spatial correspondences between frames and predicting object motion trajectories across timestamps. That is, the model(s) 110 can apply the plurality of tokens (e.g., tokens encoding the features) as the plurality of inputs to the vision model to cause the vision model to generate (e.g., modeling the spatial and temporal dynamics of the scene) the volumetric representation 114. The model(s) 110 can map at least one output token of the vision model to at least one parameter of a three-dimensional (3D) Gaussian. That is, at least one (e.g., each) corresponding output token can be decoded into 3DGS parameters (e.g., using a linear layer of the model(s) 110). The at least one parameter can include at least one of color, scale, rotation, opacity, and/or a distance along a ray. For example, at least one (e.g., each) 3D Gaussian can be parametrized by its RGB color, scale, rotation, opacity, and/or ray distance (e.g., having n number of parameters per Gaussian).

The vision system 108 and/or time enhancer 106 can include any one or more artificial intelligence models (e.g., machine learning models, supervised models, neural network models, deep neural network models), rules, heuristics, algorithms, functions, or various combinations thereof to perform operations including volumetric scene reconstruction, frame interpolation, and multi-view synthesis, such as processing monocular video frames to generate temporally consistent 3D representations of dynamic scenes. That is, model(s) 110 can be a neural network and/or machine-learning (ML) model trained to extract spatial and temporal features from context frames, predict scene dynamics, and generate intermediate representations for reconstruction and rendering. The model(s) 110 can divide at least one (e.g., each) input context frame lᵢ ∈ l_{c} into n×n patches (e.g., 8×8 patches), which can be projected into feature space

$${\{ {f}_{ij}^{rgb} \}}_{j - 1}^{HW / 64}$$

using a linear embedding layer. The camera Plücker embeddings can be derived from the camera poses Pᵢ ∈ P_{c} and the time embeddings can be processed similarly to form the camera pose features

$$\{ {f}_{i j}^{pose} \}$$

and the time features

$$\{ {f}_{i}^{time} \}$$

(shared for all patches j). The features can be added and/or otherwise aggregated together to form the input tokens for the patches of the context frame,

$${\{ {f}_{i j} \}}_{j = 1}^{H W / 64} where {f}_{i j} = {f}_{i j}^{rgb} + {f}_{i j}^{pose} + {f}_{i}^{time} .$$

The input tokens from at least one (e.g., each, all) input time feature

$${f}_{i}^{time}$$

can be obtained from: (i) context timestamp tᵢ that can be separate for at least one (e.g., each) context frame Iᵢ, and/or (ii) bullet timestamp t_{b} that can be shared across all context frames i. Both timestamp scalars can be encoded using Positional Encoding (PE) (e.g., sinusoidal encoding method that represents temporal information as continuous functions to preserve relative ordering and periodicity across timestamps) with sinusoidal functions, and then passed through two linear layers to obtain the features

$${f}_{i}^{c t x} and {f}_{i}^{bullet}$$

respectively. Thus, the time feature can be set as

$${f}_{i}^{time} = {f}_{i}^{ctx} + {f}_{i}^{bullet} .$$

In some implementations, the vision system 108 can output 3D Gaussian splats, (e.g., volumetric scene representations, interpolated frames, depth-aware embeddings, and/or temporally consistent feature maps). For example, the output can be a reconstructed scene at a selected reference timestamp, where 3D Gaussians can be positioned to represent the spatial structure and motion trajectories of objects. In another example, the output can be a synthesized intermediate frame at an interpolated timestamp. In some implementations, the interpolated frames can be provided to vision system 108 to perform frame-based reconstruction, motion trajectory refinement, and/or temporal consistency in volumetric rendering. In some implementations, each corresponding output token

$${f}_{i j}^{out}$$

can be decoded into 3DUS parameters Gᵢⱼ ∈ [symbol] ^{8×8×12} using a single linear layer of the model(s) 110. That is, at least one (e.g., each) 3D Gaussian can be parameterized by its RGB color c ∈ [symbol] ³, scale s ∈ [symbol] ³, rotation represented as unit quaternion q ∈ [symbol] ⁴, opacity σ ∈ [symbol] , and ray distance τ ∈ [symbol] , resulting in 12 parameters per Gaussian. For example, the 3D position of each Gaussian μ ∈ R³ can be obtained using pixel-aligned unprojection as μ=o+τd, where o ∈ [symbol] ³ and d ∈ [symbol] ³ can be the ray origin and direction obtained from Pᵢ.

In some implementations, the vision system 108 can maintain, execute, train, update, and/or otherwise process, refine, or apply one or more artificial intelligence (AI) models during the modeling stage. In some implementations, the AI model(s) can include any type of vision transformer-based, convolutional, and/or hybrid AI model capable of processing multi-frame scene reconstruction (e.g., self-attention networks, optical flow estimation models) to generate temporally and spatially coherent volumetric representations from monocular video data. For example, the AI model(s) can be trained and/or updated to segment frames into patches, extract image, pose, and/or time features, and apply learned transformations to produce volumetric representations, among other scene processing tasks. The AI model(s) can be or include a transformer-based model (e.g., a generative pre-trained transformer (GPT) model, a bidirectional encoder representations from transformers (BERT)). The machine-learning model(s) can be or include a vision transformer (ViT) model in some implementations. The vision system 108 can execute the AI model to generate outputs. The vision system 108 can receive data to provide as input to the AI model(s), which can include context frames, camera pose embeddings, time embeddings, and/or learned scene parameters.

In some implementations, the vision system 108 can execute one or more AI models (e.g., model(s) 110) by utilizing a modeling framework to improve the performance of the AI model during the modeling stage. The framework can include implementing techniques such as gradient descent, backpropagation, and distributed training to process large-scale datasets. The AI model(s) can incorporate mechanisms such as spatial-temporal regularization and feature attention weighting to maintain efficiency and prevent overfitting. For example, during execution, the vision system 108 can partition input data into mini-batches, apply loss functions, and update model parameters iteratively. The AI models can support inference operations that include processing feature vectors, transforming raw input data, and generating probabilistic predictions and/or metrics. The vision system 108 can integrate hardware accelerators such as GPUs or TPUs to handle high-dimensional computations for volumetric reconstruction and temporal interpolation, for example when processing large sequences of frames for dynamic scene modeling.

In some implementations, the vision system 108 can evaluate trained models using various metrics (e.g., precision, recall, and/or F1 score) and/or any frame reconstruction accuracy metric, temporal consistency measure, and/or perceptual quality metric to determine readiness for deployment and/or inference operations. The evaluation can include analyzing model performance on validation datasets, testing datasets, or real-world data inputs to assess consistency and robustness. For example, the vision system 108 can compare model predictions against ground truth data to determine accuracy metrics, error rates, and/or confidence intervals. In another example, the vision system 108 can track performance variations over multiple evaluation cycles to identify potential degradation and/or drift in model accuracy. The evaluation can include the vision system 108 applying techniques such as cross-validation, Monte Carlo simulations, and/or adversarial testing to measure resilience against noise or distributional shifts.

In some implementations, the vision system 108 can generate performance metrics and/or data structures including metric values, confusion matrices, and/or calibration plots to identify model effectiveness. The performance metrics and/or data structures can be used to facilitate retraining procedures, model adjustments, and/or fine-tuning processes if evaluation criteria are not met. The vision system 108 can integrate threshold-based criteria, such as enforcing an F1 score above a predefined value, before permitting the model(s) 110 to be deployed for inference. In some implementations, model evaluation can include automated testing pipelines that perform predefined test cases, analyze false positive and false negative rates, and/or apply statistical significance tests to validate improvements.

In some implementations, the vision system 108 can include at least one AI model (e.g., model(s) 110). The model(s) 110 can include an input layer, an output layer, and/or one or more intermediate layers, such as hidden layers, which can each have respective nodes. That is, the model(s) 110 extracts spatial and temporal features, encode scene representations, and/or generate volumetric reconstructions. For example, the input layer processes context frames, camera pose embeddings, and/or time embeddings. For example, the output layer predicts Gaussian parameters, including color, opacity, scale, rotation, and/or ray distance, to define the reconstructed scene. For example, the intermediate layers apply self-attention mechanisms, positional encoding, and/or spatial-temporal feature fusion to improve reconstruction quality.

In some implementations, the model(s) 110 of the vision system 108 can include a plurality of layers such as self-attention layers (e.g., trained to model spatial and temporal dependencies between context frames, such as 24 self-attention blocks applied at the beginning and end of the model(s) 110), embedding layers (e.g., trained to encode image patches, pose information, and timestamp representations into a shared feature space), feed-forward layers (e.g., trained to process extracted features and refine volumetric representations), and/or output layers (e.g., trained to map transformer-processed tokens to 3D Gaussian parameters, including color, scale, rotation, opacity, and ray distance). The self-attention blocks operate at both the beginning and end of the model(s) 110 to refine how spatial and temporal information can be captured and processed. At the beginning of the model(s) 110, the self-attention layers can receive input tokens that encode image patches, camera poses, and timestamps and determine relationships between these tokens to establish spatial coherence and temporal alignment across context frames. At the end of the model(s) 110, the self-attention layers can refine the learned feature representations by re-weighting token interactions based on the global context derived throughout the transformer processing. The model(s) 110 can concatenate features from multiple context frames and apply a vision transformer (ViT)-based architecture to process sequential and spatial relationships within input data. Additionally, LayerNorm can be applied at both the beginning and end of self-attention blocks to stabilize training. The model(s) 110 can generate a volumetric representation 114 by segmenting input frames into patches, encoding positional and temporal embeddings, and/or transforming extracted tokens into a structured Gaussian representation for rendering.

In some implementations, the system 100 can configure (e.g., train, update, fine-tune, apply transfer learning to) the model(s) 110 by modifying or updating one or more parameters, such as weights and/or biases, of various nodes of the model(s) 110 responsive to evaluating estimated outputs of the model(s) 110 (e.g., generated in response to receiving training examples in a training dataset, such as a training dataset including monocular video sequences, synthetic scene reconstructions, and/or real-world dynamic motion datasets). The vision system 108 can be or include various neural network models, including models that can operate on or generate data including but not limited to volumetric renderings, interpolated scene frames, temporally-aware embeddings, and/or Gaussian parameterized scene representations, and/or various combinations thereof.

In some implementations, the vision system 108 can be configured (e.g., trained, updated, fine-tuned, has transfer learning performed, etc.) based at least on the training data of the at least one training dataset (e.g., frame interpolation datasets, multi-view synthesis datasets, dynamic scene datasets). For example, one or more example context frames and/or camera pose embeddings of the training data can be applied (e.g., by the system 100 and/or in a pre-training and/or tuning process performed by the system 100 or another system) as input to the vision system 108 to cause the vision system 108 to generate an estimated output. The estimated output can be evaluated and/or compared with ground truth images (or reference volumetric reconstructions) of the training data that correspond with the one or more example scene timestamps and/or pose representations, and the model(s) 110 of the vision system 108 can be updated based at least on the loss computed from image-space and perceptual similarity functions. For example, based at least on an output of the reconstruction loss function, one or more parameters (e.g., weights and/or biases) of model(s) 110 of the vision system 108 can be updated.

In some implementations, the vision system 108 can determine at least one performance metric based on at least one loss function and a ground-truth image and update at least one model parameter of the model(s) 110 based on the at least one performance metric (e.g., weights of layer(s) are updated to minimize the difference between rendered and ground-truth images). That is, the vision system 108 can compute a weighted sum of mean squared error loss and perceptual similarity loss (e.g., using one of two strategies) comparing the rendered image to a ground-truth image. For example, a first supervision strategy can be employed in which the reference timestamp corresponds to at least one timestamp of the plurality of context frames. In another example, a second supervision strategy can be employed in which the reference timestamp lies between two timestamps of the plurality of context frames, causing the model(s) 110 to process temporal interpolation of at least one dynamic region of the scene.

Generally, training can include implementing in-context supervision and interpolation supervision. That is, the vision system 108 can perform in-context supervision by selecting a supervision timestamp from the plurality of context frames, applying the plurality of context frames and the corresponding camera poses as inputs to the vision model, generating a volumetric representation 114 at the supervision timestamp, and/or computing a loss between a rendered image from the volumetric representation 114 and a ground-truth image corresponding to the supervision timestamp. For example, the vision system 108 can randomly select a context frame as the supervision frame, extract its associated timestamp and camera pose, and/or propagate the extracted data through the vision model to obtain predicted 3D Gaussian parameters, where the predicted parameters can be used to generate a rendered 2D image that is compared to the ground-truth image at the supervision timestamp using a weighted combination of mean squared error loss and perceptual similarity loss. Additionally, the vision system 108 can perform interpolation supervision by selecting a supervision timestamp that lies between two adjacent context frames, generating an interpolated volumetric representation 114 at the supervision timestamp, and/or computing a loss between the interpolated rendered image and a ground-truth image at the supervision timestamp. For example, the vision system 108 can compute the supervision timestamp as a fractional time value between two adjacent timestamps, determine interpolated camera poses using linear interpolation, generate an interpolated context frame using a time enhancement model, apply the interpolated frame and the surrounding context frames as inputs to the vision model, and/or compute a reconstruction loss based on a rendered image from the generated volumetric representation 114 and a corresponding ground-truth image.

In some implementations, the vision system 108 can generate a sequence of volumetric representations by iteratively setting the bullet timestamp to each timestamp in the video. That is, the vision system 108 can apply the model(s) 110 to reconstruct a volumetric representation 114 at least one (e.g., each) timestamp by processing a plurality of context frames, camera poses, and/or interpolated scene data. For example, the vision system 108 can reconstruct a video longer than the number of training context views |l_{c}| by including the exact timestamp t_{b}=t while uniformly distributing the remaining |l_{c}|−1 required context frames across the entire video duration to form an input batch. In another example, the vision system 108 can generate a volumetric representation 114 for an interpolated timestamp t_{b} ∉ T by selecting the nearest context frames, computing an interpolated camera pose, and/or applying the time enhancement model to synthesize an intermediate frame at the interpolated timestamp. The interpolated frame can be applied as an additional input to the model(s) 110 to improve volumetric reconstruction at timestamps without direct observations. That is, the vision system 108 can iteratively reconstruct the full sequence of volumetric representations in parallel by applying the model(s) 110 to at least one (e.g., each) timestamp, maintaining temporal consistency across frames, and/or refining Gaussian parameters to preserve spatial coherence in the reconstructed scene.

In some implementations, the vision system 108 can implement and/or otherwise facilitate a pre-training in which model(s) 110 is trained on large-scale, unstructured datasets to learn foundational representations (e.g., spatiotemporal relationships in monocular video data, depth-conditioned scene features, and/or implicit representations for volumetric reconstruction). The pre-training can include self-supervised learning techniques such as masked token prediction, next-token prediction, contrastive learning, and/or denoising objectives to develop generalized feature representations. For example, model(s) 110 can be exposed to large corpora of monocular video sequences, synthetic multi-view datasets, and/or reference timestamp-based reconstructions to extract statistical patterns, semantic relationships, and/or latent structures. In another example, model(s) 110 can apply unsupervised clustering techniques to identify recurrent patterns and correlations in the training data (e.g., Gaussian parameter distributions, spatial feature consistency across timestamps, and/or learned depth priors). The pre-training phase can include updating model parameters based on loss functions computed from predicting missing or corrupted data points. The vision system 108 can apply distributed training techniques, including data parallelism, model parallelism, and/or pipeline parallelism, to optimize the computational efficiency of pre-training. The output (e.g., time-aligned embeddings, interpolated spatial features, and/or Gaussian-conditioned volume representations) of the pre-training phase can be used to initialize model(s) 110 for subsequent fine-tuning on domain-specific tasks.

In some implementations, model(s) 110 can support static reconstructions (by equalizing all elements in T) and dynamic scene reconstruction using only RGB loss for weak supervision. The model(s) 110 can use the availability of numerous static datasets to perform pretraining. That is, unlike other models (e.g., GS-LRM or MVSplat) where different models are used in different domains the model(s) 110 can be understood as a universal (e.g., kitchen-sink) reconstruction model that is not specific to any dataset, allowing the model(s) 110 to be generalized to both static and dynamic scenes, and capable of handling objects as well as both indoor and outdoor scenes.

In some implementations, a first training stage, the interpolation model(s) 107 and/or the model(s) 110 can be trained using low-resolution and high-resolution static pretraining. To obtain a more generalizable 3D prior as initialization, the interpolation model(s) 107 and/or the model(s) 110 can be pretrained with a mixture of static datasets. In some implementations, time embedding cannot be used in a first stage. The collection of static datasets can capture object-centric and indoor and/or outdoor scenes. The static datasets can capture both the synthetic and real-world domains (e.g., consist of 390K training samples). The vision system 108 can normalize the scales of different static datasets to be bounded (e.g., in a 10³ cube). Additionally, the interpolation model(s) 107 and/or the model(s) 110 can begin training from a low-resolution few-view setting that reconstructs on 128×128 resolution from |l_{c}|=4 context views. To further increase the reconstruction details, the vision system 108 can fine-tune the interpolation model(s) 107 and/or the model(s) 110 from 128×128 by first increasing the image resolution to 256×256, and then fine-tune to 512×512, in some implementations.

In some implementations, a second training stage, the interpolation model(s) 107 and/or the model(s) 110 can be trained using dynamic scene co-training. That is, after the training the interpolation model(s) 107 and/or the model(s) 110 on static scenes, the vision system 108 can fine-tune the interpolation model(s) 107 and/or the model(s) 110 with time embedding projection layers on dynamic scenes with 4D data that contains monocular and/or multi-view synchronized videos. Additionally, during the second training stage, the static datasets for co-training can be used to increase multi-view supervision and stabilize the training. Additionally, the vision system 108 can label the camera poses and add the labeled camera poses to the training set to further improve the robustness of the interpolation model(s) 107 and/or the model(s) 110 with regards to real-world data.

In some implementations, a third training stage, the model(s) 110 can be trained using long-context window fine-tuning. The vision system 108 can increase the number of context views from |l_{c}|=4 to |l_{c}]=12 to cover more frames. That is, the vision system 108 can adjust the training pipeline to incorporate additional context frames.

In some implementations, the vision system 108 can implement and/or otherwise facilitate fine-tuning in which model(s) 110 is updated to specific tasks (e.g., reference timestamp-based volumetric reconstruction, motion-aware Gaussian positioning, and/or temporally coherent novel view synthesis) using domain-specific training datasets (e.g., multi-view video sequences, interpolated scene reconstructions, and/or depth-enhanced datasets). The fine-tuning process can include supervised learning, reinforcement learning, and/or contrastive learning to refine the pre-trained representations. For example, the vision system 108 can train the model to generate a volumetric representation 114 using a vision model applied to a plurality of context frames, where training is guided by image-space supervision (e.g., rather than explicit 3D ground-truth data). The vision system 108 can update model(s) 110 by adjusting weights, biases, and/or layer-specific parameters based on task-specific loss functions. For example, fine-tuning can include minimizing a weighted combination of Mean Squared Error (MSE) loss and Learned Perceptual Image Patch Similarity (LPIPS) loss computed between a rendered 2D image from the generated volumetric representation 114 and the corresponding ground-truth image. For example, the losses defined in the RGB image space (e.g., without using any source of 3D ground truth) can be determined as a weighted sum by: [symbol] _{RGB}= [symbol] _{MSE}+λ [symbol] _{LPIPS}, where λ can be a weighting factor that can be tuned based on empirical validation to improve reconstruction quality across both static and dynamic scenes.

In some implementations, fine-tuning can be performed using techniques such as adaptive supervision loss balancing, where the contribution of MSE and LPIPS losses is dynamically weighted based on scene complexity and object motion stability. The vision system 108 can iteratively evaluate model(s) 110 on validation datasets (e.g., dynamic monocular video reconstructions, reference timestamp-based scene interpolations, and/or multi-frame temporally synchronized volumetric representations) to track performance changes, mitigate overfitting, and/or determine convergence criteria. Fine-tuning outputs can be evaluated against reference benchmarks (e.g., perceptual similarity metrics, Gaussian parameter stability assessments, and/or pose-conditioned interpolation accuracy scores) to assess task alignment, efficiency improvements, and/or robustness against adversarial inputs.

In some implementations, the vision system 108 can implement and/or otherwise facilitate retrieval-augmented generation (RAG) models to improve output quality of model(s) 110 by incorporating external knowledge sources. The RAG architecture can include a retrieval system and a generation system, where the retrieval system of vision system 108 can fetch relevant documents, embeddings, or structured data (e.g., previously stored volumetric reconstructions, interpolated Gaussian splat configurations, object motion priors, and/or depth-conditioned scene embeddings) from knowledge bases (e.g., monocular video scene archives, synthetic dataset repositories, pose-aligned feature databases, and/or large-scale motion trajectory datasets), and the generation system of vision system 108 can synthesize responses using retrieved content. The vision system 108 can utilize vector search techniques such as FAISS, approximate nearest neighbor (ANN) search, and/or BM25 ranking to identify relevant retrieval candidates. For example, model(s) 110 can retrieve contextually relevant volumetric representations (e.g., multi-frame Gaussian splat reconstructions, reference timestamp-based depth projections, temporally conditioned scene features, and/or pose-aligned object transformations) from an indexed database and use the retrieved content as additional input for generating responses. In some implementations, the vision system 108 can dynamically update retrieval parameters based on query complexity, information density, and/or response ambiguity. The retrieval process can be reinforced using feedback mechanisms, where low-confidence generations trigger additional retrieval iterations. The vision system 108 can integrate hybrid approaches that combine parametric memory from model(s) 110 with non-parametric retrieval sources.

In some implementations, the vision system 108 can implement and/or otherwise facilitate a sparse expert-based model architecture. The model(s) 110 can utilize a Mixture of Experts (MoE) framework, where a subset of expert networks can be dynamically activated per inference step based on input characteristics. For example, when a set of context frames with high-speed motion is provided, the vision system 108 can activate an expert network trained for rapid object tracking and pose-consistent Gaussian splat updates. The MoE structure can include multiple specialized sub-networks, at least one (e.g., each) trained on different aspects of volumetric data processing, and a gating mechanism that selects the relevant experts for a given query. In some implementations, the vision system 108 can include optimizations such as multi-head latent attention, which reduces computational overhead by selectively encoding high-priority motion trajectories and filtering static scene elements during inference. The model(s) 110 can integrate both local and global attention mechanisms, where local attention can process immediate frame-to-frame feature correspondences and global attention can capture long-range temporal dependencies. Additionally, the model(s) 110 can implement soft token merging to reduce redundant input representations and adaptive token inflation to restore lost details during late-stage volumetric synthesis. For example, the model(s) 110 can apply selective Gaussian refinement to maintain spatial consistency and minimize volumetric drift in reconstructed scenes. The vision system 108 can further improve inference performance by employing hardware acceleration techniques, including tensor parallelism and/or memory-efficient caching strategies. The system 100 can execute the sparse expert-based model architecture (e.g., model(s) 110) for volumetric scene interpolation, reference timestamp-based frame synthesis, dynamic object tracking, and/or multi-perspective reconstruction from monocular video data.

In some implementations, the model(s) 110 (e.g., vision model) can generate the volumetric representation 114 based on an unprojection (e.g., obtain the 3D position of each Gaussian using pixel-aligned unprojections) of a plurality of image patches. The model(s) 110 can perform an unprojection of a plurality of pixel locations from at least one context frame of the plurality of context frames into 3D space based on the plurality of camera poses (e.g., defining the ray origin (starting point) and direction for at least one pixel). The unprojection can map 2D pixel locations of a context frame into 3D space. In some implementations, the model(s) 110 can assign at least one distance parameter to the plurality of pixel locations to position a plurality of 3D Gaussians along a plurality of rays. That is, using the rays with pixel locations determined, a distance parameter can be assigned to at least one (e.g., each) pixel to position it along its corresponding ray in 3D space. Further, the model(s) 110 can update at least one 3D parameter of the plurality of 3D Gaussians to represent a portion of the scene. That is, a Gaussian splat parameter (e.g., color, scale, opacity) can be updated to reflect the dynamic changes in the scene (e.g., moving objects, temporal changes), derived from the context frames and reference timestamp.

Generally, the plurality of 3D Gaussians can be positioned based at least on a plurality of spatial changes corresponding to at least one motion trajectory of at least one object between the plurality of context frames. In some implementations, dynamic scene reconstruction can allow camera angle or viewpoints to change. Additionally, the plurality of 3D Gaussians can be configured for rendering from the plurality of perspectives and to represent the at least one motion trajectory of the at least one object within the scene at the reference timestamp. That is, the 3D Gaussians can be rendered from any angle or viewpoint without recalculating the Gaussian positions. For example, when a scene is “frozen” a user can rotate, pan, and/or zoom to examine the scene from different angles or viewpoints.

In some implementations, the model(s) 110 (e.g., vision model) can generate the volumetric representation 114 based on a plurality of pose embeddings (e.g., e.g., Plücker embeddings derived from the camera poses) based on the plurality of camera poses. That is, the pose embeddings can be used to generate the volumetric representation 114 by encoding spatial relationships between the camera viewpoints and aligning projected pixel data from context frames into a shared coordinate space for 3D Gaussian reconstruction. The pose embeddings can be processed through transformer layers to establish spatial correspondences between context frames. In some implementations, the model(s) 110 (e.g., vision model) can generate the volumetric representation 114 based on a plurality of time embeddings (e.g., the input time features-obtained from context timestamps and bullet timestamps—can be used to obtain at least one context time feature and/or bullet time feature) based on the plurality of timestamps and the reference timestamp. That is, the time embeddings can be used to generate the volumetric representation 114 by modulating temporal relationships between context frames, encoding motion dynamics across timestamps, and/or interpolating missing frame information when reconstructing volumetric representations at arbitrary reference timestamps. The encoded time features can guide the model(s) 110 in distinguishing static elements from dynamic objects.

In some implementations, the interfacing stage can be the stage in the vision pipeline in which the system 100 can render, store, and distribute volumetric representations for interactive viewing and further processing. The system 100 can include at least one interface system 112. The interface system 112 can provide the volumetric representation 114 of the scene at the reference timestamp for rendering at a plurality of perspectives. That is, the interface system 112 can provide the 3D representation for viewing from multiple perspectives. The interface system 112 can render the perspectives according to parameters of the representation (e.g., color, opacity, scale, and rotation) to allow rendering of visual details regardless of the viewing angle. For example, the plurality of perspectives can support interactive scene manipulation (e.g., rotation, panning, zooming) while preserving visual fidelity, rendering the 3D Gaussian splats from different viewpoints without modifying their parameters.

In some implementations, the interface system 112 can allow and/or facilitate manipulations of the interactive scene by adjusting rendering viewpoints in response to user input, dynamically modifying camera perspectives, and/or integrating user-defined transformations such as scaling or depth adjustments. That is, the interface system 112 can interpret input signals (e.g., gestures, camera movements, and/or positional tracking data) from a user device and apply corresponding modifications to the rendered volumetric representation. The user device (e.g., a virtual reality headset, augmented reality display, touchscreen interface, or other interactive system) can generate interaction data based on user actions, such as touch gestures, mouse movements, controller inputs, and/or head tracking. The interface system 112 can receive the interaction data, update rendering parameters accordingly, and transmit the updated volumetric representation back to the user device for display. For example, when the user device detects a zoom gesture, the interface system 112 can adjust the camera distance and re-render the volumetric representation at an updated perspective while preserving 3D Gaussian parameters. In another example, when the user device registers a rotational input, the interface system 112 can modify the viewpoint and transmit the adjusted scene without recomputing the volumetric representation.

In some implementations, the interface system 112 can store and/or provide the plurality of volumetric representations as a sequence of volumetric frames corresponding to a reconstructed scene. For example, during the interfacing stage, the interface system 112 can manage real-time and/or near real-time rendering requests, encode volumetric representations into a format suitable for storage or transmission, and/or synchronize volumetric data across different viewing devices. In some implementations, the interface system 112 can provide and/or otherwise distribute the volumetric representation by transmitting rendered scene data to external display systems, saving reconstructed frames in a storage medium, and/or streaming interactive visualizations. That is, providing can include encoding volumetric representations into structured formats (e.g., scene graphs, mesh-based representations, and/or voxel grids), facilitating playback through rendering pipelines, and/or integrating reconstructed views into extended reality (XR) applications. For example, the interface system 112 can generate scene buffers for real-time and/or near real-time visualization, transmit multi-perspective views to remote users, and/or dynamically update rendering parameters based on user interactions.

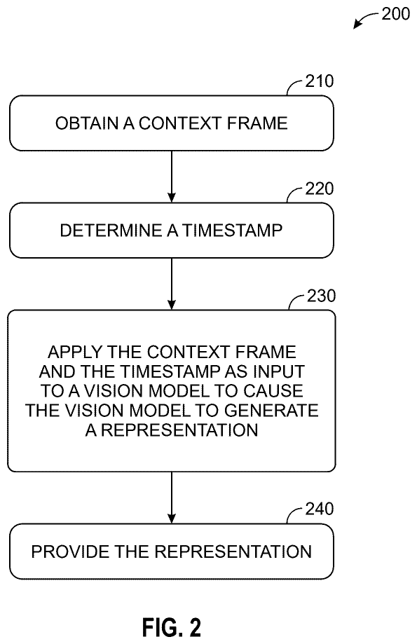

With reference to FIG. 2, an example flow diagram illustrating a method for scene reconstruction using reference timestamps and volumetric representations in a vision pipeline in a vision pipeline, in accordance with some implementations of the present disclosure. It should be understood that this and other implementations described herein are set forth only as examples. Other implementations, components, features, and elements (e.g., machines, interfaces, functions, orders, groupings of functions, etc.) can be used in addition to or instead of those shown, and some elements can be omitted altogether. Further, many of the implementations, components, features, elements, etc. described herein are functional entities that can be implemented as discrete or distributed components or in conjunction with other components, and in any suitable combination and location (e.g., on a local device, vehicle, or machine at the edge, on-premises-such as locally hosted servers, remotely located-such as in one or more computing or server devices in one or more data centers in the cloud, and/or at other locations). Various functions described herein as being performed by entities can be carried out by hardware, firmware, and/or software. For instance, various functions can be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some implementations, the systems, methods, and processes described herein can be executed using similar components, features, and/or functionality to those of example machine 600 of FIGS. 6A-6E, example computing ecosystem 700 of FIG. 7, example generative language model system 800 of FIG. 8, and/or example computing device 900 of FIG. 9.

Now referring to FIG. 2, each block of method 200, described herein, includes a computing process that can be performed using any combination of hardware, firmware, and/or software. For instance, various functions can be carried out using one or more processors (such as, but not limited to, those described herein) executing instructions stored in one or more memories or memory systems. In some implementations, the computer processes can also be embodied as computer-usable instructions stored on computer storage media. The methods can be provided by a standalone application, a service or hosted service (standalone or in combination with another hosted service), an application programming interface (API) and/or a plug-in to another product, etc. In addition, method 200 is described, by way of example, with respect to FIGS. 6A-6E, 7, 8, and 9. However, these methods can additionally or alternatively be executed by any one system, or any combination of systems, including, but not limited to, those described herein.

FIG. 2 is a flow diagram showing a method 200 for obtaining, determining, applying, and/or providing operations (among other operations), in accordance with some implementations of the present disclosure. Various operations of method 200 can relate to improving the temporal consistency and accuracy of volumetric scene reconstruction in video-based processing pipelines. Existing systems often rely on and/or use explicit 3D ground-truth data or dense frame-by-frame optimization, which can lead to high computational costs, temporal inconsistencies, and limitations in handling dynamic scenes. The existing technological problems can arise when these systems fail to interpolate accurate intermediate frames, resulting in motion artifacts, loss of geometric consistency, and/or increased processing latency. Method 200 of FIG. 2 can solve these technological problems by implementing learned time-aware embeddings, transformer-based feature aggregation, and Gaussian-based volumetric representations, thereby improving reconstruction efficiency, interpolation accuracy, and/or rendering fidelity.

The method 200, at block 210, includes obtaining a plurality of context frames of video data. In some implementations, the processing circuits can obtain a set of visual data of a video captured at multiple times from multiple viewpoints. The plurality of context frames correspond to a plurality of camera poses at a plurality of timestamps. That is, the processing circuits and/or processing circuitry can extract image features, pose embeddings, and temporal information from the context frames to construct input tokens for transformer-based processing. For example, obtaining the context frames can include accessing monocular video sequences and extracting spatial and temporal features from the video data. The camera poses and timestamps can be identified from embeddings (e.g., Plücker embeddings from camera intrinsics and extrinsics, learned latent pose representations, and/or any feature-based encoding of camera transformations) derived from camera parameters, where timestamps can be used to encode temporal ordering and motion cues for downstream interpolation and reconstruction. Plücker embeddings can refer to a mathematical representation of lines in 3D space using Plücker coordinates, which can encode both position and orientation information. The embeddings can be derived from camera parameters to represent camera poses.

The method 200, at block 220, includes determining a reference timestamp (e.g., bullet time) is one of the plurality of timestamps or between two of the plurality of timestamps of the plurality of context frames. In some implementations, the processing circuits can determine a reference time matching one of the multiple times or a time between two of the multiple times. In some implementations, the processing circuits can select from a timestamp that exists in the video data or a fractional timestamp that can be determined between two recorded frames. That is, the processing circuits can compute the reference timestamp by selecting an observed timestamp from the plurality of context frames and/or interpolating a fractional timestamp between adjacent context frames using temporal interpolation. The processing circuits can analyze motion trajectories, frame timing, and/or scene dynamics to determine a reference timestamp for reconstruction. In some implementations, the processing circuits can generate, using at least one artificial intelligence (AI) model (e.g., interpolation model), an interpolated frame at the reference timestamp different from the plurality of timestamps of the plurality of context frames. That is, an AI model can be used to predict an intermediate frame before applying the frames as input into the vision model. Additionally, the processing circuits can update the plurality of context frames to include the interpolated frame corresponding with the reference timestamp. In some implementations, the processing circuits can generate additional visual data (e.g., interpolated frame) representing a new view (e.g., novel view) of the scene at the reference time, the additional visual data is different from the set of visual data. Additionally, the processing circuits can update the set of visual data to include the additional visual data.

The method 200, at block 230, includes apply the plurality of context frames, the plurality of camera poses, and the reference timestamp as a plurality of inputs to a vision model to cause the vision model to generate a volumetric representation of a scene (e.g., dynamic or static scenes) at the reference timestamp. In some implementations, the processing circuits can generate, using an artificial intelligence (AI) model, a three-dimensional (3D) representation of a scene at the reference time based on the set of visual data. In some implementations, the processing circuits can generate, using the vision model, a volumetric representation of a scene at the reference timestamp based on the plurality of context frames, the plurality of camera poses, and the reference timestamp. That is, the vision model can be a transformer-based reconstruction model. The volumetric representation can be a 3DGS scene frozen at a specified bullet timestamp. The vision model can model the input tokens containing features (e.g., image features, pose features, and time features). At least one (e.g., each) token can correspond to a patch or element of the context frames. The tokens containing the features can be processed through the model layers transforming the raw features into structured representations. In some implementations, the processing circuits can generate, using the vision model, the volumetric representation based at least on an unprojection of a plurality of image patches, (ii) a plurality of pose embeddings based on the plurality of camera poses, and/or (iii) a plurality of time embeddings based on the plurality of timestamps and the reference timestamp. The unprojection can include obtaining the 3D position of at least one (e.g., each) Gaussian using pixel-aligned unprojections. The pose embeddings can be Plücker embeddings derived from the camera poses. The time embeddings can be the input time feature obtained from context timestamps and bullet timestamps.

In some implementations, the processing circuits can segment at least one context frame of the plurality of context frames into a plurality of patches. That is, the input to the vision model can be input frames having a resolution of H×W, at least one (e.g., each) patch having dimensions P×P, and the frame being segmented into (H/P)×(W/P) patches. The processing circuits can generate at least one token of a plurality of tokens for at least one of the plurality of patches. The token (e.g., input token) can include at least one image feature, at least one pose feature, and at least one time feature. In some implementations, applying the plurality of context frames, the plurality of camera poses, and the reference timestamp as the plurality of inputs can include the processing circuits applying the plurality of tokens as the plurality of inputs to the vision model to cause the vision model to generate the volumetric representation. That is, the input tokens encoding the features can be processed using a transformer-based architecture (e.g., to model the spatial and temporal dynamics of the scene). Additionally, the vision model can map at least one output token of the vision model to at least one parameter of a three-dimensional (3D) Gaussian. That is, generating the 3D representation can include converting an output of the AI model into visual rendering data (e.g., color, size, orientation, transparency, or depth in the scene) defining a 3D shape. For example, at least one (e.g., each) corresponding output token can be decoded into 3DGS parameters (e.g., using a linear layer). That is, the processing circuits can convert an output of the AI model (e.g., 3D representation) into visual rendering data (e.g., a parameter, such as size, orientation, transparency, and/or depth in the scene) defining a 3D shape. The at least one parameter can include at least one of color, scale, rotation, opacity, and/or a distance along a ray. For example, at least one (e.g., each) 3D Gaussian can be parametrized by its RGB color, scale, rotation, opacity, and/or ray distance (e.g., n number of parameters per Gaussian).

In some implementations, applying the plurality of context frames, the plurality of camera poses, and the reference timestamp to the vision model to cause the vision model to generate the volumetric representation can further include the processing circuits performing an unprojection (e.g., map 2D pixel locations of a context frame into 3D space) of a plurality of pixel locations from at least one context frame of the plurality of context frames into 3D space based on the plurality of camera poses. In some implementations, applying the plurality of context frames, the plurality of camera poses, and the reference timestamp to the vision model to cause the vision model to generate the volumetric representation can further include the processing circuits assigning at least one distance parameter (e.g., to a corresponding ray in 3D space) to the plurality of pixel locations to position a plurality of 3D Gaussians along a plurality of rays. In some implementations, applying the plurality of context frames, the plurality of camera poses, and the reference timestamp to the vision model to cause the vision model to generate the volumetric representation can further include the processing circuits updating at least one 3D parameter (e.g., gaussian splat parameter (e.g., color, scale, opacity) can be updated to reflect the dynamic changes in the scene (e.g., moving objects, temporal changes), derived from the context frames and reference timestamp) of the plurality of 3D Gaussians to represent a portion of the scene.

In some implementations, the processing circuits can identify a plurality of reference timestamps (e.g., observed or interpolated) based at least on iterating through the plurality of timestamps of the video data corresponding to a monocular video. Additionally, the processing circuits can apply the plurality of context frames, the plurality of camera poses, and at least one of the plurality of reference timestamps as the plurality of inputs to the vision model to cause the vision model to generate a plurality of volumetric representations of the scene at a plurality of different reference timestamps. At least one (e.g., each) volumetric representation can correspond to a reference timestamp and reflect the state of the scene at that moment in time. In some implementations, the processing circuits can store and/or provide the plurality of volumetric representations as a sequence of volumetric frames corresponding to a reconstructed scene. For example, the sequence can capture both static and dynamic elements.

The method 200, at block 240, includes providing the volumetric representation of the scene at the reference timestamp for rendering at a plurality of perspectives. In some implementations, the processing circuits can provide the 3D representation for viewing from multiple perspectives. That is, parameters of the representation (e.g., color, opacity, scale, and rotation) can allow the rendering of visual details regardless of the viewing angle (i.e., allowing interactive manipulation of the scene (e.g., rotating, panning, and/or zooming) while maintaining visual fidelity without updating the 3D Gaussian splats (e.g., just rendered from a new angle). In some implementations, the plurality of 3D Gaussians can be positioned based at least on a plurality of spatial changes corresponding to at least one motion trajectory of at least one object between the plurality of context frames. That is, the processing circuits can provide dynamic scene reconstruction allowing camera angle or viewpoints to be updated and/or changed. Additionally, the plurality of 3D Gaussians can be configured for rendering from the plurality of perspectives and to represent the at least one motion trajectory of the at least one object within the scene at the reference timestamp. That is, the rendering can be from any angle or viewpoint without recalculating the Gaussian positions. For example, when a scene is “frozen” a user could rotate, pan, and/or zoom to examine the scene from different angles or viewpoints.

In some implementations, the processing circuits can render at least one two-dimensional (2D) image from the volumetric representation of the scene at the reference timestamp. For example, the rendering can be from a virtual camera view. In some implementations, the processing circuits can determine at least one performance metric based on at least one loss function and a ground-truth image. That is, the processing circuits can determine and/or otherwise compute a weighted sum of mean squared error loss and perceptual similarity loss comparing the rendered image to a ground-truth image. For example, a first supervision strategy can be employed in which the reference timestamp corresponds to at least one timestamp of the plurality of context frames. In another example, a second supervision strategy can be employed in which the reference timestamp is between two timestamps of the plurality of context frames, causing the vision model to process temporal interpolation of at least one dynamic region of the scene. In some implementations, the processing circuits can update at least one model parameter of the vision model based on the at least one performance metric. For example, the processing circuits can update weights (e.g., model parameters) of transformer layer(s) and/or feature embedding layer(s) to minimize and/or reduce the difference between rendered and ground-truth images.

The systems and methods described herein can be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein can be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed implementations can be included in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

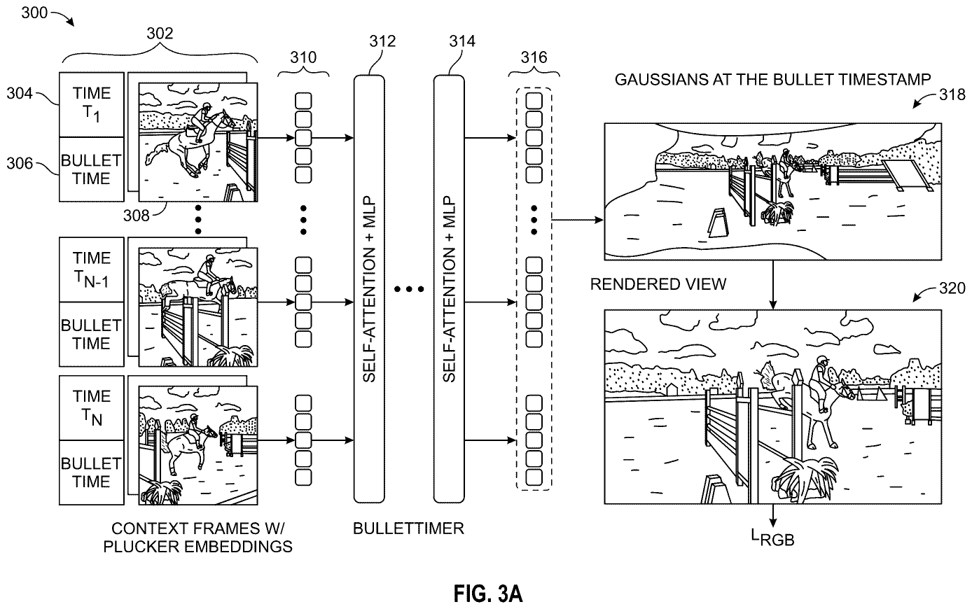

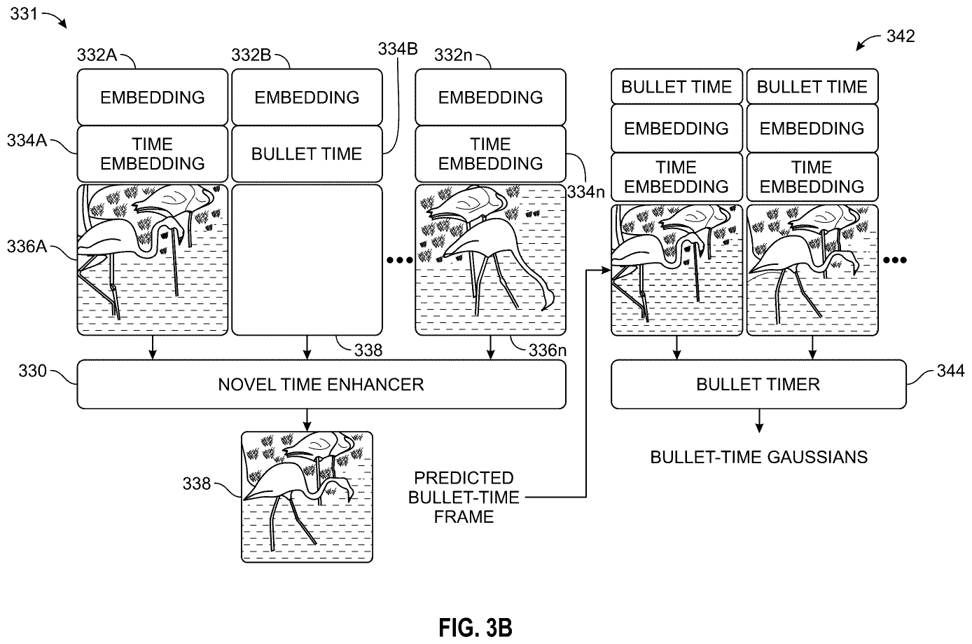

Referring now to FIG. 3A, a block diagram of the vision pipeline of system 100, in accordance with some implementations of the present disclosure. The vision pipeline of system 100 (described in greater detail with reference to FIG. 1) can include a set of context frames 302, where at least one (e.g., each) context frame can correspond to a timestamp (e.g., time T₁, time T_{N-1}, time T_{N}) 304 and a reference timestamp (e.g., bullet time) 306. The context frames 302 can include scene images 308 representing different viewpoints of a dynamic event (e.g., an equestrian jump). The vision pipeline of system 100 can extract image features, pose features (e.g., Plücker embeddings), and/or time features from the context frames 302 to form a set of input tokens 310. The input tokens 310 can be processed by a transformer-based vision model (e.g., BulletTimer, such as model(s) 110 and/or interpolated model(s) 107 of FIG. 1) including self-attention and/or multilayer perceptron (MLP) layers 312 and 314. The output tokens 316 can represent scene parameters for generating a volumetric representation (e.g., 3D Gaussian splats) at the bullet timestamp. The Gaussians at the bullet timestamp 318 can be used to reconstruct the scene from different perspectives. The vision pipeline of system 100 can generate a rendered view 320 of the reconstructed scene using the volumetric representation. The rendered view 320 can be supervised using an image-space loss function (e.g., L_{RGB}) to improve reconstruction accuracy.

Referring now to FIG. 3B, a block diagram of a time enhancer pipeline 331, in accordance with some implementations of the present disclosure. The time enhanced pipeline can be implemented by the time enhancer 106 and/or interpolation model(s) 107 of system 100 of FIG. 1. The time enhancer pipeline 331 can apply a time enhancement model (e.g., novel time enhancer (NTE) 330, such as interpolation model(s) 107 of FIG. 1) to generate interpolated frames at a reference timestamp (e.g., bullet time). The time enhancer pipeline 331 can receive a plurality of context frames 336A-336n, at least one (e.g., each) associated with embeddings 332A-332n, time embeddings 334A-334n, and bullet timestamps 334B. The embeddings 332A-332n can encode image, pose, and/or spatial information and the time embeddings 334A-334n can encode temporal relationships between the context frames. The NTE 330 (including the same features and functionality as the interpolation model(s) 107 of FIG. 1) can generate a predicted bullet-time frame 338 using learned temporal attention mechanisms and interpolation techniques. That is, the predicted bullet-time frame 338 before modeling is represented as an uninitialized frame with no image content and/or reconstructed features. The predicted bullet-time frame 338 can be provided as an additional context frame to BulletTimer 344 (including the same features and functionality as the vision system 108 and model(s) 110 of FIG. 1), which can generate a volumetric representation of the scene at the interpolated bullet timestamp. The BulletTimer 344 can output bullet-time Gaussians 342 representing the reconstructed scene. The time enhancer pipeline 331 can improve motion coherence and reconstruction accuracy by providing temporally consistent interpolated frames before volumetric rendering.

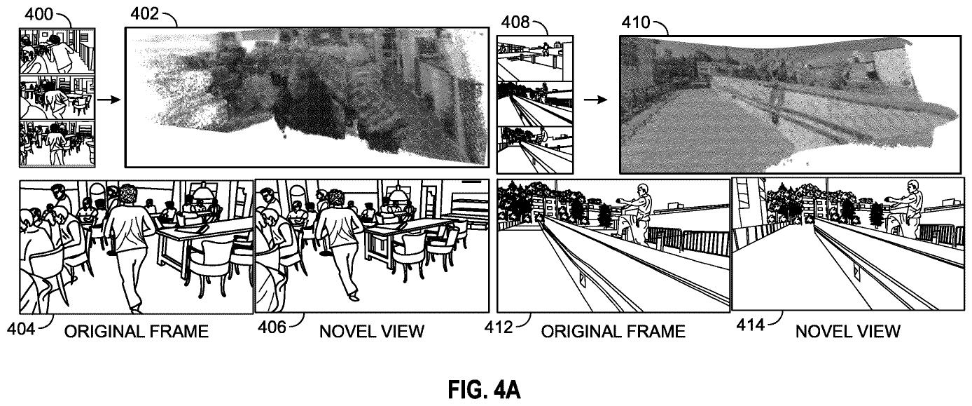

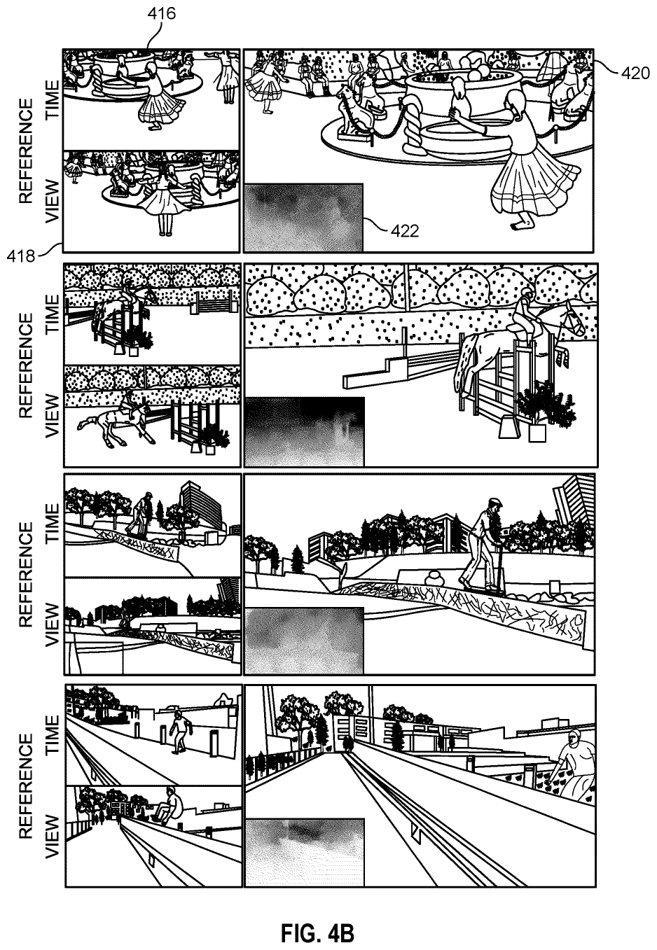

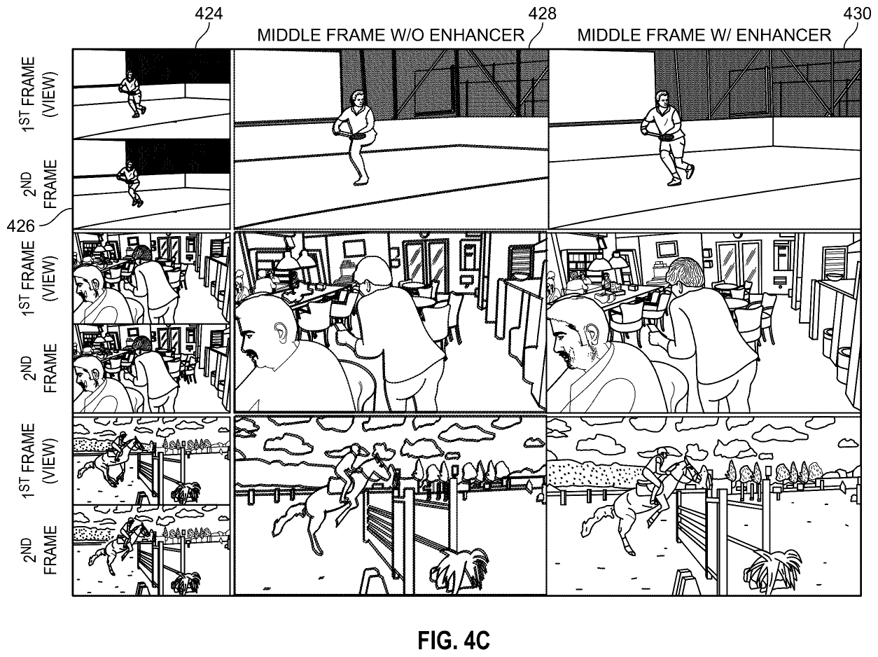

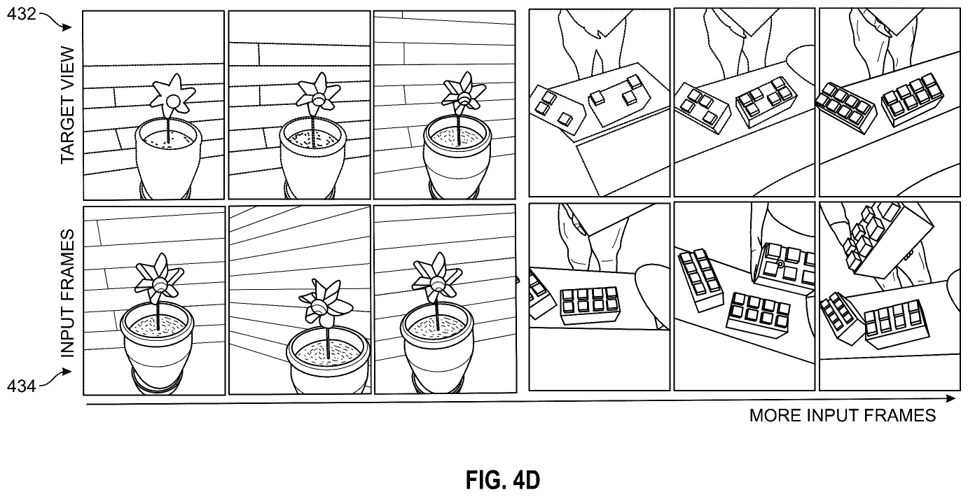

Referring now to FIGS. 4A-4D, example illustrations of inputs and outputs of the vision pipeline of system 100, in accordance with some implementations of the present disclosure. FIGS. 4A-4D illustrate the reconstruction, interpolation, and novel view synthesis capabilities of the vision system 108 of FIG. 1.

Referring to FIG. 4A, an illustration of novel view synthesis is shown. The system 100 can receive a sequence of input context frames 400 and 408, representing different viewpoints of a dynamic and/or static scene. The vision system 108 can process the context frames and generate a 3D Gaussian representation 402 and 410 of the scene, which can be rendered from different perspectives. The system 100 can further output novel views 406 and 414 corresponding to original frames 404 and 412, respectively, allowing the user to synthesize unseen viewpoints of the same scene. The novel views 406 and 414 can be generated while maintaining geometric consistency by utilizing the temporal and spatial features extracted from the input context frames 400 and 408.

Referring to FIG. 4B, an illustration of reference timestamps and depth-conditioned interpolation is shown. The reference frames 416 and 418 can correspond to ground-truth images captured at specific timestamps. The system 100 can generate interpolated frames 420 and depth maps 422 using learned temporal embeddings and scene dynamics (e.g., using model(s) 110 and/or interpolation model(s) 107 of FIG. 1). The interpolated frames 420 can maintain details while ensuring temporal consistency. The depth maps 422 can provide additional structural information, providing improved volumetric reconstructions.

Referring to FIG. 4C, an illustration comparing interpolation performance with and without enhancement is shown. The first and second context frames 424 and 426 can represent the input frames used for interpolation. The middle frame without enhancement 428 is generated without the use of time enhancement models (e.g., interpolation model(s) 107 of FIG. 1), whereas the middle frame with enhancement (e.g., enhanced middle frame 430) utilizes the time enhancer 106 (e.g., novel time enhancer 330 of FIG. 3B) to refine motion trajectories and correct occlusion artifacts. The enhanced middle frame 430 exhibits improved temporal coherence.

Referring to FIG. 4D, an illustration of the impact of increasing the number of input frames for novel view synthesis is shown. The input frames 434 can be provided to the vision system 108, which synthesizes a target view 432 at an arbitrary viewpoint. As more input frames are introduced, the system 100 can refine the target view 432 with improved accuracy and reduced artifacts, leveraging additional temporal and spatial information to enhance reconstruction fidelity.

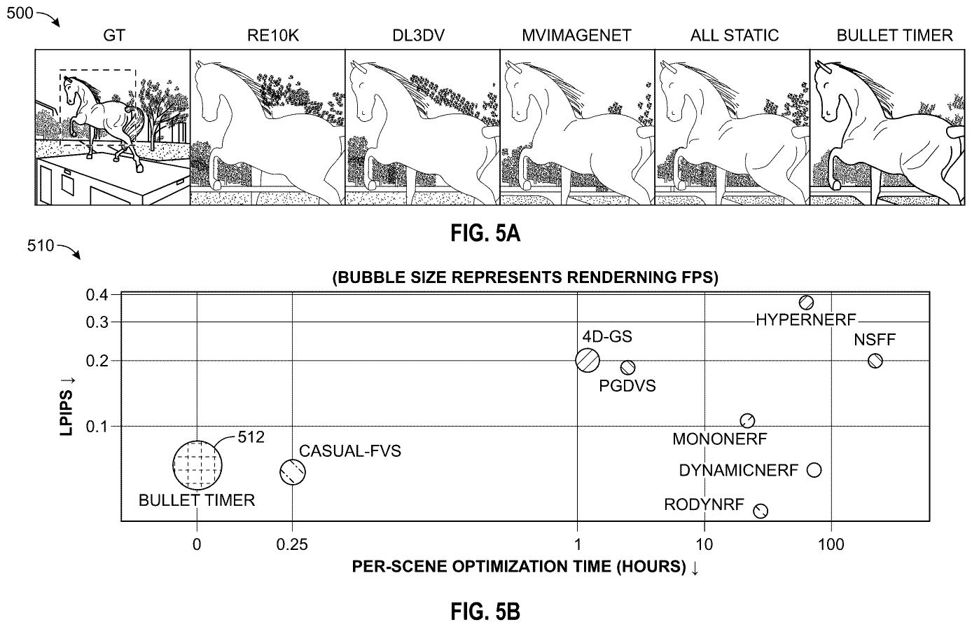

Referring now to FIGS. 5A-5B, example metrics of the vision pipeline of system 100, in accordance with some implementations of the present disclosure. FIG. 5A illustrates a qualitative comparison 500 between different training datasets and their effect on scene reconstruction performance. The first image labeled GT represents the ground truth frame used for comparison. Subsequent images correspond to reconstructions generated using different static training datasets, including RE10K, DL3DV, and MVIMAGENET, followed by an All-Static model and the BulletTimer model (implemented as model(s) 110 of FIG. 1). At least one (e.g., each) model contributes varying levels of detail and motion fidelity, with BulletTimer demonstrating improved reconstruction quality by leveraging a combination of static and dynamic scene training. The visual differences illustrate the impact of using both static and dynamic datasets for training, allowing BulletTimer to capture fine-grained temporal details and reduce motion artifacts.

FIG. 5B illustrates a graph 510 of a quantitative evaluation of different scene reconstruction methods in terms of Learned Perceptual Image Patch Similarity (LPIPS) on the vertical axis and per-scene optimization time on the horizontal axis. The bubble size can represent the rendering frames per second (FPS) for each method. The BulletTimer model (implemented as model(s) 110 of FIG. 1) is represented by a large bubble labeled 512, positioned at the lowest LPIPS value and near-zero optimization time, indicating that it achieves high-fidelity reconstructions with minimal per-scene processing overhead. Comparatively, other methods such as 4D-GS, PGDVS, and HyperNeRF present higher LPIPS scores and longer optimization times. The inclusion of models such as MonoNeRF, DynamicNeRF, and RODYNerf illustrates the efficiency trade-offs, with BulletTimer illustrating a balance between rendering quality and computational efficiency. This metric evaluation depicts the effectiveness of training of the BulletTimer model, which includes static dataset pretraining, dynamic scene co-training, and/or long-context window fine-tuning to achieve real-time and/or near real-time, high-quality scene reconstructions.

### Example Language Models

FIG. 6A is an example of sensor locations having corresponding fields of view or sensory fields for an autonomous or semi-autonomous vehicle 600a, an autonomous mobile robot (AMR) 600b, and a humanoid robot 600c, in accordance with some implementations of the present disclosure. Although three types of machines 600 are illustrated, this is not intended to be limiting, and the machine(s) 600 described herein can include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 600a, AMR 600b, humanoid robot 600c, and/or other machine types can be referred to herein collectively as machine 600, in some instances.

With respect to vehicles 600A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 600 can be capable of functionality in accordance with one or more of Level 3-Level 5 of the autonomous driving levels. The machine 600 can be capable of functionality in accordance with one or more of Level 1-Level 5 of the autonomous driving levels. For example, the machine 600 can be capable of driver assistance (Level 1), partial automation (Level 2, Level 2+, Level 2++), conditional automation (Level 3), high automation (Level 4), and/or full automation (Level 5), depending on the implementation. The term “autonomous,” as used herein, can include any and/or all types of autonomy for the machine 600 or other machine, such as being fully autonomous, being highly autonomous, being conditionally autonomous, being partially autonomous, providing assistive autonomy, being semi-autonomous, being primarily autonomous, or other designation.

With respect to FIG. 6A, the sensors and their respective fields of view (not illustrated for clarity purposes) or sensory fields (not illustrated for clarity purposes) are one example implementation and are not intended to be limiting. Although not illustrated, each sensor can have a corresponding field of view (e.g., a 360-degree field of view of a surround camera 668D, a 180-degree field of view of a wide-view camera 670, a 360-degree sensory field of a LiDAR sensor 664, etc.). For example, only a subset of the sensors illustrated can be included, additional sensors can be included, alternative sensors can be included, the number of each sensor modality can differ, the sensor modalities can differ (e.g., cannot include LiDAR or RADAR, can include SONAR, thermal sensors, etc.), the sensor locations can be different from those illustrated on the vehicle 600a, AMR 600b, and/or humanoid robot 600c, etc. For example, with respect to the vehicle 600a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information can differ. Similarly, for the AMR 600b and/or humanoid robot 600c, the shape, size, purpose, implementation, model, etc. can dictate the number and types of sensors used.

As illustrated in FIG. 6A, the autonomous or semi-autonomous vehicle 600A, the AMR 600B, and the humanoid robot 600C can include different sensor types, number, and locations. For a non-limiting example, the vehicle 600A can include twelve cameras 664, such as a front wide camera (e.g., 120 degree field of view (FOV)), a front telephoto camera (e.g., 30 degree fOV), a side rear left camera (e.g., 70 degree fOV), a side rear right camera (e.g., 70 degree fOV), a front fisheye camera (e.g., 200 degree fOV), a rear fisheye camera (e.g., 200 degree fOV), a left fisheye camera (e.g., 200 degree fOV), a right fisheye camera (e.g., 200 degree fOV), a front telephoto satellite camera (e.g., 30 degree fOV), a rear telephoto camera (e.g., 30 degree fOV), a cross left camera (e.g., 120 degree fOV), and a cross right camera (e.g., 120 degree fOV). The camera(s) 664 can use, in implementations, a gigabit multimedia serial link (GMSL) interface—such as GMSL2—as input/output (I/O).

In some implementations, although not illustrated in FIG. 6A, the vehicle 600A can include an in-cabin occupant and/or driver monitoring system, that can include various different sensors. For example, the in-cabin sensors can include various cameras 668, such as a driver monitoring camera (e.g., 55 degree fOV positioned forward of and facing toward the driver seat), a front occupant monitoring camera (e.g., 190 degree fOV positioned forward of and facing the front occupant(s) seat(s)), and a rear occupant monitoring camera (e.g., 190 degrees positioned forward of and facing the rear occupant(s) seat(s)). Similar to the external facing camera(s) 668, the internal camera(s) 668 may, in implementations, use a GMSL (such as GMSL2) interface for I/O.

As another non-limiting example, the vehicle 600A can further include nine RADAR sensors 660. For example, the vehicle 600A can include a front center imaging RADAR sensor (e.g., 120 degree fOV or sensory field), a corner front left RADAR sensor (e.g., 160 degree fOV or sensory field), a corner front right RADAR sensor (e.g., 160 degree fOV or sensory field), a corner rear right RADAR sensor (e.g., 160 degree fOV or sensory field), a side left RADAR sensor (e.g., 160 degree fOV or sensory field), a side right RADAR sensor (e.g., 160 degree fOV or sensory field), a rear left RADAR sensor (e.g., 50 degree fOV or sensory field), and rear right RADAR sensor (e.g., 50 degree fOV or sensory field). The RADAR sensor(s) 660 can use, in implementations, an Ethernet interface as I/O.

The vehicle(s) 600A can further include, as a non-limiting example, twelve ultrasonic sensors 662. As illustrated in FIG. 6A, the ultrasonic sensors can be positioned along the front and rear bumpers of the vehicle 600A, and along the side of the vehicle 600A, and can be used to detect objects (static and dynamic) in close proximity to the vehicle 600A. In some implementations, the ultrasonic sensor(s) 662 can use a DS13 interface as I/O.

The vehicle(s) 600A can further include, as a non-limiting example, a LiDAR sensor 664, such as a front center LiDAR sensor (e.g., 120-degree horizontal FOV or sensory field and 30-degree vertical FOV or sensor field). In some implementations, such as where additional or alternative LiDAR sensors are used, the LiDAR sensor can have differing horizontal and vertical fields of view or sensory fields. For example, a LiDAR sensor 664 can include a 360-degree horizontal FOV or sensory field (such as in a spinning LiDAR sensor) and a 90-degree vertical FOV or sensory field. In some implementation, the LiDAR sensor(s) 664 can use an Ethernet interface as I/O.

The autonomous mobile robot (AMR) 600B can include, as a non-limiting example, three LiDAR sensors 664. For example, the top-most illustrated LiDAR sensor 664 can include a beam or 3D LiDAR sensor (e.g., 360 degree horizontal and 90-degree vertical FOV or sensory field), and the front and rear LiDAR sensors can include planar or 2D LiDAR sensors (e.g., 180-degree horizontal FOV or sensory field).

The AMR 600B can further include, as a non-limiting implementation, eight cameras 668, such as a front stereo camera (e.g., 120 degree fOV), a rear stereo camera (e.g., 120 degree fOV), a left stereo camera (e.g., 120 degree fOV), a right stereo camera (e.g., 120 degree fOV), a front fisheye camera (e.g., 202 degree+−3 degree fOV), a rear fisheye camera (e.g., 202 degree+−3 degree fOV), a left fisheye camera (e.g., 202 degree+−3 degree fOV), and a right fisheye camera (e.g., 202 degree+−3 degree fOV).

The AMR 600B can further include a charging port, charging port contacts, a status indicator light, one or more (e.g., four) RGB LEDs, one or more IMU sensors 666, a magnetometer, and a barometer. The AMR 600B is capable of high-precision time synchronization between sensors using hardware time stamping, and PTP over Ethernet with less than 10 microseconds for sensor acquisition time. The AMR 600B provides simultaneous camera capture across all cameras 668 within 100 microseconds from a single hardware trigger, in implementations, and can write to disk at 4 GB/second for sensor capture to bag writing (e.g., writing to ROSbags for the robot operation system (ROS)). As such, the AMR 600B is capable of running the ROS (such as NVIDIA's Isaac ROS), can be teleoperated (as described herein), can map an environment, and can navigate within an environment using visual cameras 668, LiDARs 664, and/or other sensor types or modalities.

The humanoid robot 600C can include, as a non-limiting example, one LiDAR sensor 664. For example, the LiDAR sensor 664 can include a beam or 3D LiDAR sensor (e.g., 360 degree horizontal and 90-degree vertical FOV or sensory field), or can include a planar or 2D LiDAR sensor (e.g., 180-degree horizontal FOV or sensory field).

The humanoid robot 600C can further include, as a non-limiting implementation, four cameras 668, such as a front stereo camera (e.g., 120-degree fOV), a rear stereo camera (e.g., 120-degree fOV), a front fisheye camera (e.g., 202 degree+-3-degree fOV), and a rear fisheye camera (e.g., 202 degree+-3-degree fOV).

The humanoid robot 600C can further include, as a non-limiting implementation, four ultrasonic sensors 662, such as a left arm ultrasonic sensor, a right arm ultrasonic sensor, a left leg ultrasonic sensor, and right leg ultrasonic sensor.

The humanoid robot 600C can further include any number of actuators-such as to allow control and maneuverability of joints. For example, the humanoid robot 600C can include actuators that allow for various degrees of freedom (DoF) depending on the design. In a non-limiting implementation, the humanoid robot 600C can have 40 total degrees of freedom (DoF) (e.g., 6 DoF x 2 for the arms, 6 DoF x 2 for the hands, 6 DoF x 2 for the legs, 2 DoF for the torso, and 2 DoF for the neck). The actuators can convert energy into physical motion, allowing for actions such as joint movements, locomotion, and gripping/manipulation. For example, joint movements can be performed using motors and servos to control the rotation of joints in an arm or manipulator, and to allow for reaching, grabbing, and manipulating objects. Locomotion can be accomplished using wheels, tracks, or other locomotion devices (robotic legs) to move around the environment. Gripping and manipulation can be performed using end-effectors or hands/fingers, which can be equipped with actuators to grip objects, apply force, and perform specific tasks. In some examples, the humanoid robot 600C can include position and orientation sensors, such as encoders, gyroscopes, and the like, to determine the position of the robot 600C in space, allowing for location determination and movement tracking. The humanoid robot 600C can include force and pressure sensors, in implementations, to detect environment interactions, allowing the robot 600C to grasp objects with the right force and to avoid obstacles along the way. The perception sensors (e.g., cameras, LiDARs, RADARs, ultrasonic, SONAR, etc.) can be used along with tactile sensors to allow the robot 600C to perceive objects, shapes, and textures, and to understand when touch is initiated and stopped (along with force sensors that regulate the force used during touch). As a non-limiting example, the humanoid robot 600C can have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 600C, in implementations, can include a conversational system-such as a conversational system powered by language models (e.g., LLMs, VLMs, MMLMs, VLAS, etc.)—in order to help understand the environment, reason, and communicate with humans, animals, devices, and/or other robots, and/or make planning, control, and navigation decisions. As such, in addition to performing various tasks, the humanoid robot 600C can use onboard sensors, microphones, and speakers to understanding speech, audio and visual cues, etc., while also being able to communicate back to the environment.

With reference to cameras 668 of the machine(s) 600, the camera types for the cameras 668 can include, but are not limited to, digital cameras that can be adapted for use with the components and/or systems of the machine 600. For a vehicle 600a implementation, the camera(s) 668 can operate at automotive safety integrity level (ASIL) B and/or at another ASIL. The camera types can be capable of any image capture rate, such as 30 frames per second (fps), 60 fps, 120 fps, 240 fps, etc., depending on the implementation. The cameras can be capable of using rolling shutters, global shutters, another type of shutter, or a combination thereof. In some examples, the color filter array can include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some implementations, clear pixel cameras, such as cameras with an RCCC, an RCCB, and/or an RBGC color filter array, can be used in an effort to increase light sensitivity.

Cameras with a field of view that include portions of the environment in front of the machine 600 (e.g., front-facing cameras) can be used for surround view, to help identify forward facing paths and obstacles, as well aid in, with the help of one or more controllers 636 and/or control SoCs, providing information critical to generating an occupancy grid and/or determining the preferred machine movements, trajectories, and/or paths. Front-facing cameras can be used to perform many of the same ADAS functions as LiDAR, including emergency braking, pedestrian detection, and collision avoidance. Front-facing cameras can also be used for ADAS functions and systems including Lane Departure Warnings (“LDW”), Autonomous Cruise Control (“ACC”), and/or other functions such as traffic sign recognition.

A variety of cameras can be used in a front-facing configuration, including, for example, a monocular camera platform that includes a complementary metal oxide semiconductor (“CMOS”) color imager. Another example can be a wide-view camera(s) 668B that can be used to perceive objects coming into view from the periphery (e.g., pedestrians, warehouse vehicles, other robots, crossing traffic, or bicycles). In addition, any number of long-range camera(s) 668E (e.g., a long-view stereo camera pair) can be used for depth-based object detection, especially for objects for which a neural network has not yet been trained. The long-range camera(s) 668E can also be used for object detection and classification, as well as basic object tracking.

Any number of stereo cameras 668A can also be included in a front-facing and/or other (e.g., rear-facing) configuration. In at least one implementation, one or more of stereo camera(s) 668A can include an integrated control unit including a scalable processing unit, which can provide a programmable logic (“FPGA”) and a multi-core micro-processor with an integrated Controller Area Network (“CAN”) or Ethernet interface on a single chip. Such a unit can be used to generate a 3D map of the machine's 600 environment, including a distance estimate for points in the image (e.g., a disparity or depth image). An alternative stereo camera(s) 668A can include a compact stereo vision sensor(s) that can include two camera lenses (one each on the left and right) and an image processing chip that can measure the distance from the vehicle to the target object and use the generated information (e.g., metadata) to activate the autonomous emergency braking and lane departure warning functions. Other types of stereo camera(s) 668A can be used in addition to, or alternatively from, those described herein. For example, in some implementations, stereo depth estimation can be performed using other than stereo cameras, such as two monocular cameras having at least partially overlapping fields of view.

Cameras with a field of view that include portions of the environment to the side of the machine 600 (e.g., side-view cameras) can be used, for example, for surround view, providing information used to create and update the occupancy grid, as well as to generate side impact collision warnings and/or to indicate to an AMR 600B or humanoid robot 600C, for example, that there are objects, features, and/or persons present to the side. For example, surround camera(s) 668D can be positioned on the machine 600. The surround camera(s) 668D can include wide-view camera(s) 668B, fisheye camera(s), 360-degree camera(s), and/or the like. For example, four fisheye cameras can be positioned on the machine's 600 front, rear, and sides. In an alternative implementation, the machine 600 can use three surround camera(s) 668D (e.g., left, right, and rear), and can leverage one or more other camera(s) (e.g., a forward-facing camera) as a fourth surround view camera.

Cameras 668 with a field of view that include portions of the environment to the rear of the machine 600 (e.g., rear-view cameras) can be used for gaining an understanding of objects, features, persons, and/or other information to the rear of the machine 600, such as for park assistance, surround view, rear collision warnings, planning, control, and navigation determinations, and/or creating and updating an occupancy grid, BEV image representing the environment, height map, etc. A wide variety of cameras 668 can be used including, but not limited to, cameras 668 that are also suitable as a front-facing camera(s) (e.g., long-range and/or mid-range camera(s) 668E, stereo camera(s) 668A), infrared camera(s) 668C, etc.), rear-facing camera(s), side-facing camera(s), downward facing camera(s), upward facing camera(s), and/or the like, as described herein.

Similarly, for LiDAR sensors 664, RADAR sensors 660, ultrasonic sensors 662, and/or other sensor modalities or types, the location and placement of the sensors, and their corresponding fields of view or sensory fields can be determined based on the use case, implementation, or design of the particular machine 600.

For example, the machine(s) 600 include RADAR sensor(s) 660 that can be used by the machine 600 for long-range object detection, even in darkness and/or severe weather conditions. RADAR functional safety levels can be ASIL B, in implementations. The RADAR sensor(s) 660 can use the CAN and/or the bus 602 (e.g., to transmit data generated by the RADAR sensor(s) 660) for control and to access object tracking data, with access to Ethernet to access raw data in some examples. A wide variety of RADAR sensor types can be used. For example, and without limitation, the RADAR sensor(s) 660 can be suitable for front, rear, and side RADAR use. In some example, Pulse Doppler RADAR sensor(s) are used.

The RADAR sensor(s) 660 can include different configurations, such as long range with narrow field of view, short range with wide field of view, short range side coverage, etc. In some examples, long-range RADAR can be used for adaptive cruise control (ACC) functionality. The long-range RADAR systems can provide a broad field of view realized by two or more independent scans, such as within a 250 m range. The RADAR sensor(s) 660 can help in distinguishing between static and moving objects, and can be used by ADAS systems for emergency brake assist and forward collision warning, by robots for detecting dynamic objects in various environments—such as those with lower or no lighting. Long-range RADAR sensors can include monostatic multimodal RADAR with multiple (e.g., six or more) fixed RADAR antennae and a high-speed CAN and FlexRay interface. In an example with six antennae, the central four antennae can create a focused beam pattern, designed to record the machine's 600 surroundings at higher speeds with minimal interference from the periphery (e.g., from traffic in adjacent lanes). The other two antennae can expand the field of view, making it possible to quickly detect objects entering or leaving the machine's immediate path (e.g., lane).

Mid-range RADAR systems can include, as an example, a range of up to 660 m (front) or 80 m (rear), and a field of view of up to 42 degrees (front) or 150 degrees (rear). Short-range RADAR systems can include, without limitation, RADAR sensors designed to be installed at both ends of a lateral surface (e.g., a rear bumper) such that two beams can be used to constantly monitor the blind spot in the rear and next to the machine 600 (e.g., vehicle, robot, etc.). As such, short-range RADAR systems can be used in an ADAS system for blind spot detection and/or lane change assist.

The machine 600 can further include ultrasonic sensor(s) 662. The ultrasonic sensor(s) 662, which can be positioned at the front, back, and/or the sides of the machine 600, can be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 600. A wide variety of ultrasonic sensor(s) 662 can be used, and different ultrasonic sensor(s) 662 can be used for different ranges of detection (e.g., 2.5 m, 4 m). The ultrasonic sensor(s) 662 can operate at functional safety levels of ASIL B, as an example.

The machine 600 can include LiDAR sensor(s) 664. The LiDAR sensor(s) 664 can be used for object and feature detection, pedestrian and other robot detection, emergency braking, collision avoidance, simultaneous localization and mapping (SLAM), free-space detection, and/or other functions. The LiDAR sensor(s) 664 can be functional safety level ASIL B, in implementations. In some examples, the machine 600 can include multiple LiDAR sensors 664 (e.g., two, four, six, etc.) that can use Ethernet (e.g., to provide data to a Gigabit Ethernet switch).

In some examples, the LiDAR sensor(s) 664 can be capable of providing a list of objects and their distances for a 360-degree field of view. Commercially available LiDAR sensor(s) 664 can have an advertised range of approximately 600 m, with an accuracy of 2 cm-3 cm, and with support for a 600 Mbps Ethernet connection, for example. In some examples, one or more non-protruding LiDAR sensors 664 can be used. In such examples, the LiDAR sensor(s) 664 can be implemented as a small device that can be embedded into the front, rear, sides, top, and/or corners of the machine 600. The LiDAR sensor(s) 664, in such examples, can provide up to a 120-degree horizontal and 35-degree vertical field-of-view, with a 200 m range even for low-reflectivity objects. Front-mounted LiDAR sensor(s) 664 can be configured for a horizontal field of view between 45 degrees and 135 degrees.

In some examples, LiDAR technologies, such as 3D flash LiDAR, can also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR can allow for highly accurate and distortion-free images of the surroundings to be generated with every laser flash. In some examples, four flash LiDAR sensors can be deployed, one at each side of the machine 600. Available 3D flash LiDAR systems include a solid-state 3D staring array LiDAR camera with no moving parts other than a fan (e.g., a non-scanning LiDAR device). The flash LiDAR device can use a 5-nanosecond class I (eye-safe) laser pulse per frame and can capture the reflected laser light in the form of 3D range point clouds and co-registered intensity data. By using flash LiDAR, and because flash LiDAR is a solid-state device with no moving parts, the LiDAR sensor(s) 664 can be less susceptible to motion blur, vibration, and/or shock.

FIG. 6B is an illustration of sensor and component locations of an example autonomous or semi-autonomous vehicle 600A (alternatively referred to herein as “vehicle 600,” “ego-vehicle 600,” “ego-machine 600,” or “machine 600,”), in accordance with some implementations of the present disclosure. Although the vehicle 600A is illustrated, this is not intended to be limiting, and similar components and/or sensors can be included on any other machine type without departing from the scope of the present disclosure. For example, similar sensors and/or components can be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 6C is a block diagram of an example system architecture for a machine 600, such as autonomous or semi-autonomous vehicle 600A, autonomous mobile robot (AMR) 600B, humanoid robot 600C, and/or other types of machines, in accordance with some implementations of the present disclosure. It should be understood that this and other implementations described herein are set forth only as examples. Other implementations, components, features, and elements (e.g., machines, interfaces, functions, orders, groupings of functions, etc.) can be used in addition to or instead of those shown, and some elements can be omitted altogether. Further, many of the implementations, components, features, elements, etc. described herein are functional entities that can be implemented as discrete or distributed components or in conjunction with other components, and in any suitable combination and location (e.g., on a local device, vehicle, or machine at the edge, on-premises-such as locally hosted servers, remotely located-such as in one or more computing or server devices in one or more data centers in the cloud, and/or at other locations). Various functions described herein as being performed by entities can be carried out by hardware, firmware, and/or software. For instance, various functions can be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some implementations, the systems, methods, and processes described herein can be executed using similar components, features, and/or functionality to those of example machine 600 of FIGS. 6A-6E, example computing ecosystem 700 of FIG. 7, example generative language model system 800 of FIG. 8, and/or example computing device 900 of FIG. 9.

Each of the components, features, and systems of the machine 600 in FIG. 6C are illustrated as being connected via bus 602 (alternatively referred to as a “machine communications network 602,” or just “communications network 602”). The bus 602 can include a Controller Area Network (CAN) data interface (alternatively referred to herein as a “CAN bus”). A CAN can be a network inside the machine 600 used to aid in control of various features and functionality of the machine 600, such as actuation of brakes, acceleration, braking, steering, windshield wipers, etc. A CAN bus can be configured to have dozens or even hundreds of nodes, each with its own unique identifier (e.g., a CAN ID). The CAN bus can be read to find steering wheel angle, ground speed, engine revolutions per minute (RPMs), button positions, and/or other vehicle status indicators. The CAN bus can be ASIL B compliant. In some implementations, in addition to or alternatively from a CAN bus, the bus 602 can include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 602, this is not intended to be limiting. For example, there can be any number of busses 602, which can include one or more CAN busses, one or more FlexRay busses, one or more Ethernet busses, and/or one or more other types of busses using a different protocol. In some examples, two or more busses 602 can be used to perform different functions, and/or can be used for redundancy. For example, a first bus 602 can be used for collision avoidance functionality and a second bus 602 can be used for actuation control. In any example, each bus 602 can communicate with any of the components of the machine 600, and two or more busses 602 can communicate with the same components. In some examples, each SoC 604, each controller 636, and/or each computer or compute engine within the machine 600 can have access to the same input data (e.g., inputs from sensors of the machine 600), and can be connected to a common bus, such as a CAN bus.

The machine 600 can include components such as a chassis, a vehicle body, wheels (e.g., 2, 4, 6, 8, 18, etc.), tires, axles, batteries, side-view mirrors, and/or other components of a vehicle or machine. The machine 600 can include a propulsion system 650, such as an internal combustion engine, hybrid electric power plant, an all-electric engine, a hydrogen-fueled engine, and/or another propulsion system type. The propulsion system 650 can be connected to a drive train of the machine 600, which can include a transmission, to allow the propulsion of the machine 600. The propulsion system 650 can be controlled in response to receiving signals from the throttle/accelerator 652.

A steering system 654, which can include a steering wheel and/or other steering device (e.g., remote steering and/or local steering), can be used to steer the machine 600 (e.g., along a desired path or route) when the propulsion system 650 is operating (e.g., when the vehicle is in motion). The steering system 654 can receive signals from a steering actuator 656. In some implementations, a steering wheel or other steering mechanism cannot be included, such as for a machine 600 capable of full automation (e.g., Level 5) functionality.

The brake sensor system 646 can be used to operate the vehicle brakes in response to receiving signals from the brake actuators 648 and/or brake sensors.

The machine 600 can include one or more controller(s) 636, such as those described herein with respect to FIG. 6A. The controller(s) 636 can be used for a variety of functions, and can be coupled to any of the various other components and systems of the machine 600. For example, the controllers 636 can be used for control of the machine 600, artificial intelligence executing on the machine 600, infotainment for the machine 600, and/or the like. For example, one controller 636 can be used for some or all of the functionality, or different controllers 636 can be used for different functionalities—e.g., to ensure availability and a safety separation between various controllers for different tasks. For example, the controller(s) 636 can use plans computed by the system—e.g., paths or trajectories for vehicles 600A or AMRs 600B, or movements, components trajectories, movement locations or displacements, etc. for joints or components (e.g., of manipulators, end effectors, limbs, hands, fingers, legs, feet, etc.), of a humanoid robot 600C—to control the machine(s) 600 in the environment. In some instances, the controller(s) 636 can include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 600C, for example, the controller(s) 636 can act as the brain, responsible for analyzing sensor data, making decisions, and sending commands to the actuators. The controller(s) 636 can include a low-level controller that handles basic motor control, ensuring accurate and precise movements of individual joints and actuators. The controller(s) 636 can include a high-level controller to coordinate multiple actuators and sensors, planning complex motions and adapting to changing environments.

The controller(s) 636 can include an artificial intelligence controller, in implementations, that can use AI algorithms (e.g., DNNs, MLMs, etc.) to learn, make decisions, and autonomously perform tasks for the machine 600. In some implementations, the controller(s) 636 can use an open-loop control algorithm that is fixed and does not adjust actions to the environment. In other implementations, closed-loop control can be used that incorporates feedback mechanisms to monitor the robot's performance and make necessary adjustments. In examples, the controller(s) 636 can implement reactive control in order to respond directly to sensory inputs, allowing for quick reflexes and real-time changes. Further, deliberative control can be implemented in some examples, using internal models and planning algorithms to generate high-level actions, which can be suited for complex tasks that require reasoning, decision making, and long-term planning.

Controller(s) 636, which can include one or more systems on chip (SoCs) 604 (FIGS. 6C and 6D), CPUs, GPU(s), accelerator(s), etc., can provide signals (e.g., representative of commands or messages) to one or more components and/or systems of the machine 600. Although the controller(s) 636 is listed separately from the SoC(s) 604, this is not intended to be limiting, and in some implementations one or more components of the SoC(s) 604 can perform the operations of the controller(s) 636. For example, the controller(s) can send signals to operate the machine brakes via one or more brake actuators 648, to operate the steering system 654 via one or more steering actuators 656, to operate the propulsion system 650 via one or more throttle/accelerators 652, etc. The controller(s) 636 can include one or more onboard (e.g., integrated) computing devices (e.g., supercomputers) that process sensor signals, and output operation commands (e.g., signals representing commands) to allow autonomous or semi-autonomous navigation and movement and/or to assist a human operator using the machine 600. The controller(s) 636 can include a first controller 636 for autonomous control and navigation functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. For example, the hardware used for safety monitoring and other safety functions (such as a functional safety island) can be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring can be discrete or separate from the hardware used for vehicle perception and control. In some examples, a single controller 636 can handle two or more of the above functionalities, two or more controllers 636 can handle a single functionality, and/or any combination thereof.

The controller(s) 636 can provide the signals for controlling one or more components and/or systems of the machine 600 in response to sensor data received from one or more sensors (e.g., sensor inputs). The sensor data can be received from, for example and without limitation, global navigation satellite systems (“GNSS”) sensor(s) 658 (e.g., Global Positioning System sensor(s)), RADAR sensor(s) 660, ultrasonic sensor(s) 662, LiDAR sensor(s) 664, inertial measurement unit (IMU) sensor(s) 666 (e.g., accelerometer(s), gyroscope(s), magnetic compass(es), magnetometer(s), etc.), microphone(s) 696, camera(s) 668 (e.g., stereo camera(s) 668A, wide-view camera(s) 668B (e.g., fisheye cameras), infrared camera(s) 668C, surround camera(s) 668D (e.g., 360 degree cameras), long-range and/or mid-range camera(s) 668E, and/or other camera types), speed sensor(s) 644 (e.g., for measuring the speed of the machine 600), vibration sensor(s) 642, steering sensor(s) 640, brake sensor(s) (e.g., as part of the brake sensor system 646), actuators, and/or other sensor types.

One or more of the controller(s) 636 can receive inputs (e.g., represented by input data) from an instrument cluster 632 of the machine 600 and provide outputs (e.g., represented by output data, display data, etc.) via a human-machine interface (HMI) display 634 (e.g., screen, heads-up display, mirror display, facial display, robotic display, etc.), an audible annunciator, a loudspeaker, a speaker, and/or via other components of the machine 600. The outputs can include information such as machine velocity, speed, time, map data corresponding to a map(s) 622 of FIG. 6C (e.g., from a navigation map, a Standard Definition (SD) map, a High Definition (“HD”) map, etc.), location data (e.g., the machine's 600 location, such as on a map 622), direction, location of other vehicles (e.g., an occupancy map, height map, bird's eye view (BEV) image, grid, etc.), information about objects and status of objects as perceived by the system, system status information, etc. For example, the HMI display(s) 634 can display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 600 can include one or more systems on a chip (SoCs) 604 (described in more detail in FIG. 6D). The SoC(s) 604 can include CPU(s) 606, GPU(s) 608, processor(s) 610, cache(s) 612, accelerator(s) 614, data store(s) 616, and/or other components and features. The SoC(s) 604 can be used to process and provide data for various operations, such as navigation, planning, reasoning, inference, perception, control, and/or actuation operations of the machine 600 in a variety of platforms and systems. For example, the SoC(s) 604 can process live perception data (e.g., from camera, LiDAR, RADAR, ultrasonic, etc.) in addition to map data corresponding to one or more maps 622 (e.g., HD map, SD map, navigational map, occupancy map, etc.) in order to make or aid in performing various operations of the machine 600. Where a map and/or AI is used, map and/or AI (e.g., model parameter updates, fine-tuning, etc.) refreshes and/or updates via a network interface 624 from one or more servers (e.g., server(s) 678 of FIG. 6E)—such as one or more servers of a cloud-based data center.

Although an SoC(s) 604 is illustrated throughout FIGS. 6A-6E, additional or alternative components and/or architectures can be used-such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 600, use of the machine 600, model of the machine 600, and required capabilities of the machine 600, one or more SoCs 604 and/or alternative architectures and/or components can be used to satisfy the particular implementation.

The machine 600 can include a CPU(s) 618 (e.g., discrete CPU(s), or dCPU(s)), that can be coupled to the SoC(s) 604 via a high-speed interconnect (e.g., PCIe). The CPU(s) 618 can include an X86 processor, for example. The CPU(s) 618 can be used to perform any of a variety of functions, including arbitrating potentially inconsistent results between ADAS sensors and the SoC(s) 604, and/or monitoring the status and health of the controller(s) 636 and/or infotainment SoC 630, for example.

The machine 600 can include a GPU(s) 620 (e.g., discrete GPU(s), or dGPU(s)), that can be coupled to the SoC(s) 604 via a high-speed interconnect (e.g., NVIDIA's NVLink). The GPU(s) 620 can provide additional artificial intelligence functionality, such as by executing redundant and/or different neural networks, and can be used to train and/or update neural networks based on input (e.g., sensor data) from sensors of the machine 600.

The machine 600 can further include the network interface 624 which can include one or more wireless antennas 626 and/or modems (e.g., one or more wireless antennas for different communication protocols, such as a cellular antenna, a Bluetooth antenna, etc.). The network interface 624 can be used to allow wireless connectivity over the Internet with the cloud (e.g., with the server(s) 678 and/or other network devices), with other vehicles, and/or with computing devices (e.g., client devices of passengers). To communicate with other vehicles, a direct link can be established between the two vehicles and/or an indirect link can be established (e.g., across networks and over the Internet). Direct links can be provided using a vehicle-to-vehicle communication link. The vehicle-to-vehicle communication link can provide the machine 600 information about vehicles in proximity to the machine 600 (e.g., vehicles in front of, on the side of, and/or behind the machine 600). This functionality can be part of a cooperative adaptive cruise control functionality of the machine 600.

The network interface 624 can include a SoC that provides modulation and demodulation functionality and allows the controller(s) 636 to communicate over wireless networks. The network interface 624 can include a radio frequency front-end for up-conversion from baseband to radio frequency, and down conversion from radio frequency to baseband. The frequency conversions can be performed through well-known processes, and/or can be performed using super-heterodyne processes. In some examples, the radio frequency front end functionality can be provided by a separate chip. For example, the network interface 624 can be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 626 can also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 600 can further include data store(s) 628 which can include off-chip (e.g., off the SoC(s) 604) storage. The data store(s) 628 can include one or more storage elements including RAM, SRAM, DRAM, VRAM, Flash, hard disks, and/or other components and/or devices that can store at least one bit of data.

The machine 600 can further include GNSS sensor(s) 658. The GNSS sensor(s) 658 (e.g., GPS, assisted GPS sensors, differential GPS (DGPS) sensors, etc.), to assist in mapping, perception, occupancy grid generation, and/or path planning functions. Any number of GNSS sensor(s) 658 can be used, including, for example and without limitation, a GPS using a USB connector with an Ethernet to Serial (RS-232) bridge.

The machine 600 can further include IMU sensor(s) 666. The IMU sensor(s) 666 can be located at a center of the rear axle of the machine 600, in some examples. The IMU sensor(s) 666 can include, for example and without limitation, an accelerometer(s), a magnetometer(s), a gyroscope(s), a magnetic compass(es), and/or other sensor types. In some examples, such as in six-axis applications, the IMU sensor(s) 666 can include accelerometers and gyroscopes, while in nine-axis applications, the IMU sensor(s) 666 can include accelerometers, gyroscopes, and magnetometers.

In some implementations, the IMU sensor(s) 666 can be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 can allow the machine 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 can be combined in a single integrated unit.

The vehicle can include one or more microphone 696 placed in and/or around the machine 600. The microphone(s) 696 can be used for emergency vehicle detection and identification, among other things.

The machine 600 can further include vibration sensor(s) 642. The vibration sensor(s) 642 can measure vibrations of components of the machine, such as the arms or legs of a humanoid robot 600C, or the axle(s) of a vehicle 600A or AMR 600B. For example, changes in vibrations can indicate a change in road, walking, or traversable surfaces. In another example, when two or more vibration sensors 642 are used, the differences between the vibrations can be used to determine friction or slippage of the surface (e.g., when the difference in vibration is between a power-driven axle and a freely rotating axle).

The machine 600 can include an ADAS system 638—such as when the machine 600 is a vehicle 600A. The ADAS system 638 can include a dedicated SoC(s), in some examples. The ADAS system 638 can include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 600 can further include the infotainment SoC 630 (e.g., an in-vehicle infotainment system (IVI)). Although illustrated and described as a SoC, the infotainment system cannot be an SoC, and can include one or more discrete components, such as multi-chip modules (MCMs), application-specific integrated circuits (ASICs), system-in-packages (SiPs), heterogeneous integration (HI), single-board computers (SBCs), etc. The infotainment SoC 630 can include a combination of hardware and software that can be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 600. For example, the infotainment SoC 630 can radios, disk players, navigation systems, video players, USB and Bluetooth connectivity, carputers, in-car entertainment, Wi-Fi, steering wheel audio controls, hands free voice control, a heads-up display (HUD), an HMI display 634, a telematics device, a control panel (e.g., for controlling and/or interacting with various components, features, and/or systems), and/or other components. The infotainment SoC 630 can further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 can include GPU functionality. The infotainment SoC 630 can communicate over the bus 602 (e.g., CAN bus, Ethernet, etc.) with other devices, systems, and/or components of the machine 600. In some examples, the infotainment SoC 630 can be coupled to a supervisory MCU such that the GPU of the infotainment system can perform some self-driving functions in the event that the primary controller(s) 636 (e.g., the primary and/or backup computers of the machine 600) fail. In such an example, the infotainment SoC 630 can put the machine 600 into a chauffeur to safe stop mode, as described herein.

In some implementations, the infotainment system can provide a digital or virtual assistant, that can be voice only, or can have a visual component (e.g., in the form of a digital human or digital avatar). The assistant can provide basic functions, like texting, adjusting vehicle settings, music or video control, navigation features, etc., and/or can provide more advanced features such as those supported by one or more language models-such as large language models (LLMs), vision language models (VLMs), multi-modal language models (MMLMs), etc. For example, the driver and/or occupants can be able to interact with the assistant similar to how a user can interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 600—whether a vehicle 600A, AMR 600B, humanoid robot 600C, and/or other type of machine—can include a locally stored language model(s) and/or communicate to a remotely hosted language model (e.g., via one or more APIs) to provide more detailed and in-depth communication features to the users of the machine(s) 600.

In some examples, an infotainment SoC 630, the SoC(s) 604, and/or another SoC or computing/processing system can perform in-cabin driver and/or occupant monitoring. For example, the computing system can perform facial recognition and vehicle owner identification can use data from camera and/or other sensors to identify the presence of an authorized driver and/or owner of the machine 600. The always on sensor processing engine can be used to unlock the vehicle when the owner approaches the driver door and turn on the lights, and, in security mode, to disable the vehicle when the owner leaves the vehicle. In this way, the SoC(s) 604 provide for security against theft and/or carjacking.

In some implementations, an in-cabin monitoring camera sensor can be monitored using one or more neural networks running on another or dedicated SoC—such as an in-vehicle infotainment or in-vehicle monitoring SoC, configured to identify in cabin events and respond accordingly. An in-cabin system can perform lip reading to activate cellular service and place a phone call, dictate emails, change the vehicle's destination, activate or change the vehicle's infotainment system and settings, or provide voice-activated web surfing. The in-cabin system can further include one or more in-cabin AI agents or assistants, which can use one or more APIs or plug-ins to interact with one or more LLMs, VLMs, MMLMs, etc. in the cloud. For example, the in-cabin AI agents or assistants can provide directions, vehicle or machine feedback information, answer general questions, handle music/video and/or other requests, activate windows, doors, and/or other vehicle components, etc. As such, one or more dedicated SoCs and/or sets of processors can be used to perform the in-cabin infotainment and/or in-cabin monitoring (e.g., as an occupant monitoring system (OMS)) for the machine 600.

The machine 600 can further include an instrument cluster 632 (e.g., a digital dash, an electronic instrument cluster, a digital instrument panel, etc.). The instrument cluster 632 can include a controller and/or supercomputer (e.g., a discrete controller or supercomputer). The instrument cluster 632 can include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information can be displayed and/or shared among the infotainment SoC 630 and the instrument cluster 632. In other words, the instrument cluster 632 can be included as part of the infotainment SoC 630, or vice versa.

FIG. 6D is a block diagram of an example architecture of a computing system (a subset of the system described with respect to FIG. 6C), in accordance with at least some implementations of the present disclosure. Although illustrated as an SoC(s) 604, this is not intended to be limiting, and the computing system can additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 604 can be an end-to-end platform with a flexible architecture that spans automation levels 2-5, or the SoC(s) 604 can be specifically designed for a specific automation level (e.g., a first SoC 604 for level 2 to level 2++, a second SoC 604 for level 3, a third SoC 604 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 604 can be faster, more reliable, and even more energy-efficient and space-efficient than conventional systems. For example, the accelerator(s) 614, when combined with the CPU(s) 606, the GPU(s) 608, and the data store(s) 616, can provide for a fast, efficient platform for level 2-5 autonomous vehicles as well as for safe planning, navigation, and control of AMRs 600B, humanoid robots 600C, and/or other robot or machine types.

In some implementations, such as where the SoC(s) 604 include a GPU 608 with 2000 or more cores (e.g., 2048 cores), 60 or more tensor cores (e.g., 64 tensor cores), and a GPU max frequency of over 1 GHz (e.g., 1.3 GHZ), a CPU 606 including 10 or more cores (e.g., 12 cores), with 64 bits, 3 MB L2 and 6 MB L3 cache memory, and a max frequency of 2 or more GHz (e.g., 2.2 GHZ), one or more deep learning accelerators (DLAs), deep learning accelerator clusters (XNNs), neural network accelerators (NNAs), or neural processing units (NPUs) 609 (e.g., 2 DLAs/XNNs/NNAs/NPUs 609), and a vision accelerator—such as a programmable vision accelerator (PVA) 607, a single SoC 604) can be capable of 275 tera operations per second (TOPS) of AI performance. For example, NVIDIA's Jetson AGX Orin 64 GB SoC satisfies these criteria, and achieves this performance.

Similarly, in implementations where the SoC(s) 604 include a GPU 608 with 1700 or more cores (e.g., 1792 cores), 50 or more tensor cores (e.g., 56 tensor cores), and a GPU max frequency of over 900 MHZ (e.g., 930 MHz), a CPU 606 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 609 (e.g., 2 DLAs/XNNs/NNAs/NPUs 609), and a vision accelerator-such as a programmable vision accelerator (PVA) 607, a single SoC 604) can be capable of 200 tera operations per second (TOPS) of AI performance. For example, NVIDIA's Jetson AGX Orin 32 GB SoC satisfies these criteria, and achieves this performance.

In some implementations, such as where the SoC(s) 604 include a GPU 608 with 1000 or more cores (e.g., 1024 cores), 28 or more tensor cores (e.g., 32 tensor cores), and a GPU max frequency of over 900 MHz (e.g., 1173 MHZ), a CPU 606 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 609 (e.g., 1 DLA/XNN/NNA/NPU 609), and a vision accelerator-such as a programmable vision accelerator (PVA) 607, a single SoC 604) can be capable of 157 tera operations per second (TOPS) of AI performance. For example, NVIDIA's Jetson AGX Orin NX 16 GB SoC satisfies these criteria, and achieves this performance.

In various implementations, such as where the SoC(s) 604 include a GPU 608 with 1000 or more cores (e.g., 1024 cores), 28 or more tensor cores (e.g., 32 tensor cores), and a GPU max frequency of over 900 MHZ (e.g., 1020 MHz), a CPU 606 including 6 or more cores (e.g., 6 cores), with 64 bits, 1.5 MB L2 and 4 MB L3 cache memory, and a max frequency of 1.5 or more GHz (e.g., 1.7 GHZ), a single SoC 604) can be capable of 67 tera operations per second (TOPS) of AI performance. For example, NVIDIA's Jetson Orin Nano 8 GB SoC satisfies these criteria, and achieves this performance.

The SoC(s) 604 can include one or more CPUs 606. The CPU(s) 606 can include a CPU cluster or CPU complex (alternatively referred to herein as a “CCPLEX”), in implementations. The CPU(s) 606 can include multiple cores and/or (e.g., L2, L3) caches. For example, in some implementations, the CPU(s) 606 can include twelve cores in a coherent multi-processor configuration. In some implementations, the CPU(s) 606 can include four dual-core clusters where each cluster has a dedicated L2 cache (e.g., a 3 MB L2 cache). The CPU(s) 606 (e.g., the CCPLEX) can be configured to support simultaneous cluster operation enabling any combination of the clusters of the CPU(s) 606 to be active at any given time.

The SoC(s) 604 can include any type and number of GPUs 608. For example, an integrated GPU(s) (alternatively referred to herein as an “iGPU(s)”) can be used in some implementations. The GPU(s) 608 can be programmable and can be efficient for parallel workloads. The GPU(s) 608, in some examples, can use an enhanced tensor instruction set. The GPU(s) 608 can include one or more streaming microprocessors, where each streaming microprocessor can include a cache (e.g., an L1 cache with at least 96 KB storage capacity), and two or more of the streaming microprocessors can share an L2 cache (e.g., an L2 cache with a 512 KB storage capacity). In some implementations, the GPU(s) 608 can include at least eight streaming microprocessors. The GPU(s) 608 can use compute application programming interface(s) (API(s)). In addition, the GPU(s) 608 can use one or more parallel computing platforms and/or programming models (e.g., NVIDIA's CUDA).

The GPU(s) 608 can be power-optimized for best performance in automotive, robotics, and/or other embedded use cases. For example, the GPU(s) 608 can be fabricated on a Fin field-effect transistor (FinFET). However, this is not intended to be limiting, and the GPU(s) 608 can be fabricated using other semiconductor manufacturing or fabrication processes. Each streaming microprocessor can incorporate a number of mixed-precision processing cores partitioned into multiple blocks. For example, and without limitation, 64 PF32 cores and 32 PF64 cores can be partitioned into four processing blocks. In such an example, each processing block can be allocated 16 FP32 cores, 8 FP64 cores, 16 INT32 cores, two mixed-precision NVIDIA TENSOR CORES for deep learning matrix arithmetic, an (e.g., L0) instruction cache, a warp scheduler, a dispatch unit, and/or a (e.g., 64 KB) register file. In addition, the streaming microprocessors can include independent parallel integer and floating-point data paths to provide for efficient execution of workloads with a mix of computation and addressing calculations. The streaming microprocessors can include independent thread scheduling capability to allow finer-grain synchronization and cooperation between parallel threads. The streaming microprocessors can include a combined L1 data cache and shared memory unit in order to improve performance while simplifying programming.

The GPU(s) 608 can include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) can be used, such as a graphics double data rate type five synchronous random-access memory (GDDR5).

The GPU(s) 608 can include unified memory technology including access counters to allow for more accurate migration of memory pages to the processor that accesses them most frequently, thereby improving efficiency for memory ranges shared between processors. In some examples, address translation services (ATS) support can be used to allow the GPU(s) 608 to access the CPU(s) 606—page tables directly. In such examples, when the GPU(s) 608 memory management unit (MMU) experiences a miss, an address translation request can be transmitted to the CPU(s) 606. In response, the CPU(s) 606 can look in its page tables for the virtual-to-physical mapping for the address and transmits the translation back to the GPU(s) 608. As such, unified memory technology can allow a single unified virtual address space for memory of both the CPU(s) 606 and the GPU(s) 608, thereby simplifying the GPU(s) 608 programming and porting of applications to the GPU(s) 608.

The SoC(s) 604 can include any number of cache(s) 612, including those described herein. For example, the cache(s) 612 can include L0 caches, L1 caches, L2 caches, L3 caches (e.g., that are available to both the CPU(s) 606 and the GPU(s) 608 (e.g., that is connected both the CPU(s) 606 and the GPU(s) 608)), etc. The cache(s) 612 can include a write-back cache that can keep track of states of lines, such as by using one or more cache coherence protocol (e.g., MEI, MESI, MSI, etc.). The (e.g., L3) cache can include 4 MB or more, depending on the implementation, although smaller or larger cache sizes can be used.

The SoC(s) 604 can include one or more arithmetic logic units (ALUs) 665 which can be leveraged in performing processing with respect to any of the variety of tasks or operations of the machine 600—such as computer vision, machine learning or deep learning processing, world model management, etc. In addition, the SoC(s) 604 can include a floating-point unit(s) (FPU(s)) 667—or other math coprocessor or numeric coprocessor types—for performing mathematical operations within the system. For example, the SoC(s) 604 can include one or more FPUs 667 integrated as execution units within a CPU(s) 606 and/or GPU(s) 608.

The SoC(s) 604 can include one or more accelerators 614 (e.g., hardware accelerators, software accelerators, or a combination thereof). For example, the SoC(s) 604 can include a hardware acceleration cluster that can include optimized hardware accelerators and/or large on-chip memory. The large on-chip memory 615 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), can allow the hardware acceleration cluster to accelerate neural network processing, transformer processing, optical flow processing, vision processing, and/or other calculations or processing. The hardware acceleration cluster can be used to complement the GPU(s) 608 and to off-load some of the tasks of the GPU(s) 608 (e.g., to free up more cycles of the GPU(s) 608 for performing other tasks). As an example, the accelerator(s) 614 can be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 614 (e.g., the hardware acceleration cluster) can include a deep learning accelerator(s) (DLA) 609 (alternatively referred to herein as “a deep learning accelerator cluster (XNN) 609,” “neural network accelerator (NNA) 609,” or “neural processing unit (NPU) 609”). The DLA(s) 609 can include one or more Tensor processing units (TPUs) 641 that can be configured to provide an additional, e.g., ten trillion operations per second for deep learning applications and inferencing. The TPUs 641 can be accelerators configured to, and optimized for, performing image processing functions (e.g., for CNNs, RCNNs, DNNs, etc.). The DLA(s) 609 can further be optimized for a specific set of neural network types and floating-point operations, as well as inferencing. The design of the DLA(s) can provide more performance per millimeter than a general-purpose GPU, and vastly exceeds the performance of a CPU. The TPU(s) 641 can perform several functions, including a single-instance convolution function, supporting, for example, INT8, INT16, and FP16 data types for both features and weights, as well as post-processor functions. Although the TPU(s) 641 are described as being included as part of the DLA(s) 609, this is not intended to be limiting, and the TPU(s) 641 can be included in additional or alternative accelerator(s) 614 and/or other components, and/or can be included as a discrete processing component(s).

The DLA(s) 609 can quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 609 can perform any function of the GPU(s) 608, and by using an inference accelerator, for example, a designer can target either the DLA(s) 609 or the GPU(s) 608 for any function. For example, the designer can focus processing of DNNs and floating-point operations on the DLA(s) 609 and leave other functions to the GPU(s) 608 and/or other accelerator(s) 614. The DLA(s) 609 can be used to run any type of network to enhance control and safety, including for example, a neural network that outputs a measure of confidence for each object detection.

The accelerator(s) 614 (e.g., the hardware acceleration cluster) can include a programmable vision accelerator(s) (PVA) 607, which can alternatively be referred to herein as a computer vision accelerator or generally a vision accelerator. The PVA(s) 607 can be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 607 can provide a balance between performance and flexibility. For example, each PVA(s) 607 can include, for example and without limitation, any number of reduced instruction set computer (RISC) cores, direct memory access (DMA) systems, pixel processing engines (PPEs), vector processors or vector processing units (VPUs), and/or other components. The PVA engine can include an advanced very long instruction word (VLIW), single instruction multiple data (SIMD) digital signal processor. The PVA(s) 607 can be optimized for the tasks of image processing and computer vision algorithm acceleration. For example, the PVA(s) 607 provides excellent performance with extremely low power consumption, and can be used asynchronously and concurrently with the CPU(s) 606, GPU(s) 608, and/or other accelerators in the system (e.g., vehicle, robot, etc.) as part of a heterogeneous compute pipeline.

The PVA(s) 607 can include one or more (e.g., two) vector processing subsystems (VPS), where each VPS can include one or more vector processing unit (VPU) cores, one or more decoupled look-up units (DLUTs), one or more shared or vector memories (VMEMs), and one or more instruction caches (I-caches). The VPU core(s) can be the main processing unit, and can include a vector SIMD VLIW DSP 643 optimized for computer vision. The VPU core(s) can fetch instructions through the I-cache(s), and can access data through the VMEM(s). The DLUT(s) can include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) can provide local data storage for the VPU, allowing efficient implementation of various image processing and computer vision algorithms. The VPU VMEM(s) can support access from outside-VPS hosts such as direct memory access (DMA) and the CPU(s) 606 (e.g., ARM Cortex-R5 processor), facilitating data exchange with the CPU(s) 606 and other system-level components. The VPU I-cache can supply instruction data to the VPU(s) when requested, can request missing instruction data from system memory, and/or can maintain temporary instruction storage for the VPU. For each VPU task, the CPU(s) 606 can configures the DMA system, optionally prefetch the VPU program into VPU I-cache, and/or kick off each VPU-DMA pair to process a task. The PVA(s) 607 can also include an L2 SRAM memory to be shared between the one or more (e.g., two) sets of VPS and DMA. In some implementations, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) can be 2048 or greater, excluding the DLUT. The FP32 GMACs can include 32 per PVA instance.

The RISC cores can interact with image sensors (e.g., the image sensors of any of the cameras described herein), image signal processor(s), and/or the like. Each of the RISC cores can include any amount of memory. The RISC cores can use any of a number of protocols, depending on the implementation. In some examples, the RISC cores can execute a real-time operating system (RTOS). The RISC cores can be implemented using one or more integrated circuit devices, application specific integrated circuits (ASICs), and/or memory devices. For example, the RISC cores can include an instruction cache and/or a tightly coupled RAM.

The DMA system can allow components of the PVA(s) 607 to access the system memory independently of the CPU(s) 606. The DMA can support any number of features used to provide optimization to the PVA(s) 607 including, but not limited to, supporting multi-dimensional addressing and/or circular addressing. In some examples, the DMA can support up to six or more dimensions of addressing, which can include block width, block height, block depth, horizontal block stepping, vertical block stepping, and/or depth stepping.

The vector processors or VPUs can be programmable processors that can be designed to efficiently and flexibly execute programming for computer vision algorithms and provide signal processing capabilities. In some examples, the PVA(s) 607 can include a PVA core and two vector processing subsystem partitions. The PVA core can include a processor subsystem, DMA engine(s) (e.g., two DMA engines), and/or other peripherals. The vector processing subsystem can operate as the primary processing engine of the PVA(s) 607, and can include one or more vector processing units (VPUs), one or more pixel processing engines (PPEs)—which can include a 2D layout of interconnected (e.g., for north, south, east, west intercommunication) processing elements, one or more instruction caches, and/or one or more shared or vector memories (e.g., VMEMs). A VPU core can include a digital signal processor such as, for example, a single instruction, multiple data (SIMD), very long instruction word (VLIW) digital signal processor. The combination of the SIMD and VLIW can enhance throughput and speed.

In some implementations, each of the vector processors can include an instruction cache and can be coupled to dedicated memory. As a result, in some examples, each of the vector processors can be configured to execute independently of the other vector processors. In other examples, the vector processors that are included in a particular PVA(s) 607 can be configured to employ data parallelism. For example, in some implementations, the plurality of vector processors included in a single PVA(s) 607 can execute the same computer vision algorithm, but on different regions of an image. In other examples, the vector processors included in a particular PVA(s) 607 can simultaneously execute different computer vision algorithms, on the same image, or even execute different algorithms on sequential images or portions of an image. Among other things, any number of PVAs 607 can be included in the hardware acceleration cluster and any number of vector processors can be included in each of the PVAs. In addition, the PVA(s) 607 can include additional error correcting code (ECC) memory, to enhance overall system safety.

The accelerator(s) 614 (e.g., the hardware accelerator cluster) have a wide array of uses for autonomous and semi-autonomous machine control. The PVA(s) 607 can be a programmable vision accelerator that can be used for key processing stages in perception, robotics understanding and reasoning, ADAS, semi-autonomous, and autonomous vehicles, etc. The PVA's 607 capabilities are a good match for algorithmic domains needing predictable processing, at low power and low latency. In other words, the PVA(s) 607 performs well on semi-dense or dense regular computation, even on small data sets, which need predictable run-times with low latency and low power. Thus, in the context of platforms for autonomous vehicles and robotics, the PVAs 607 are designed to run classic computer vision algorithms, as they are efficient at object detection and operating on integer math.

For example, according to one implementation of the technology, the PVA 607 is used to perform computer stereo vision. A semi-global matching-based algorithm can be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 607 can perform computer stereo vision function on inputs from two monocular cameras.

In some examples, the PVA(s) 607 can be used to perform dense optical flow. According to process raw RADAR data (e.g., using a 4D Fast Fourier Transform) to provide Processed RADAR. In other examples, the PVA(s) 607 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 607, this is not intended to be limiting. In some implementations, these components can be included in alternative or additional processing components and/or accelerator(s) 614, and/or can be included as discrete components of the SoC(s) 604 and/or other computing system architecture(s).

In some examples, the SoC(s) 604 can include a real-time ray-tracing hardware accelerator (RTA) 651 that can be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some implementations, one or more tree traversal units (TTUs) can be used for executing one or more ray-tracing related operations. For example, the machine 600 (or another machine or device) can be simulated within a simulation environment, and the simulation environment can be generated using one or more light transport simulation algorithms (e.g., ray-tracing, path-tracing, etc.). These ray-tracing algorithms can thus be accelerated using a ray-tracing accelerator 651 and/or a ray-tracing optimized GPU 606—such as NVIDIA's RTX GPU.

The accelerator(s) 614 (e.g., in the hardware acceleration cluster) can include one or more optical flow accelerators (OFAs) 611. For example, the OFA(s) 611 can be used for computing optical flow and stereo disparity between frames of sensor data (e.g., images). Optical flow can be accelerated on the OFA(s) 611 for uses such as object detection and tracking, and/or for stereo depth estimation where used for computing stereo disparity between stereo image frames (e.g., two or more frames captured using two or more image sensors with at least partially overlapping fields of view).

The SoC(s) 604 can include one or more camera serial interfaces (CSIs) 623. For example, the CSI(s) 623 can include a mobile industry processor interface (MIPI) camera serial interface (CSI) for receiving video and input from cameras, a high-speed interface, and/or a video input block that can be used for camera and related pixel input functions. The SoC(s) 604 can further include an input/output controller(s) that can be controlled by software and can be used for receiving I/O signals that are uncommitted to a specific role. For example, the CSI 623 can include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2x MIPI CSI-2, 22 pin camera connector, depending on the implementation and implementation.

The accelerator(s) 614 (e.g., the hardware acceleration cluster) can include a computer vision network on-chip (CVNOC) 663 and SRAM, for providing a high-bandwidth, low latency SRAM for the accelerator(s) 614. In some examples, the on-chip memory can include at least 4 MB SRAM, consisting of, for example and without limitation, eight field-configurable memory blocks, that can be accessible by the PVA 607, OFA 611, DLA 609, and/or other accelerator(s) 614. Each pair of memory blocks can include an advanced peripheral bus (APB) interface, configuration circuitry, a controller, and a multiplexer. Any type of memory 615 can be used. The PVA 607, OFA 611, DLA 609, and/or other accelerator(s) 614 can access the memory via a backbone that provides the accelerator(s) 614 with high-speed access to memory. The backbone can include a computer vision network on-chip that interconnects the accelerator(s) 614 to the memory (e.g., using the APB).

The CVNOC 663 can include an interface that determines, before transmission of any control signal/address/data, that the accelerator(s) 614 provide ready and valid signals. Such an interface can provide for separate phases and separate channels for transmitting control signals/addresses/data, as well as burst-type communications for continuous data transfer. This type of interface can comply with ISO 26262 or IEC 61508 standards, although other standards and protocols can be used.

The SoC(s) 604 can include data store(s) 616 and/or memory 615. The data store(s) 616 can be on-chip memory 615 of the SoC(s) 604, which can store neural networks and/or other algorithms to be executed on the CPU(s) 606, the GPU(s) 608, and/or one or more of the accelerator(s) 614. In some examples, the data store(s) 616 can be large enough in capacity to store multiple instances of neural networks for redundancy and safety. The data store(s) 612 can include L2 and/or L3 cache(s) 612, for example. The memory(ies) 615 can include SRAM, LPDDR5, and/or other memory types. For example, the memory(ies) 615 can include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 616 can include reference to the memory associated with the PVA 607, OFA 611, DLA 609, and/or other accelerator(s) 614, as described herein.

The data store(s) 116 can include various storage types, such as eMMC, NVMe, etc. For example, the SoC(s) 604 can include storage in the form of an embedded multimedia card (eMMC) (e.g., 64 GB eMMC 5.1) and/or an SD card slot, with external NVM express (NVMe) capability, e.g., via M.2 Key M. For example, the data store(s) 616 and/or other storage can be accessed via, e.g., NVMe, using PCI Express (PCIe), RDMA, TCP, and/or other protocols.

The SoC(s) 604 can include one or more processor(s) 610 (e.g., embedded processors). The processor(s) 610 can include a boot and power management processor (BPMP) 653, that can be a dedicated processor and subsystem to handle boot power and management functions and related security enforcement. The BPMP 653 can be a part of the SoC(s) 604 boot sequence and can provide runtime power management services. The BPMP 653 can provide clock and voltage programming, assistance in system low power state transitions, management of SoC(s) 604 thermals and temperature sensors, and/or management of the SoC(s) 604 power states. Each temperature sensor can be implemented as a ring-oscillator whose output frequency is proportional to temperature, and the SoC(s) 604 can use the ring-oscillators to detect temperatures of the CPU(s) 606, GPU(s) 608, accelerator(s) 614, and/or other components. If temperatures are determined to exceed a threshold, BPMP 653 can enter a temperature fault routine and put the SoC(s) 604 into a lower power state and/or put the machine 600 into a chauffeur to safe stop mode (e.g., bring the machine 600 to a safe stop).

The processor(s) 610 can further include a set of embedded processors that can serve as an audio processing engine (APE) 655. The APE 655 can be an audio subsystem that allows full hardware support for multi-channel audio over multiple interfaces, and a broad and flexible range of audio I/O interfaces. In some examples, the APE 655 is a dedicated processor core with a digital signal processor with dedicated RAM.

The processor(s) 610 can further include an always on processor engine (AOPE) 657 that can provide necessary hardware features to support low power sensor management and wake use cases. The AOPE 657 can include a processor core, a tightly coupled RAM, supporting peripherals (e.g., timers and interrupt controllers), various I/O controller peripherals, and routing logic.

The processor(s) 610 can further include a safety processor(s) 613 (alternatively referred to as “safety island 613”), which can include a safety cluster engine that includes a dedicated processor or processor subsystem to handle safety management for automotive, robotics, and/or other applications. The safety processor(s) 613—and/or safety cluster engine—can include two or more processor cores, a tightly coupled RAM, support peripherals (e.g., timers, an interrupt controller, etc.), and/or routing logic. In a safety mode, the two or more cores can operate in a lockstep mode and function as a single core with comparison logic to detect any differences between their operations. In some implementations, the safety processor(s) 613 can include a discrete processor(s), such that fault of other system components cannot impact the performance and availability of the safety processor 613.

The processor(s) 610 can further include a real-time or near real-time sensor engine (SE) 659 that can include a dedicated processor subsystem for handling real-time or near real-time camera, LiDAR, RADAR, and/or other sensor modality management.

The processor(s) 610 can further include one or more image signal processors (ISPs) 627, which can include a high-dynamic range signal processor and/or a hardware engine that is part of one or more sensor processing pipelines.

The processor(s) 610 can include a video image compositor (VIC) 661 that can be a processing block (e.g., implemented on a microprocessor) that implements video post-processing functions needed by a video playback application to produce the final image for the player window. The VIC 661 can perform lens distortion correction on wide-view camera(s) 668B, surround camera(s) 668D, in-cabin monitoring camera sensors, and/or other camera sensors with distorted fields of view.

A VIC 661 can include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor can use information from the previous image to reduce noise in the current image.

A VIC 661 can also be configured to perform stereo rectification on input stereo lens frames. The video image compositor can further be used for user interface composition when the operating system desktop is in use, and the GPU(s) 608 is not required to continuously render new surfaces. Even when the GPU(s) 608 is powered on and active doing 3D rendering, the video image compositor can be used to offload the GPU(s) 608 to improve performance and responsiveness.

The SoC(s) 604 can further include a broad range of peripheral interfaces for input/output (I/O) 625, such as to allow communication with peripherals, audio codecs, power management, and/or other devices. The SoC(s) 604 can be used to process data from cameras (e.g., connected over Gigabit Multimedia Serial Link and/or Ethernet), sensors (e.g., LiDAR sensor(s) 664, RADAR sensor(s) 660, etc. that can be connected over Ethernet), data from bus 602 (e.g., speed of machine 600, steering wheel position, etc.), data from GNSS sensor(s) 658 (e.g., connected over Ethernet or CAN bus). The SoC(s) 604 can further include dedicated high-performance mass storage controllers that can include their own DMA engines, and that can be used to free the CPU(s) 606 from routine data management tasks. In some implementations, the SoC(s) 604 I/O 625 can include a header (e.g., a 40 pin header, or 40 pin expansion header) with support for universal asynchronous receiver/transmitter (UART), serial peripheral interface (SPI), inter-integrated circuit sound (12S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 625 elements, components, or features.

The SoC(s) 604 can include in-machine networking capability using, for example, Ethernet (e.g., automotive Ethernet), SERDES, controller area network (CAN), FlexRay, local interconnect network (LIN), low voltage differential signaling (LVDS), media-oriented system transport (MOST), another networking type, and/or a combination thereof. For example, the SoC(s) 604 can include an RJ45 connector with up to 10 GbE, a 1 GbE connector, and/or other networking connector types.

The SoC(s) 604 can include one or more digital signal processors (DSPs) 643. For example, the DSP(s) 643 can include a dedicated or specialized microprocessor chip optimized for digital signal processing-such as in audio signal processing, telecommunications, digital image processing, RADAR, SONAR, LiDAR, and/or other sensor processing, speech recognition, and/or other applications.

The SoC(s) 604 can include one or more video encoders 619 and/or one or more video decoders 621. For example, the video encoder(s) 619 can include a hardware-based (e.g., as part of the GPU(s) 608) video encoder (e.g., supporting H.264, H.265, etc., and being HEVC compliant, such as NVIDIA's NVENC) that can process image inputs (e.g., as YUV, RGB, etc.) to generate a video bit stream. The video decoder(s) 621 can include a video decoder engine that can provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc., and being HEVC compliant, such as NVIDIA's NVDEC). In some examples, the video decoder(s) 621 can be hardware-based (e.g., as part of the GPU(s) 608).

The SoC(s) 604 can include one or more general compute acceleration clusters (GCAC(s)) 629. For example, the GCAC(s) 629 can include various processor types that can be used to accelerate compute, such as one or more vector microcode processors (VMPs) 633, one or more multi-threaded processing clusters (MPCs) 631, one or more programmable macro arrays (PMA(s)) 635, and/or one or more other processor types. For example, the GCAC(s) 629 can include a PMA 635, two VMPs 633, and 2 MPCs 631.

The SoC(s) 604 can include one or more vector microcode processors (VMPs) 633. The VMP(s) 633, in implementations, can include a wide vector (very long instruction word (VLIW) and single instruction multiple data (SIMD)) machine with performing various operations, such as short integral type operations common in computer vision and deep learning algorithms.

The SoC(s) 604 can include one or more multi-threaded processing clusters (MPCs) 631. The MPC(s) 631 can include a processing cluster that be, in implementations, more versatile than a GPU, and with higher efficiency than a CPU. For example, the MPC(s) 631 can include a multi-threaded processor that allows multiple threads to share resources and execute instructions concurrently.

The SoC(s) 604 can include one or more programmable macro arrays (PMA(s)) 635. The PMA(s) 635 can include a coarse-grained reconfigurable architecture (CGRA) dataflow machine, having a unique architecture that delivers strong performance on dense computer vision and deep learning algorithms that can be unachievable in classic digital signal processing (DSP) architectures.

The SoC(s) 604 can include one or more display processing units (DPUs) 645 for performing hardware-accelerated image processing. For example, the DPU(s) 645 can retrieve pixel data from memory 615 and send it to a display peripheral through standard interfaces. As such, the DPU(s) 645 can handle display processing and rendering for in-machine and/or on-machine displays.

The SoC(s) 604 can include one or more application processing units (APUs) 639. For example, the APU(s) 639 can include a quad or dual-core processor with 48 KB/32 KB L1 cache with parity and ECC, along with a 1 MB L2 cache with ECC. The APU(s) 639 can support NEON instructions and single and double precision floating point operations.

The SoC(s) 604 can include one or more real-time processing units (RTPUs) 669. The RTPU(s) 669 can include a dual-core processor with 32 KB/32 KB L1 cache, and 256 KB TCM with ECC. The RTPU(s) 669 can support single and double precision floating point operations.

The SoC(s) 604 can include one or more built-in self-test (BIST) components 637. For example, the BIST component(s) 637 can include memory BIST (MBIST) to test memories of the system and/or logic BIST (LBIST) to test logic of the system. The BIST components 637 can include embedded logic for directly testing logic and/or memory of the system.

The SoC(s) 604 can include one or more dynamically reconfigurable processors (DRPs) 671. For example, the DRP(s) 671 can be used for accelerating various computing operations. For example, the DRP(s) 671 can be combined, in implementations, with a MAC unit for use as an AI accelerator. In implementations, the DRP(s) 671 can execute applications while dynamically switching the circuit connection configuration of the arithmetic units (e.g., ALUs) on the chip at each operating clock according to the content to be processed. Since only the necessary arithmetic circuits are used, the DRP(s) 671 can consume less power than with CPU processing and can achieve higher speed. Furthermore, compared to CPUs, where frequent external memory accesses due to cache misses and other causes will degrade performance, the DRP(s) 671 can build the necessary data paths in hardware ahead of time, resulting in less performance degradation and less variation in operating speed (jitter) due to memory accesses. The DRP(s) 671 can include a dynamic loading function that switches the circuit connection information each time the algorithm changes, enabling processing with limited hardware resources, even in robotic/automotive applications that require processing of multiple algorithms.

In some implementations, the accelerator(s) 614 can include an OpenCV accelerator for speeding up processing of OpenCV, an open-source industry standard library for computer vision processing. In some implementations, the combination of one or more DRP(s) 671 deployed as an AI accelerator along with an OpenCV accelerator(s) can enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to allow Level 2-5 autonomous driving functionality and/or autonomous robotics movement, control, planning, and/or navigation operations. In addition, because the SoC(s) 604 can include various compute engines (e.g., processors 610, CPUs 606, GPU(s) 608, accelerator(s) 614, etc.), tasks can be distributed between and among the compute engines, in some instances without common cause failures due to the discrete footprint of the compute engines. Further, because the SoC(s) 604 can include a dedicated safety processor(s) 613 (or safety island 613), critical safety or redundant operations can be performed without common cause failures from the main processing components or compute engines of the SoC(s) 604. Due to these features, the SoC(s) 604 and/or the underlying systems of the machine 600 can be capable of satisfying higher levels of safety-such as automotive safety integrity level (ASIL) D from the ISO 26262 standard.

FIG. 6E is a system diagram for communication between a cloud-based server(s) (e.g., in a data center, such as those described herein) and the example autonomous or semi-autonomous vehicle or machine 600 of FIG. 6A, in accordance with some implementations of the present disclosure. The system 676 can include a server(s) 678, a network(s) 690, and a machine(s) 600. The server(s) 678 can include a plurality of GPUs 684(A)-684(H) (collectively referred to herein as GPUs 684), switches 682(A)-682(H) (such as PCIe 4.0/5.0/etc. switches, M.2 slots, thunderbolt, USB4, NVIDIA's NVLink, NVIDIA's NVSwitch, GPUDirect RDMA, GPUDirect Storage, etc.), CPUs 680(A)-680(B) (collectively referred to herein as CPUs 680), accelerators, and/or other processor types. The GPUs 684, the CPUs 680, and the PCIe switches can be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the implementation, each of the server(s) 678 can include any number of GPUs 684, CPUs 680, and/or PCIe switches. For example, the server(s) 678 can each include eight, sixteen, thirty-two, and/or more GPUs 684.

The server(s) 678 can receive, over the network(s) 690 and from the machine(s) 600, sensor data indicating information about new or previously unexplored locations, and/or sensor data indicating changes to previously seen/stored locations (e.g., unexpected or changed road conditions, such as recently commenced road-work). The server(s) 678 can transmit, over the network(s) 690 and to the machine(s) 600, neural networks 692, updated neural networks 692, map information 694, etc., including information regarding traffic and road conditions. The updates to the map information 694 can include updates for the HD map 622, SD map, navigation map, etc., such as information regarding construction sites, potholes, detours, flooding, and/or other obstructions. In some examples, the neural networks 692, the updated neural networks 692, the map information 694, and/or the other information can have resulted from new training and/or experiences represented in data received from any number of machine(s) 600 in the environment, and/or based on training performed at a datacenter (e.g., using the server(s) 678 and/or other servers).

The server(s) 678 can be used to train machine learning models (e.g., neural networks) based on training data. The training data can be generated by the machine(s) 600, and/or can be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training can be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models can be used by the machine(s) 600 (e.g., transmitted to the machine(s) 600 over the network(s) 690, and/or the machine learning models can be used by the server(s) 678 to remotely monitor and/or control the machine(s) 600.

In some examples, the server(s) 678 can receive data from the machine(s) 600 and apply the data to up-to-date real-time neural networks for real-time intelligent inferencing. The server(s) 678 can include deep-learning supercomputers and/or dedicated AI computers powered by GPU(s) 684, such as a DGX and DGX Station machines developed by NVIDIA. However, in some examples, the server(s) 678 can include deep learning infrastructure that use only CPU-powered datacenters.

The deep-learning infrastructure of the server(s) 678 can be capable of fast, real-time inferencing, and can use that capability to evaluate and verify the health of the processors, software, and/or associated hardware in the machine 600. For example, the deep-learning infrastructure can receive periodic updates from the machine 600, such as a sequence of images and/or objects that the machine 600 has located in that sequence of images (e.g., via computer vision and/or other machine learning object classification techniques). The deep-learning infrastructure can run its own neural network to identify the objects and compare them with the objects identified by the machine 600 and, if the results do not match and the infrastructure concludes that the AI in the machine 600 is malfunctioning, the server(s) 678 can transmit a signal to the machine 600 instructing a fail-safe computer of the machine 600 to assume control, notify the passengers, and complete a safety maneuver or operation-such as to slow down, hand control back to a driver, come to a stop, and/or pull over/shut down.

For inferencing, the server(s) 678 can include the GPU(s) 684 and one or more programmable inference accelerators (e.g., NVIDIA's TensorRT). The combination of GPU-powered servers and inference acceleration can make real-time responsiveness possible. In other examples, such as where performance is less critical, servers powered by CPUs, FPGAs, and other processors can be used for inferencing.

### Computing Ecosystem for Generating, Training, and Deploying AI

FIG. 7 is a system diagram illustrating a three computer ecosystem 700, including a first computing system 702 for generating or creating artificial intelligence (AI)—such as AI training and validation data, a second computing system 704 for training artificial intelligence, and a third computing system 706 (which can include or correspond to the SoC(s) 604 of FIGS. 6A-6E) deploying the AI at the edge, in accordance with at least some implementations of the present disclosure. For example, to develop and deploy embodied or physical AI, the three-computer ecosystem 700 can be used, including three accelerated computer systems to handle physical AI training, simulation, and runtime (e.g., edge deployment). These systems can generate training data for and train multimodal foundation models (and/or other model types) using scalable, physically based simulations of the machine(s) 600 and their worlds. By doing so, simulation of machine(s) 600 can be performed at scale, allowing for refinement, testing, and optimization of skills (e.g., robot skills) in a virtual world (e.g., using NVIDIA's OMNIVERSE) that mimics the laws of physics-helping to reduce real-world data acquisition costs and ensuring the machine(s) 600 can perform safely in controlled settings.

The computing system 704 (e.g., NVIDIA's DGX Platform) can be used to train and fine-tune powerful foundation and generative AI models. Models, such as general-purpose foundation models (e.g., NVIDIA's Project GROOT), can be used to allow robots and other machine(s) 600 to understand natural language and emulate movements by observing human actions. The computing system 704 can include a platform that incorporates software, infrastructure, and expertise in a modern, unified AI development and training solution. The computing system 704 can include individual computing devices 710 (e.g., NVIDIA's DGX B200, H200, etc.) and/or any number of computing devices 710 in a data center infrastructure 712 (e.g., NVIDIA's DGX SuperPOD).

For example, the individual computing devices 710 can include GPUs (e.g., 8 GPUs with 1,440 GB total GPU memory) and CPUs (e.g., 2 CPUs with 112 cores total, 2.1 GHZ, or 4 GHz (with boost)) that provide upwards of 72 petaFLOPS for training and 144 petaFLOPS for inference. The computing devices 710 can include memory (e.g., 4 TB memory, and storage (e.g., OS storage of 2×1.9 TB NVMe M.2, and internal storage of 8×3.84 TB NVMe U.2). The computing devices 710 can include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 710 can further include, e.g., dual port quad small form-factor pluggable (QSFFP) data processing units (DPUs) (e.g., 2 dual-port QSFP112 DPUs such as NVIDIA's BlueField-3 DPUs), providing up to 400 Gb/s InfiniBand/Ethernet. The computing device(s) 710 can include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some implementations, the NICs used for the computing device(s) 710 can include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other implementations, the computing device(s) 710 can include a smart host channel adapter (HCA) (e.g., NVIDIA's ConnectX-7) to provide ultra-low latency, 400 Gb/s throughput for in-network computing acceleration engines.

The data center infrastructure 712 can include any number of the computing devices 710, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 710) to thousands, job scheduling and orchestration to ensure hassle-free execution of every developer's job, AI workflow management and machine learning operations (MLOps) to move more models from prototype to production, and enterprise software to speed developer success.

The computing system 702 (e.g., NVIDIA's OVX servers) can provide a development and simulation platform for testing and optimizing physical AI with APIs and frameworks for simulation (e.g., NVIDIA's DriveSIM, ISAAC Sim, ISAAC Gym, ISAAC Labetc.). The computing system 702 allows developers to use simulation frameworks to simulate and validate robot models, and/or to generate massive amounts of physically-based synthetic data to bootstrap model training. The computing system 702 can support learning frameworks that power robot reinforcement learning and imitation learning, to accelerate robot policy training and refinement. For example, the computing system 702 can be used to generate any number of simulations 708—such as within NVIDIA's OMNIVERSE. The computing system 702 can be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 702 can host or support a native OpenUSD software platform enabling enterprises to connect 3D pipelines and develop advanced, real-time 3D applications for industrial digitalization. With powerful ray-tracing-accelerated AI and graphics capabilities, the computing system 702 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 702 can include individual computing devices 714 (e.g., NVIDIA's OVX L40S Server) and/or any number of computing devices 714 in a data center infrastructure 716 (e.g., NVIDIA's OVX Systems).

The computing device(s) 714 (which can include a server) can include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16:64 GB/s bidirectional interconnect interface, 18,176 CUDA cores, 142 ray tracing (RT) cores, and 568 tensor cores). The computing devices 714 can include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs-such as an NVIDIA BlueField-3 DPU), providing up to 400 Gb/s InfiniBand/Ethernet. In some implementations, the NICs used for the computing device(s) 714 can include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other implementations, the computing device(s) 714 can include a smart host channel adapter (HCA) (e.g., NVIDIA's ConnectX-7) to provide ultra-low latency, 400 Gb/s throughput for in-network computing acceleration engines. The computing device(s) 714 can include a host memory (e.g., 384 Gb DDR5 ECC for 4 GPUs, or 768 Gb DDR5 ECC for 8 GPUs), and can include a dual in-line memory module (DIMM) slot(s), a host boot drive (e.g., 1 TB NVMe), and/or a host storage (e.g., 2 4 TB NVMe).

Similar to the data center infrastructure 712, the data center infrastructure 716 can allow for any number of computing device(s) 714 to be combined in cluster configuration according to a reference architecture.

The computing system 706 can be used to deploy trained AI models on a runtime computer—such as the SoC(s) 604 described herein. For example, these computing systems 706 can be designed for compact, on-board computing needs, including an ensemble of models for control policy, vision and language models, etc., deployed on a power-efficient on-board edge computing system 706. Details of components, features, and capabilities of the computing system 706 can be described in more detail herein with respect to FIGS. 6A-6E.

### Example Generative Models

In at least some implementations, language models, such as large language models (LLMs), vision language models (VLMs), multi-modal language models (MMLMs), vision-language-action (VLA) models, and/or other types of generative artificial intelligence (AI) can be implemented. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)-such as millions or billions of parameters. The LLMs/VLMs/MMLMs/etc. can be implemented for summarizing textual data, analyzing and extracting insights from data (e.g., textual, image, video, etc.), and generating new text/image/video/etc. in styles, and/or formats. The user specified tones, LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), can be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—maybe be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 8 is a block diagram of an example generative language model system 800 suitable for use in implementing at least some implementations of the present disclosure. In the example illustrated in FIG. 8, the generative language model system 800 includes a retrieval augmented generation (RAG) component 892, an input processor 805, a tokenizer 810, an embedding component 820, plug-ins/APIs 895, and a generative language model (LM) 830 (which can include an LLM, a VLM, a MMLM, a VLA model, etc.).

At a high level, the input processor 805 can receive an input 801 including text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some implementations, the input 801 includes plain text in the form of one or more sentences, paragraphs, and/or documents. Additionally, or alternatively, the input 801 can include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 can combine text (or can omit text) with image data, audio data, video data, design data, USD data, and/or other types of input data, such as but not limited to those described herein. Taking raw input text as an example, the input processor 805 can prepare raw input text in various ways. For example, the input processor 805 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 can remove stopwords to reduce noise and focus the generative LM 830 on more meaningful content. The input processor 805 can apply text normalization (TN), for example, by converting all characters to lowercase, removing accents, and/or or handling special cases like contractions or abbreviations to ensure consistency (e.g., converting-° to one quarter). Similarly, the input processor 805 and/or a post-processor can perform inverse text normalization (ITN) in order to convert plain language back to canonical or other forms (e.g., to convert one quarter to)-°. These are just a few examples, and other types of input and/or output processing can be applied.

In some implementations, a RAG component 892 (which can include one or more RAG models, and/or can be performed using the generative LM 830 itself) can be used to retrieve additional information to be used as part of the input 801 or prompt. RAG can be used to enhance the input to the LLM/VLM/MMLM/etc. with external knowledge, so that answers to specific questions or queries or requests are more relevant—such as in a case where specific knowledge is required. The RAG component 892 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 801 can be generated using the query or input to the model (e.g., a question, a request, etc.) in addition to data retrieved using the RAG component 892. In some implementations, the input processor 805 can analyze the input 801 and communicate with the RAG component 892 (or the RAG component 892 can be part of the input processor 805, in implementations) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 can retrieve a prior stored conversation history—or at least a summary thereof—and include the prior conversation history along with the current ask/request as part of the input 801 to the generative LM 830.

The RAG component 892 can use various RAG techniques. For example, naive RAG can be used where documents are indexed, chunked, and applied to an embedding model to generate embeddings corresponding to the chunks. A user query can also be applied to the embedding model and/or another embedding model of the RAG component 892 and the embeddings of the chunks along with the embeddings of the query can be compared to identify the most similar/related embeddings to the query, which can be supplied to the generative LM 830 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naive and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 892 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 810 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy can depend on factors such as the language being processed, the task at hand, and/or characteristics of the training dataset. As such, the tokenizer 810 can convert the (e.g., processed) text into a structured format according to tokenization schema being implemented in the particular implementation.

The embedding component 820 can use any known embedding technique to transform discrete tokens into (e.g., dense, continuous vector) representations of semantic meaning. For example, the embedding component 820 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 805 can resize the data to a standard size compatible with format of a corresponding input channel and/or can normalize pixel values to a common range (e.g., 0 to 1) to ensure a consistent representation, and the embedding component 820 can encode the image data using any known technique (e.g., using one or more convolutional neural networks (CNNs) to extract visual features). In some implementations in which the input 801 includes audio data, the input processor 805 can resample an audio file to a consistent sampling rate for uniform processing, and the embedding component 820 can use any known technique to extract and encode audio features-such as in the form of a spectrogram (e.g., a mel-spectrogram). In some implementations in which the input 801 includes video data, the input processor 805 can extract frames or apply resizing to extracted frames, and the embedding component 820 can extract features such as optical flow embeddings or video embeddings and/or can encode temporal information or sequences of frames. In some implementations in which the input 801 includes multi-modal data, the embedding component 820 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 820 can apply an encoded representation of the input 801 to the generative LM 830, and the generative LM 830 can process the encoded representation of the input 801 to generate an output 890, which can include responsive text and/or other types of data.

As described herein, in some implementations, the generative LM 830 can be configured to access or use—or capable of accessing or using—plug-ins/APIs 895 (which can include one or more plug-ins, application programming interfaces (APIs), databases, data stores, repositories, etc.). For example, for certain tasks or operations that the generative LM 830 is not ideally suited for, the model can have instructions (e.g., as a result of training, and/or based on instructions in a given prompt, such as those retrieved using the RAG component 892) to access one or more plug-ins/APIs 895 (e.g., 3rd party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 895 to the plug-in/API 895, the plug-in/API 895 can process the information and return an answer to the generative LM 830, and the generative LM 830 can use the response to generate the output 890. This process can be repeated—e.g., recursively—for any number of iterations and using any number of plug-ins/APIs 895 until an output 890 that addresses each ask/question/request/process/operation/etc. from the input 801 can be generated. As such, the model(s) can not only rely on its own knowledge from training on a large dataset(s) and/or from data retrieved using the RAG component 892, but also on the expertise or optimized nature of one or more external resources—such as the plug-ins/APIs 895.

In some implementations, one or more transformer engines (TEs) can be implemented. The transformer engine can use micro—tensor scaling to optimize performance and accuracy-such as to allow 16-bit floating point (FP16), 8-bit floating point (FP8), and/or 4-bit floating point (FP4) artificial intelligence processing. For example, the transformer engine can use 16-bit or 8-bit floating point precision, and an 8-bit or 4-bit floating point data format combined with software algorithms for increasing AI performance and capabilities. By reducing math operations to 8-bits or 4-bits, the TE allows for training larger networks faster without compromising accuracy. For example, the TEs can include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which allow mixed-precision computing, such as micro-scaling precision support), server clusters can be more capable of training enormous networks (e.g., billions of parameters) at high speeds. As such, tensor core precisions of FP64, TF32, BF16, FP16, FP8, INT8, FP6, and FP4 can be supported, as well as CUDA core precisions of FP64, FP32, FP16, and BF16.

These and other architectures for LLMs/VLMs/MMLMs/VLAs/etc. described herein are meant simply as examples, and other suitable architectures can be implemented within the scope of the present disclosure.

### Example Computing Device

FIG. 9 is a block diagram of an example computing device(s) 900 suitable for use in implementing some implementations of the present disclosure. Computing device 900 can include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s), speaker(s), etc.), and one or more logic units 920. In at least one implementation, the computing device(s) 900 can include one or more virtual machines (VMs), and/or any of the components thereof can include virtual components (e.g., virtual hardware components). For non-limiting examples, one or more of the GPUs 908 can include one or more vGPUs, one or more of the CPUs 906 can include one or more vCPUs, and/or one or more of the logic units 920 can include one or more virtual logic units. As such, a computing device(s) 900 can include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some implementations, a presentation component 918, such as a display device, can be considered an I/O component 914 (e.g., if the display is a touch screen). As another example, the CPUs 906 and/or GPUs 908 can include memory (e.g., the memory 904 can be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 can represent one or more links or busses, such as an address bus, a data bus, a control bus, or a combination thereof. The interconnect system 902 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 906 can be directly connected to the memory 904. Further, the CPU 906 can be directly connected to the GPU 908. Where there is direct, or point-to-point connection between components, the interconnect system 902 can include a PCIe link to carry out the connection. In these examples, a PCI bus need not be included in the computing device 900.

The memory 904 can include any of a variety of computer-readable media. The computer-readable media can be any available media that can be accessed by the computing device 900. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 904 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device 900. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 906 can be configured to execute at least some of the computer-readable instructions to control one or more components of the computing device 900 to perform one or more of the methods and/or processes described herein. The CPU(s) 906 can each include one or more cores (e.g., one, two, four, eight, twenty-eight, seventy-two, etc.) that are capable of handling a multitude of software threads simultaneously. The CPU(s) 906 can include any type of processor, and can include different types of processors depending on the type of computing device 900 implemented (e.g., processors with fewer cores for mobile devices and processors with more cores for servers). For example, depending on the type of computing device 900, the processor can be an Advanced RISC Machines (ARM) processor implemented using Reduced Instruction Set Computing (RISC) or an x86 processor implemented using Complex Instruction Set Computing (CISC). The computing device 900 can include one or more CPUs 906 in addition to one or more microprocessors or supplementary co-processors, such as math co-processors.

In addition to or alternatively from the CPU(s) 906, the GPU(s) 908 can be configured to execute at least some of the computer-readable instructions to control one or more components of the computing device 900 to perform one or more of the methods and/or processes described herein. One or more of the GPU(s) 908 can be an integrated GPU (e.g., with one or more of the CPU(s) 906 and/or one or more of the GPU(s) 908 can be a discrete GPU. In implementations, one or more of the GPU(s) 908 can be a coprocessor of one or more of the CPU(s) 906. The GPU(s) 908 can be used by the computing device 900 to render graphics (e.g., 3D graphics) or perform general purpose computations. For example, the GPU(s) 908 can be used for General-Purpose computing on GPUs (GPGPU). The GPU(s) 908 can include hundreds or thousands of cores that are capable of handling hundreds or thousands of software threads simultaneously. The GPU(s) 908 can generate pixel data for output images in response to rendering commands (e.g., rendering commands from the CPU(s) 906 received via a host interface). The GPU(s) 908 can include graphics memory, such as display memory, for storing pixel data or any other suitable data, such as GPGPU data. The display memory can be included as part of the memory 904. The GPU(s) 908 can include two or more GPUs operating in parallel (e.g., via a link). The link can directly connect the GPUs (e.g., using NVLINK) or can connect the GPUs through a switch (e.g., using NVSwitch). When combined together, each GPU 908 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 906 and/or the GPU(s) 908, the logic unit(s) 920 can be configured to execute at least some of the computer-readable instructions to control one or more components of the computing device 900 to perform one or more of the methods and/or processes described herein. In implementations, the CPU(s) 906, the GPU(s) 908, and/or the logic unit(s) 920 can discretely or jointly perform any combination of the methods, processes and/or portions thereof. One or more of the logic units 920 can be part of and/or integrated in one or more of the CPU(s) 906 and/or the GPU(s) 908 and/or one or more of the logic units 920 can be discrete components or otherwise external to the CPU(s) 906 and/or the GPU(s) 908. In implementations, one or more of the logic units 920 can be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 can include one or more receivers, transmitters, and/or transceivers that allow the computing device 900 to communicate with other computing devices via an electronic communication network, included wired and/or wireless communications. The communication interface 910 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 920 and/or communication interface 910 can include one or more data processing units (DPUs) to transmit data received over a network and/or through interconnect system 902 directly to (e.g., a memory of) one or more GPU(s) 908.

The I/O ports 912 can allow the computing device 900 to be logically coupled to other devices including the I/O components 914, the presentation component(s) 918, and/or other components, some of which can be built in to (e.g., integrated in) the computing device 900. Illustrative I/O components 914 include a microphone, mouse, keyboard, joystick, game pad, game controller, satellite dish, scanner, printer, wireless device, etc. The I/O components 914 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 can be include depth cameras, such as stereoscopic camera systems, infrared camera systems, RGB camera systems, touchscreen technology, and combinations of these, for gesture detection and recognition. Additionally, the computing device 900 can include accelerometers or gyroscopes (e.g., as part of an inertia measurement unit (IMU)) that allow detection of motion. In some examples, the output of the accelerometers or gyroscopes can be used by the computing device 900 to render immersive augmented reality or virtual reality.

The power supply 916 can include a hard-wired power supply, a battery power supply, or a combination thereof. The power supply 916 can provide power to the computing device 900 to allow the components of the computing device 900 to operate.

The presentation component(s) 918 can include a display (e.g., a monitor, a touch screen, a television screen, a heads-up-display (HUD), other display types, or a combination thereof), speakers, and/or other presentation components. The presentation component(s) 918 can receive data from other components (e.g., the GPU(s) 908, the CPU(s) 906, DPUs, etc.), and output the data (e.g., as an image, video, sound, etc.).

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 900 of FIG. 9—e.g., each device can include similar components, features, and/or functionality of the computing device(s) 900. In addition, where backend devices (e.g., servers, NAS, etc.) are implemented, the backend devices can be included as part of a data center (such as, but not limited to, those described herein).

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 900 described herein with respect to FIG. 9. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

Clause 1. A system, comprising: one or more processors to execute operations comprising: obtain a set of visual data of a video captured at multiple times from multiple viewpoints; determine a reference time matching one of the multiple times or a time between two of the multiple times; generate, using an artificial intelligence (AI) model, a three-dimensional (3D) representation of a scene at the reference time based on the set of visual data; and provide the 3D representation for viewing from multiple perspectives.

Clause 2. The system of clause 1, wherein the one or more processors are to execute operations comprising: generate additional visual data representing a new view of the scene at the reference time, the additional visual data is different from the set of visual data; and update the set of visual data to include the additional visual data.

Clause 3. The system of clause 1, wherein generating the 3D representation includes converting an output of the AI model into visual rendering data defining a 3D shape, wherein the visual rendering data includes at least one of a color, size, orientation, transparency, or depth in the scene.

Clause 4. A system, comprising: one or more processors to execute operations comprising: one or more operations to obtain a plurality of context frames of video data, the plurality of context frames corresponding to a plurality of camera poses at a plurality of timestamps; one or more operations to determine a reference timestamp is one of the plurality of timestamps or between two of the plurality of timestamps of the plurality of context frames; one or more operations to apply the plurality of context frames, the plurality of camera poses, and the reference timestamp as a plurality of inputs to a vision model to cause the vision model to generate a volumetric representation of a scene at the reference timestamp; and one or more operations to provide the volumetric representation of the scene at the reference timestamp for rendering at a plurality of perspectives.

Clause 5. The system of clause 4, wherein the operations executed by the one or more processors further comprise: one or more operations to segment at least one context frame of the plurality of context frames into a plurality of patches; and one or more operations to generate at least one token of a plurality of tokens for at least one of the plurality of patches, the at least one token comprising: at least one image feature; at least one pose feature; and at least one time feature.

Clause 6. The system of clause 5, wherein: the one or more operations to apply the plurality of context frames, the plurality of camera poses, and the reference timestamp as inputs comprises one or more operations to apply the plurality of tokens as the plurality of inputs to the vision model to cause the vision model to generate the volumetric representation; and the operations executed by the one or more processors further include operations to cause the vision model to map at least one output token of the vision model to at least one parameter of a three-dimensional (3D) Gaussian, the at least one parameter comprising at least one of color, scale, rotation, opacity, or a distance along a ray.

Clause 7. The system of clause 4, wherein the operations executed by the one or more processors further comprise: one or more operations to generate, using at least one artificial intelligence (AI) model, an interpolated frame at the reference timestamp different from the plurality of timestamps of the plurality of context frames; and one or more operations to update the plurality of context frames to comprise the interpolated frame corresponding with the reference timestamp.

Clause 8. The system of clause 4, wherein the one or more operations to apply the plurality of context frames, the plurality of camera poses, and the reference timestamp to the vision model to cause the vision model to generate the volumetric representation further comprises: one or more operations to perform an unprojection of a plurality of pixel locations from at least one context frame of the plurality of context frames into 3D space based on the plurality of camera poses; one or more operations to assign at least one distance parameter to the plurality of pixel locations to position a plurality of 3D Gaussians along a plurality of rays; and one or more operations to update at least one 3D parameter of the plurality of 3D Gaussians to represent a portion of the scene.

Clause 9. The system of clause 8, wherein: the plurality of 3D Gaussians are positioned based at least on a plurality of spatial changes corresponding to at least one motion trajectory of at least one object between the plurality of context frames; and the plurality of 3D Gaussians are configured for rendering from the plurality of perspectives and to represent the at least one motion trajectory of the at least one object within the scene at the reference timestamp.

Clause 10. The system of clause 4, wherein the operations executed by the one or more processors further comprise: one or more operations to render at least one two-dimensional (2D) image from the volumetric representation of the scene at the reference timestamp; one or more operations to determine at least one performance metric based on at least one loss function and a ground-truth image; and one or more operations to update at least one model parameter of the vision model based on the at least one performance metric.

Clause 11. The system of clause 4, wherein the operations executed by the one or more processors further comprise: one or more operations to identify a plurality of reference timestamps based at least on iterating through the plurality of timestamps of the video data corresponding to a monocular video; one or more operations to apply the plurality of context frames, the plurality of camera poses, and at least one of the plurality of reference timestamps as the plurality of inputs to the vision model to cause the vision model to generate a plurality of volumetric representations of the scene at a plurality of different reference timestamps; and one or more operations to store or one or more operations to provide the plurality of volumetric representations as a sequence of volumetric frames corresponding to a reconstructed scene.

Clause 12. The system of clause 4, wherein the one or more processors are comprised in at least one of: a system for implementing scene reconstruction; a system for applying contextual features to one or more models; a system for performing motion analysis; a system for performing volumetric rendering; a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more language reasoning models (LRMs); a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of extended reality content, virtual reality content, augmented reality content, or mixed reality content; a system incorporating one or more virtual machines (VMs); a system implemented at least partially in a data center; or a system implemented at least partially using cloud computing resources.

Clause 13. One or more processors comprising processing circuitry to: obtain a plurality of context frames corresponding to a plurality of camera poses at a plurality of timestamps; determine a reference timestamp is one of the plurality of timestamps or between two of the plurality of timestamps of the plurality of context frames; generate, using a vision model, a volumetric representation of a scene at the reference timestamp based on the plurality of context frames, the plurality of camera poses, and the reference timestamp; and provide the volumetric representation of the scene at the reference timestamp.

Clause 14. The one or more processors of clause 13, wherein the processing circuitry is further to: generate, using the vision model, the volumetric representation based at least on: an unprojection of a plurality of image patches; a plurality of pose embeddings based on the plurality of camera poses; and a plurality of time embeddings based on the plurality of timestamps and the reference timestamp.

Clause 15. The one or more processors of clause 13, wherein the processing circuitry is further to: segment at least one context frame of the plurality of context frames into a plurality of patches; and generate at least one token of a plurality of tokens for at least one of the plurality of patches, the at least one token comprising: at least one image feature; at least one pose feature; and at least one time feature.

Clause 16. The one or more processors of clause 15, wherein to apply the plurality of context frames, the plurality of camera poses, and the reference timestamp as a plurality of inputs, the one or more processors are to: apply the plurality of tokens as the plurality of inputs to the vision model to cause the vision model to generate the volumetric representation; and cause the vision model to map at least one output token of the vision model to at least one parameter of a three-dimensional (3D) Gaussian, the at least one parameter comprising at least one of color, scale, rotation, opacity, or a distance along a ray.

Clause 17. The one or more processors of clause 13, wherein the processing circuitry are further to: generate, using at least one artificial intelligence (AI) model, an interpolated frame at the reference timestamp different from the plurality of timestamps of the plurality of context frames; and update the plurality of context frames to comprise the interpolated frame corresponding with the reference timestamp.

Clause 18. The one or more processors of clause 13, wherein to apply the plurality of context frames, the plurality of camera poses, and the reference timestamp to the vision model to cause the vision model to generate the volumetric representation comprises: performing an unprojection of a plurality of pixel locations from at least one context frame of the plurality of context frames into 3D space based on the plurality of camera poses; assigning at least one distance parameter to the plurality of pixel locations to position a plurality of 3D Gaussians along a plurality of rays; and updating at least one 3D parameter of the plurality of 3D Gaussians to represent a portion of the scene.

Clause 19. The one or more processors of clause 18, wherein the processing circuitry is further to: position the plurality of 3D Gaussians based at least on a plurality of spatial changes corresponding to at least one motion trajectory of at least one object between the plurality of context frames, wherein the plurality of 3D Gaussians is configured for rendering from a plurality of perspectives and to represent the at least one motion trajectory of the at least one object within the scene at the reference timestamp.

Clause 20. The one or more processors of clause 13, wherein the processing circuitry is further to: render at least one two-dimensional (2D) image from the volumetric representation of the scene at the reference timestamp; determine at least one performance metric based on at least one loss function and a ground-truth image; and update at least one model parameter of the vision model based on the at least one performance metric.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to execute operations comprising:
obtain a set of visual data of a video captured at multiple times from multiple viewpoints;
determine a reference time matching one of the multiple times or a time between two of the multiple times;
generate, using an artificial intelligence (AI) model, a three-dimensional (3D) representation of a scene at the reference time based on the set of visual data; and
provide the 3D representation for viewing from multiple perspectives.

2. The system of claim 1, wherein the one or more processors are to execute operations comprising:
generate additional visual data representing a new view of the scene at the reference time, the additional visual data is different from the set of visual data; and
update the set of visual data to include the additional visual data.

3. The system of claim 1, wherein generating the 3D representation includes converting an output of the AI model into visual rendering data defining a 3D shape, wherein the visual rendering data includes at least one of a color, size, orientation, transparency, or depth in the scene.

4. A system, comprising:
one or more processors to execute operations comprising:
one or more operations to obtain a plurality of context frames of video data, the plurality of context frames corresponding to a plurality of camera poses at a plurality of timestamps;
one or more operations to determine a reference timestamp is one of the plurality of timestamps or between two of the plurality of timestamps of the plurality of context frames;
one or more operations to apply the plurality of context frames, the plurality of camera poses, and the reference timestamp as a plurality of inputs to a vision model to cause the vision model to generate a volumetric representation of a scene at the reference timestamp; and
one or more operations to provide the volumetric representation of the scene at the reference timestamp for rendering at a plurality of perspectives.

5. The system of claim 4, wherein the operations executed by the one or more processors further comprise:
one or more operations to segment at least one context frame of the plurality of context frames into a plurality of patches; and
one or more operations to generate at least one token of a plurality of tokens for at least one of the plurality of patches, the at least one token comprising:
at least one image feature;
at least one pose feature; and
at least one time feature.

6. The system of claim 5, wherein:
the one or more operations to apply the plurality of context frames, the plurality of camera poses, and the reference timestamp as inputs comprises one or more operations to apply the plurality of tokens as the plurality of inputs to the vision model to cause the vision model to generate the volumetric representation; and
the operations executed by the one or more processors further include operations to cause the vision model to map at least one output token of the vision model to at least one parameter of a three-dimensional (3D) Gaussian, the at least one parameter comprising at least one of color, scale, rotation, opacity, or a distance along a ray.

7. The system of claim 4, wherein the operations executed by the one or more processors further comprise:
one or more operations to generate, using at least one artificial intelligence (AI) model, an interpolated frame at the reference timestamp different from the plurality of timestamps of the plurality of context frames; and
one or more operations to update the plurality of context frames to comprise the interpolated frame corresponding with the reference timestamp.

8. The system of claim 4, wherein the one or more operations to apply the plurality of context frames, the plurality of camera poses, and the reference timestamp to the vision model to cause the vision model to generate the volumetric representation further comprises:
one or more operations to perform an unprojection of a plurality of pixel locations from at least one context frame of the plurality of context frames into 3D space based on the plurality of camera poses;
one or more operations to assign at least one distance parameter to the plurality of pixel locations to position a plurality of 3D Gaussians along a plurality of rays; and
one or more operations to update at least one 3D parameter of the plurality of 3D Gaussians to represent a portion of the scene.

9. The system of claim 8, wherein:
the plurality of 3D Gaussians are positioned based at least on a plurality of spatial changes corresponding to at least one motion trajectory of at least one object between the plurality of context frames; and
the plurality of 3D Gaussians are configured for rendering from the plurality of perspectives and to represent the at least one motion trajectory of the at least one object within the scene at the reference timestamp.

10. The system of claim 4, wherein the operations executed by the one or more processors further comprise:
one or more operations to render at least one two-dimensional (2D) image from the volumetric representation of the scene at the reference timestamp;
one or more operations to determine at least one performance metric based on at least one loss function and a ground-truth image; and
one or more operations to update at least one model parameter of the vision model based on the at least one performance metric.

11. The system of claim 4, wherein the operations executed by the one or more processors further comprise:
one or more operations to identify a plurality of reference timestamps based at least on iterating through the plurality of timestamps of the video data corresponding to a monocular video;
one or more operations to apply the plurality of context frames, the plurality of camera poses, and at least one of the plurality of reference timestamps as the plurality of inputs to the vision model to cause the vision model to generate a plurality of volumetric representations of the scene at a plurality of different reference timestamps; and
one or more operations to store or one or more operations to provide the plurality of volumetric representations as a sequence of volumetric frames corresponding to a reconstructed scene.

12. The system of claim 4, wherein the one or more processors are comprised in at least one of:
a system for implementing scene reconstruction;
a system for applying contextual features to one or more models;
a system for performing motion analysis;
a system for performing volumetric rendering;
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more language reasoning models (LRMs);
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of extended reality content, virtual reality content, augmented reality content, or mixed reality content;
a system incorporating one or more virtual machines (VMs);
a system implemented at least partially in a data center; or
a system implemented at least partially using cloud computing resources.

13. One or more processors comprising processing circuitry to:
obtain a plurality of context frames corresponding to a plurality of camera poses at a plurality of timestamps;
determine a reference timestamp is one of the plurality of timestamps or between two of the plurality of timestamps of the plurality of context frames;
generate, using a vision model, a volumetric representation of a scene at the reference timestamp based on the plurality of context frames, the plurality of camera poses, and the reference timestamp; and
provide the volumetric representation of the scene at the reference timestamp.

14. The one or more processors of claim 13, wherein the processing circuitry is further to:
generate, using the vision model, the volumetric representation based at least on:
an unprojection of a plurality of image patches;
a plurality of pose embeddings based on the plurality of camera poses; and
a plurality of time embeddings based on the plurality of timestamps and the reference timestamp.

15. The one or more processors of claim 13, wherein the processing circuitry is further to:
segment at least one context frame of the plurality of context frames into a plurality of patches; and
generate at least one token of a plurality of tokens for at least one of the plurality of patches, the at least one token comprising:
at least one image feature;
at least one pose feature; and
at least one time feature.

16. The one or more processors of claim 15, wherein to generate the volumetric representation the one or more processors are to:
apply the plurality of tokens as a plurality of inputs to the vision model to cause the vision model to generate the volumetric representation; and
cause the vision model to map at least one output token of the vision model to at least one parameter of a three-dimensional (3D) Gaussian, the at least one parameter comprising at least one of a color, a scale, a rotation, an opacity, or a distance along a ray.

17. The one or more processors of claim 13, wherein the processing circuitry are further to:
generate, using at least one artificial intelligence (AI) model, an interpolated frame at the reference timestamp different from the plurality of timestamps of the plurality of context frames; and
update the plurality of context frames to comprise the interpolated frame corresponding with the reference timestamp.

18. The one or more processors of claim 13, wherein to apply the plurality of context frames, the plurality of camera poses, and the reference timestamp to the vision model to cause the vision model to generate the volumetric representation comprises:
performing an unprojection of a plurality of pixel locations from at least one context frame of the plurality of context frames into 3D space based on the plurality of camera poses;
assigning at least one distance parameter to the plurality of pixel locations to position a plurality of 3D Gaussians along a plurality of rays; and
updating at least one 3D parameter of the plurality of 3D Gaussians to represent a portion of the scene.

19. The one or more processors of claim 18, wherein the processing circuitry is further to:
position the plurality of 3D Gaussians based at least on a plurality of spatial changes corresponding to at least one motion trajectory of at least one object between the plurality of context frames,
wherein the plurality of 3D Gaussians is configured for rendering from a plurality of perspectives and to represent the at least one motion trajectory of the at least one object within the scene at the reference timestamp.

20. The one or more processors of claim 13, wherein the processing circuitry is further to:
render at least one two-dimensional (2D) image from the volumetric representation of the scene at the reference timestamp;
determine at least one performance metric based on at least one loss function and a ground-truth image; and
update at least one model parameter of the vision model based on the at least one performance metric.
